(19) United States
(12) Patent Application Publication
(10) Pub. No.: US 2019/0158206 A1
(43) Pub. Date: May 23, 2019

(54) MULTI-USER MULTIPLE INPUT MULTIPLE OUPUT SYSTEMS

(71) Applicant: INTEL IP CORPORATION, SANTA CLARA, CA (US)

(72) Inventors: Hua LI, Beijing (CN); Yuan ZHU, Beijing (CN); Andrey CHERVYAKOV, Nizhny Novgorod (RU)

(21) Appl. No.: 16/092,695

(22) PCT Filed: Apr. 12, 2017
(86) PCT No.: PCT/US2017/027195

§ 371 Date: Oct. 10, 2018

Related U.S. Application Data
(60) Provisional application No. 62/336,378, filed on May 13, 2016.

(51) Int. Cl. H04J 13/00; H04B 7/0456; H04B 7/0452; H04W 72/04; H04L 5/00; H04L 27/26; H04B 7/06

(52) U.S. Cl. CPC H04J 13/0048; H04B 7/0456; H04B 7/0452; H04B 7/0626; H04L 5/0051; H04L 27/2613; H04L 5/0053; H04W 72/0446

(57) ABSTRACT

Embodiments can relate to transmitting or processing a demodulation reference signal; the method comprising generating a demodulation reference signal, spreading an instance of the demodulation reference signal using OCC-2 for a transmission associated antenna port 7, spreading an instance of the demodulation reference signal using OCC-4 for a transmission associated antenna port 11, and co-scheduling transmission or output of the spread instances of the demodulation reference signals.

### CROSS REFERENCE TO RELATED APPLICATION

The present application claims priority to U.S. Provisional Patent Application No. 62/336,378, filed May 13, 2016, entitled “MU-MIMO with mixed OCC-2 and OCC-4”; the entire disclosure of which is hereby incorporated by reference.

### BACKGROUND

There is an ever increasing demand for network capacity as the number of wireless devices increases. With that increasing demand for capacity and increasing user equipment (UE) numbers comes a greater need for spectrum management, in terms of, for example, spectral efficiency and mitigating interference. Various techniques exist for increasing the traffic carrying capacity of a channel or cell. Those techniques comprise assigning subcarriers to specific user equipments and using multiple access techniques such as Orthogonal Frequency Division Multiple Access (OFDMA) and Single Carrier Frequency Division Multiple Access (SC-FDMA) in, for example, Long Term Evolution (LTE), Long Term Evolution Advanced (LTE-A) and Long Term Evolution Advanced Pro (LTE-A Pro).

Other techniques also exist such as, for example, beamforming in which radio energy is transmitted in a directional manner. A number of antennas can be arranged to produce a resulting beam pattern comprising lobes and nulls that can improve signal to noise ratios and signal to noise plus interference ratios. Beamforming supports multi-user communications and, in particular, the antennas can be used to support multiple-input multiple output (MIMO) communications such as, for example, multi-user MIMO (MU-MIMO).

3GPP Technical Standard TS 36.211 v13.1.0 (2016 March) (TS 36.211), clause 6.3, describes the general structure of downlink physical channels. TS 36.211 clause 6.3.5, in particular, describes resource element mapping for each antenna port used for transmitting a physical channel. TS 36.211, clause 6.4, further defines the Physical Downlink Shared Channel (PDSCH), including reference signals and associated antenna ports. TS 36.211 defines various such reference signals in clause 10, which includes definitions of a User Equipment Specific Reference Signal (DM-RS) associated with the Physical Downlink Shared Channel (PDSCH), see clause 6.10.3, a Demodulation Reference Signal (DM-RS) associated with an Enhanced PDSCH, see clause 6.10.3A, and a Channel State Information Reference Signal (CSI-RS), see clause 6.10.5.

In a MU-MIMO scenario, an Evolved Node B (eNB) can schedule or service several user equipments simultaneously, which allows an overall increase in traffic carrying capacity to be realised. During MU-MIMO, the same time-frequency resources can be shared by multiple user equipments (UEs). To improve performance, each user equipment can estimate associated channel characteristics and adapt accordingly. The reference signals can be used to estimate such associated channel characteristics.

In an effort to improve performance still further, Elevation Beamforming/Full Dimension (FD) Multiple Input, Multiple Output (MIMO) is being considered for Long Term Evolution Advanced Pro for Release 13 et seq. Channel State Information Reference Signals (CSI-RS) support channel status measurements for multiple antenna situations such as, for example, beam formed transmissions.

During MU-MIMO transmission, the same time-frequency resources can be shared by multiple users. Each UE can estimate its own channel in order to demodulate data. A DM-RS is used to estimate the channel. Since perfect orthogonality of multi-users is hard to guarantee, Orthogonal Cover Codes (OCC) can be used to improve the orthogonality of multiple layers, which will greatly improve the channel estimation accuracy.

There are a number of types of OCC such as, for example, OCC-2 and OCC-4. Previously, only OCC-2 was used, which provides two orthogonal layers over antenna ports 7 and 8. A base station such as an eNB can schedule a UE with OCC-2 over antenna ports 7 and 8 to transmit simultaneously. OCC-4, however, uses 4 orthogonal layers over antenna ports 7, 8, 11 and 13, which means that more UEs can be scheduled together for MU-MIMO. From the perspective of UE implementation, the channel estimation process in the receiver is different when using OCC-2 and OCC-4. If one UE is scheduled as using OCC-2, the receiver will apply an OCC-2 related channel estimation procedure. Previously, a base station can only schedule OCC-2 users together, which will, therefore, lead to degradation of the system capacity.

### BRIEF DESCRIPTION OF THE DRAWINGS

Aspects, features and advantages of embodiments will become apparent from the following description given in reference to the appended drawings in which like numerals denote like elements and in which:

FIG. 1 illustrates an eNB and UE according to embodiments;

FIG. 2 shows the eNB and a pair of UEs according to embodiments;

FIG. 3 shows an apparatus according to embodiments;

FIG. 4 depicts an eNB or components thereof according to embodiments;

FIG. 5 shows an eNB or eNB components according to embodiments;

FIG. 6 shows a UE or UE components according to embodiments;

FIG. 7 depicts radio resources according to embodiments;

FIG. 8 illustrates DM-RS transmission using OCCs according to embodiments;

FIG. 9 shows performance data according to embodiments;

FIG. 10 depicts DM-RS transmission using OCCs according to embodiments;

FIG. 11 shows a message according to embodiments;

FIG. 12 illustrates a protocol stack according to embodiments;

FIG. 13A shows a communication exchange according to embodiments;

FIG. 13B illustrates a communication exchange according to embodiments;

FIG. 14 depicts a number of flowcharts according to embodiments;

FIG. 15A illustrates a communication exchange according to embodiments;

FIG. 15B shows a communication exchange according to embodiments;

FIG. 16 depicts a number of flowcharts according to embodiments;

FIG. 17 illustrates an apparatus or components according to embodiments;

FIG. 18 depicts a user equipment according to embodiments;

FIG. 19 illustrates a user equipment according to embodiments; and

FIG. 20 shows machine readable storage according to embodiments.

### DETAILED DESCRIPTION

In LTE Rel-9, a dual layer beamforming based transmission mode 8 (TM8) was introduced. In TM8, PDSCH demodulation is based on Demodulation Reference Signals. Using DM-RS, a DM-RS port can be precoded using the same precoder as its associated PDSCH layer. For MU-MIMO, transparent MU-MIMO is supported because any DM-RS overhead does not change with an increase of MU-MIMO transmission rank. For example, four rank one users can be served in one MU-MIMO transmission. To support four rank one users with only two DM-RS ports 7/8, one additional scrambling identity nSCID (nSCID=1) was introduced. Thus, four rank one users will use a {DM-RS, SCID} pair that belongs to {7/8, 0/1} to generate DM-RS sequences; where 7/8 refer to antenna ports, in particular, virtual antenna ports, and 0/1 refer to respective scrambling identities. Since DM-RSs with different nSCID are not orthogonal, an eNB can use spatial precoding to mitigate any inter-user interference.

In LTE Rel-10, transmission mode 9 (TM9) was introduced, which extends the DM-RS structure of TM8 to support up to rank eight SU-MIMO transmissions. However, for MU-MIMO operation, TM9 keeps the same MU-MIMO transmission order as TM8. Two DM-RS antenna ports {11, 13} are added to the same 12 Resource Elements (RE) of DM-RS ports {7, 8} using length four orthogonal cover codes. A second group of 12 REs is reserved for four other DM-RS ports {9, 10, 12, 14}. When the transmission rank is greater than 2, both DM-RS groups are used.

In LTE Rel-11, a still further transmission mode, transmission mode 10 (TM10), was introduced that keeps the same DM-RS structure as TM9. However, instead of using a physical cell ID to initialize the DM-RS sequence, two virtual cell IDs can be configured for each UE using RRC signaling. The nSCID signaling in Downlink Control Information (DCI) Format 2D dynamically chooses one of the virtual cell IDs to initialize the DM-RS sequence for a given PDSCH transmission.

The DM-RS antenna ports that are used for PDSCH transmission are indicated in the DCI Formats 2C and 2D using a 3-bit “Antenna port(s), scrambling identity and number of layers indication” field as per 3GPP TS 36.212 V13.1.0 (2016 March), Table 5.3.3.1.5C-1 and/or Table 5.3.3.1.5C-2.

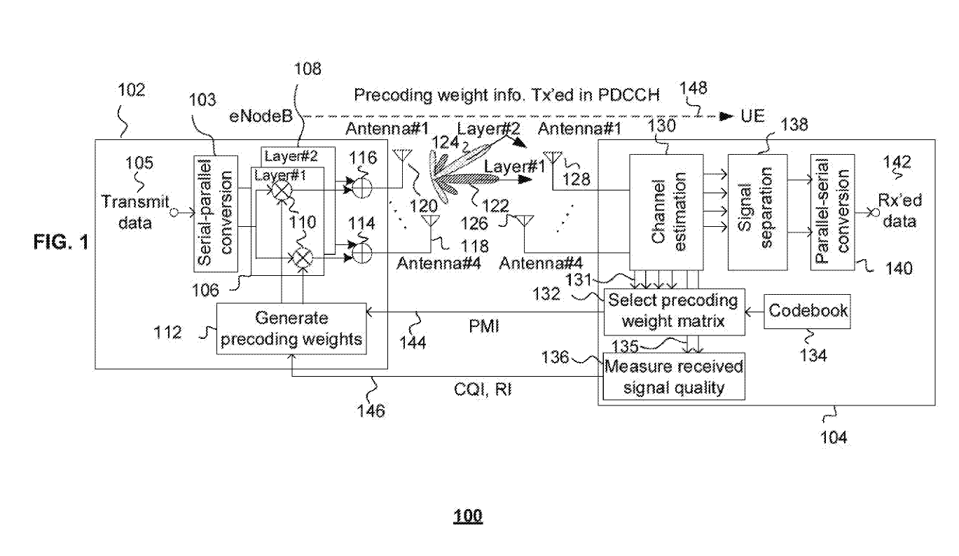

FIG. 1 shows a view of a communication system 100 comprising an eNodeB (eNB) 102 and a user equipment (UE) 104. The eNB 102 and the user equipment 104 can be configured to communicate wirelessly using beam forming. The wireless communication can be realised with or without using beam forming. In the example depicted, the eNB 102 is arranged to output at least one beam formed transmission, that is, the eNB directs radio energy in a shaped manner to the user equipment 104. The radio energy forms an antenna pattern.

The eNB 102 can comprise a serial to parallel converter 103 to convert transmit data 105 into at least one layer for transmission or into multiple layers for transmission. In the illustrated embodiment, two layers 106 and 108 are shown, that is, layer#1 106 and layer#2 108. Example implementations can be realized that use a set of layers. Such a set of layers can comprise, for example, any one or more than one of 1 to 8 layers, taken jointly and severally in any and all permutations, or some other number of layers. The layers 106 and 108 can be formed by mixing, using respective mixers 110, precoding weights, supplied by a precoding weights generator 112. The outputs of the layers 106 and 108 can be supplied to respective adders 114 and 116. The outputs from the adders 114 and 116 are transmitted to the user equipment 104 via one or more than one antenna, or one or more than one antenna element, of the eNB 102; namely, a set of antennas or antenna elements 118 to 120. In the embodiment described, four such antennas or antenna elements 118 to 120 are used; two of which are depicted. Example implementations can use a number of antennas or antenna elements such as, for example, 1, 2, 4, 8, 12, 16, 20, 24 or some other number of antennas or antenna elements. The precoding weights result in one or more than one formed beam. In the example shown, two antenna beam patterns 122 and 124 are shown. The two antenna beam patterns can be directed to one or more than one UE.

The UE 104 can comprise one or more than one antenna or one or more than one antenna element. In the illustrated embodiment, a plurality or set of antennas or antenna elements is provided. More particularly, four antennas or antenna elements are provided; two 126 and 128 of which are shown. Example implementations can use a set of antennas or antenna elements such as, for example, 1, 2, 4, 8, 12, 16, 20, 24 or some other number of antennas or antenna elements. The antennas or antenna elements 126 and 128 receive one or more of the transmit beams 122 and 124.

A channel estimator 130 is configured to process signals received by the antennas 126 and 128. The channel estimator 130 can produce channel data associated with an estimate of one or more than one channel between the eNB 102 and the user equipment 104. The channel data can be output to a precoding weight matrix selector 132. The precoding weight matrix selector 132 is responsive to a codebook 134 to provide a Precoding Matrix Indicator (PMI) to the eNB 102, in particular, to provide the PMI to the precoding weights generator 112.

The channel estimator 130 forwards the received signals to a signal separator 138. The signal separator 138 can comprise circuitry to separate the received signals into respective parallel data streams. The parallel data streams are processed by a parallel to serial converter 140 to output received data 142.

The channel data from the channel estimator 130 can also provide an output 135 to processing circuitry 136 that provides data associated one or more than one characteristic of one or more wireless channels or associated with received signals. The data can be provided in a closed-loop feedback manner to the eNB 102 for comparison with the transmitted data. In the embodiment illustrated, the data can comprise Channel State Information (CSI) comprising at least one of a Channel Quality Indicator (CQI) or a Rank Indicator (RI) 146. Example implementations can provide both the CQI and the RI 146 to the eNB 102. The eNB 102 uses at least one of the CQI, RI 146 or PMI 144, taken jointly and severally in any and all permutations, to control adaptively the transmissions, such as, for example, the number of layers transmitted, to the user equipment 104 or transmitted to a plurality of UEs. The feedback can, additionally or alternatively to the above CQI, RI and PMI, comprise an indication of an associated beam in respect of which the data associated with the one or more channel characteristics is provided. Such channel estimations can be based on the above DM-RS signals

In the example shown, the eNB 102 and the UE 104 are configured to communicate using 4×4 MIMO with a Rank 2, that is, both layers are destined for the user equipment 104. Alternatively, or additionally, the antennas and layers can be configured to serve a number of UEs. Insofar as concerns the data path, the precoding weights selected by the precoding weights generator 112 are communicated to the user equipment 104 via a communication channel such as, for example, the Physical Downlink Control Channel (PDCCH) 148 of LTE-A.

The Channel State Information (CSI) can be reported in a prescribed format or form. Such a prescribed format or form can comprise a set of recommendations to the eNB regarding transmissions properties. The transmission properties can be, for example, MIMO transmission properties. Embodiments can be realized in which the CSI can comprise at least one or more than one of Channel Quality Indicator (CQI), precoding matrix indicator (PMI), precoding type indicator (PTI) or Rank Indication (RI) taken jointly and severally in any and all permutations. RI provides an indication of the number of layers that the UE recommends for eNB transmissions. PMI is an index to a UE recommended precoding matrix. The time and frequency resources assigned to the UE for reporting CSI are prescribed by the eNB, in the form of CSI-RS resource configuration data. A UE is configurable by higher layers, as prescribed in, for example, TS 36.331 v13.1.0 (2016 March), semi-statically or semi-persistently to periodically provide one or more than one CSI component, that is, one or more than one of CQI, PMI, PTI or RI taken jointly and severally in any and all permutations.

In general, spatial processing occurs at a transmitter. In beam forming such as, for example, single-layer beam forming, the same signal is emitted from each of the transmit antennas with at least one of appropriate phase or gain weighting such that the signal power is maximized at a receiver input. The benefits of beamforming can be to increase the received signal gain, by making signals emitted from different antennas add constructively, and to reduce multipath fading effects. When a receiver has multiple antennas, the transmit beam forming cannot simultaneously maximize the signal level at all of the receive antennas, and precoding with multiple streams is used. Precoding can use knowledge of channel state information (CSI) at the transmitter as indicated above.

In various embodiments, the UE 104 and/or the eNB 102 may include such a set of antennas 118 to 120 and 126 to 128 to implement a multiple-input-multiple-output (MIMO) transmission system, which may operate in a variety of MIMO modes, including a single-user MIMO (SU-MIMO) mode, a multi-user MIMO (MU-MIMO) mode, a closed loop MIMO mode, an open loop MIMO mode or a mode associated with variations of smart antenna processing. The UE 104 may provide some type of channel state information (CSI) feedback to the eNB 102 via one or more uplink channels, and the eNB 102 may adjust one or more downlink channels based on the received CSI feedback. The feedback accuracy of the CSI may affect the performance of the MIMO system.

As indicated above, in various embodiments, the UE 104 may transmit CSI feedback to the eNB 102 when that information is available. The CSI feedback may include information related to channel quality indicator (CQI), precoding matrix indicator (PMI), and rank indication (RI). PMI may reference, or otherwise identify, a precoder within the codebook. The eNB 102 may adjust the downlink channels based on the precoder referenced by the PMI. The CSI feedback is responsive to a prescribed format.

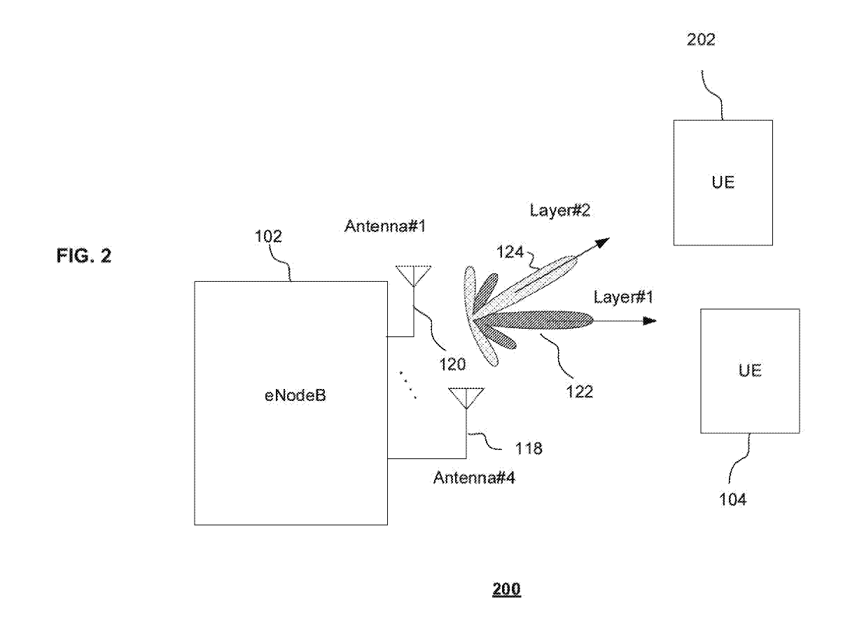

The eNB 102 and the UE 104 can be configured to operate in a MU-MIMO manner as shown in FIG. 2, where there is shown a view 200 of the eNB 102 communicating with the above described UE 104 in addition to one or more than one further UE 202. In the embodiment shown, a given layer, such as layer 1, is carried by a respective beam such as antenna pattern 122 and a further layer, such as layer 2, is carried by a further respective beam such as antenna pattern 124. Resource elements such as, for example, DM-RS bearing resource elements are conveyed using respective configuration data or parameters sets. The configuration data or parameters sets can prescribe one or more of antenna ports, layers, codes and scrambling identities associated with UE-specific reference signals such as, for example, DM-RS signals. It will be appreciated, however, that precoding for the DM-RS sequence is not communicated since precoding the DM-RS sequence can use a virtual channel estimation based on, for example, angle of arrival of data. The transmissions destined for the different UEs 104 and 202 can be made orthogonal using the above described orthogonal cover codes.

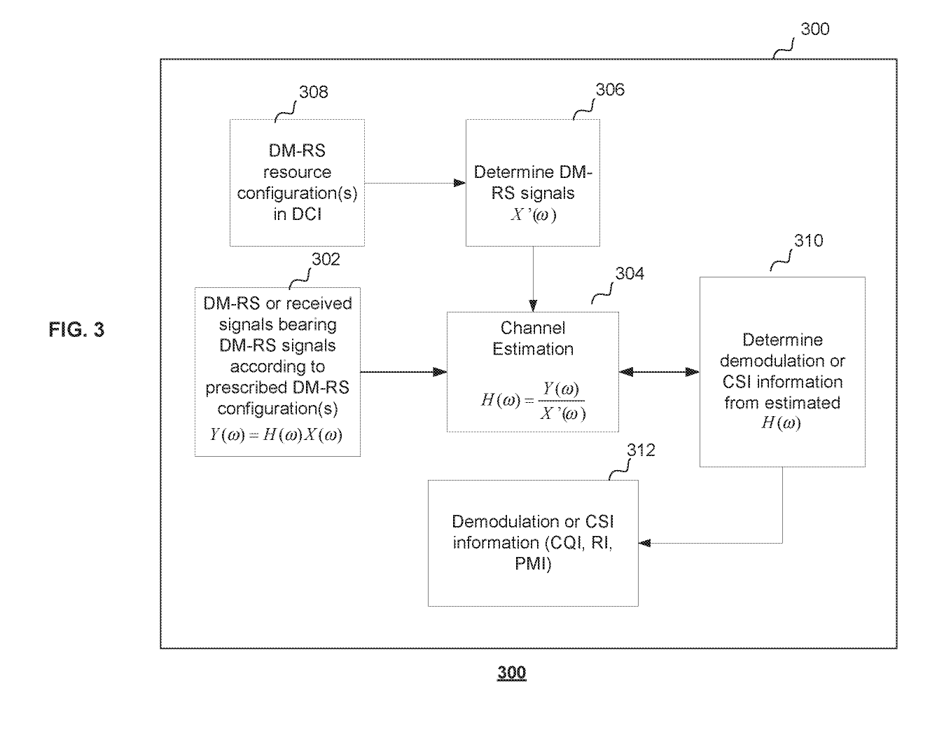

FIG. 3 depicts an apparatus 300 for processing received modulation symbols such as, for example, DM-RS signals configured according to DM-RS resource configuration(s). In any and all embodiments described, the DM-RS signals can be carried by a PDSCH. The apparatus 300 can be an embodiment of the UE 104 or a component of, or for, such a UE.

In general, the received signals can be represented in the frequency domain as

Y(ω)=H(ω)X(ω),

where Y(ω) represents the received DM-RS signals or represent signals bearing one or more DM-RSs received by a UE, which were initially configured and transmitted according to associated DM-RS resource configuration information,
H(ω) represents the channel over which the received signals have propagated, that is, the channel transfer function or a respective antenna port, and
X(ω) represents the originally transmitted DM-RS signal or signals.

It can be appreciated that received signals 302 are received and forwarded to channel estimation circuitry or logic 304. It will be appreciated that the channel estimation logic 304 can be an embodiment of the above channel estimator 130. The channel estimation circuitry or logic 304 also receives an ideal version of DM-RS signals 306, X′(ω), generated according to the DM-RS resource configuration information by DM-RS generator circuitry or logic 308. The DM-RS resources configuration information provides the UE with data allowing signals associated with X(ω) to be generated at the UE.

The channel estimation logic 304 processes the received signals, Y(ω), and the generated signals, X′(ω), to determine the channel transfer function, H(ω) In general terms, determining the channel transfer function can be conceptually expressed as:

$$H ( ω ) = \frac{Y ( ω )}{{X}^{′} ( ω )} .$$

The estimated channel transfer function, H(ω), can be used by, for example, channel state information estimation circuitry or logic 310 to determine Channel State Information 312.

Embodiments can be realised that use one or more than one channel estimation technique. For one or more than one given resource element or antenna port, channel interpolation can be used in conjunction with channel estimation such as, for example time-frequency two dimension filtering or two one-dimension filtering. The receiver or channel estimation can be a linear receiver or estimation using, for example, a zero-forcing receiver or a Minimum Mean Square Error (MMSE) receiver. Alternatively, the receiver or channel estimation can be non-linear using, for example, a Maximum Likelihood (ML) receiver or a Successive Interference Cancellation estimation or receiver.

The channel estimation logic 310 is arranged to process the DM-RS signal, transmitted using respective OCCs, to provide channel transfer function estimates for one or more antenna ports or resource elements. Embodiments can be realized that use one or more than one technique for channel estimation. For example, embodiments can use one channel estimation technique to determine an initial channel estimate and use one or more further techniques for subsequent estimates of the channel or refinements of an initial channel estimate.

Suitably, a channel estimation can be realised by knowing the data being carried on one or more than one subcarrier. For example, the data can be a DM-RS signal carried on one or more than one subcarrier, resource element or antenna port. Embodiments can be realised, in which the DM-RS on subcarrier n at time i is denoted as c_{n,i}, using a Least Square (LS) channel estimate can be determined from

$${L}_{n , i}^{LS} = \frac{{r}_{n , i}}{{c}_{n , i}}$$

where r_{n,i} is the value received on sub-channel or subcarrier n. Embodiments can be realized that improve the channel estimate by taking into account the correlation between fading at different frequencies. Therefore, embodiments can be produced in which LS estimates over a different subcarrier(s) or different resource element(s) can be represented as a vector hᵢ^{LS}=(h_{1,i}^{LS} h_{2,i}^{LS} . . . h_{n,i}^{LS})^{T} such that the corresponding vector of Linear Minimum Mean Squares Estimate (LMMSE) can be given by hᵢ^{LMMSE}=Rₕₕ_{^{LS}}Rₕ_{^{LS}}ₕ_{^{LS}}⁻¹hᵢ^{LS}, where Rₕₕ_{^{LS}} is the covariance matrix between channel gains and the LS estimate of the channel gains, Rₕ_{^{LS}}ₕ_{^{LS}}⁻¹ is an autocovariance matrix of LS estimates. Assuming the presence of Additive White Gaussian Noise (AWGN) with respective variances of σₙ² on respective subcarriers or resource elements, then Rₕₕ_{^{LS}}=Rₕₕ and Rₕ_{^{LS}}ₕ_{^{LS}}⁻¹=Rₕₕ+σ²I, where I is the Identity matrix. Embodiments can be realised in which the channel attenuations are arranged in a vector hᵢ=(h_{1,i}, h_{2,i} . . . h_{n,i})^{T} so that Rₕₕ can be determined from Rₕₕ=E{hᵢhᵢ^{H}}=E{hᵢ*hᵢ^{T}}*, where hᵢ* is the complex conjugate of hᵢ, hᵢ^{H} is the Hermitian of hᵢ and hᵢ^{T} is the transpose of hᵢ. Embodiments can be realized that refine the foregoing on the basis that it is computationally intensive if the number of subcarriers is high. Suitably, embodiments can be realized in which a filter, such as, for example, a smoothing Finite Impulse Response (FIR) filter of a limited length, is applied across the LS estimated attenuations.

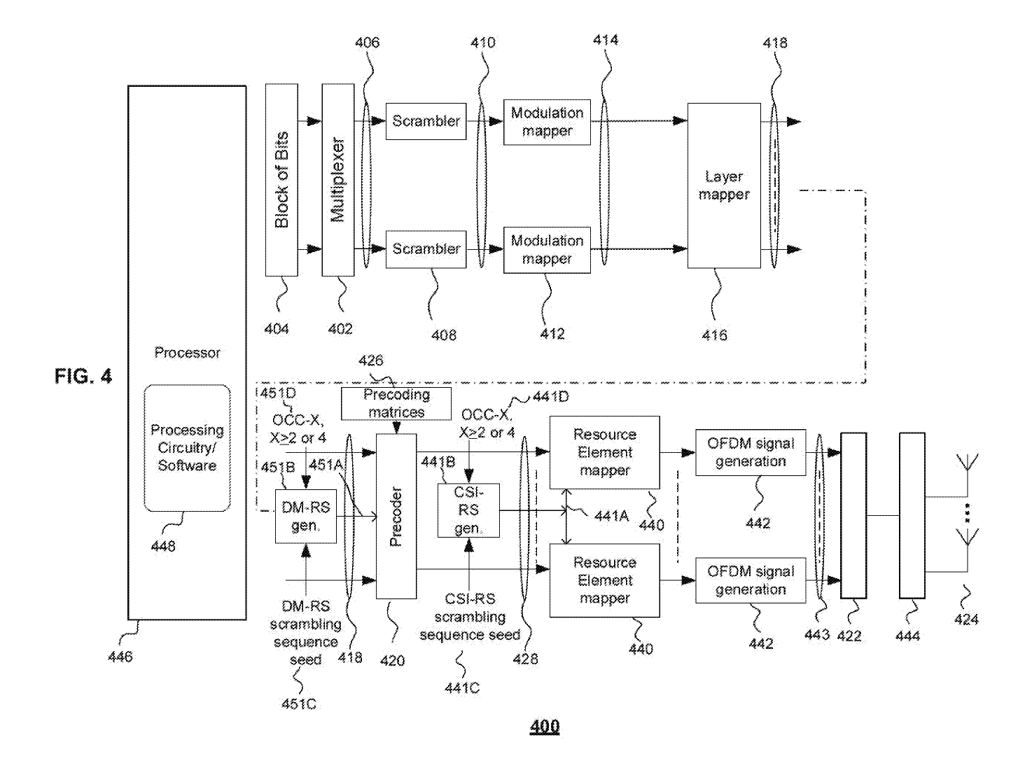

FIG. 4 depicts a system, apparatus, component or components 400 for realizing embodiments. The system, apparatus, component or components can be used to realize a base station such as, an eNB 102, or a component or part of such a base station. The system 400 of FIG. 4 depicts an architecture that can apply to one or more than one other channel as well as, or as an alternative to, the PDCCH. The one or more than one other channel can be, for example, another control channel or some other type of channel such as, for example, a Physical Broadcast Channel (PBCH), PDSCH, Physical Control Format Indicator Channel (PCFICH), PDCCH, Physical Hybrid-ARQ Indicator Channel (PHICH), Physical Uplink Control Channel (PUCCH), Physical Uplink Shared Channel (PUSCH) and Physical Random Access Channel (PRACH) (the latter three channels being uplinks in contrast to the former downlinks) or any other type of channel such as, for example, enhanced versions of the above channels. Therefore, embodiments can be realised in which the channel comprises one or more than one of an Enhanced Physical Downlink Control Channel (ePDCCH) or an Enhanced Physical Downlink Shared Channel (ePDSCH) or both.

Baseband signals associated with, or intended for, uplink and/or downlink physical channels can be defined using the following operations and associated entities. The system 400 may include a multiplexer 402 for multiplexing a block of bits 404 (BoB). The multiplexer 402 outputs multiplexed bits 406 associated with the BoB 404.

A scrambler 408 can scramble the multiplexed BoB 406 to be output for transmission or to be transmitted in a transmission (e.g., over an antenna port or over a physical channel). A plurality of scramblers is shown in the example of FIG. 4. The scrambler 408 is configured, therefore, to produce scrambled bits 410. The scrambler or scramblers can be responsive to a scrambling code seed to generate a data scrambling sequence. One or more than one scrambler 408 can be used.

Using information about the channel, the transmitter may tailor the transmit signal output to the channel in a manner that simplifies or improves receiver processing. The receiver may generate channel-related feedback information by processing a training signal or signals or a pilot signal or signals received from the transmitter. Embodiments are provided in which such a training or pilot signal or sequence is or comprises one or more than one DM-RS signal.

One or more than one modulation mapper 412 modulates the scrambled bits 410 to generate modulation symbols 414 for output. These generated modulation symbols 414 can be complex-valued modulation symbols.

The one or more than one modulation mapper 412 can selectively use one more than one modulation constellation. The one or more than one modulation constellation can comprise at least one of a binary phase shift keying (BPSK) constellation, a quadrature phase shift keying (QPSK) constellation or a quadrature amplitude modulation (QAM) constellation. The QAM constellation can comprise, for example, 8-QAM, 16-QAM, 64-QAM, 256QAM or a higher order QAM. The type of modulation used may depend on the signal quality or channel conditions. The modulation mapper 412 is not limited to using such modulation constellations. The modulation mapper 412 can, alternatively or additionally, use some other form of modulation constellation.

A layer mapper 416 is configured to map the modulation symbols 414 onto one or more than one transmission layer, or to produce layered modulation symbols 418.

One or more than one precoder 420 is configured to precode the layered modulation symbols 418 for transmission or output. The precoder 420 may encode the modulation symbols 418 on each layer for transmission onto one or more than one antenna port 422. Precoding may be used to convert antenna domain signal processing into beam-domain processing. Additionally, the one or more than one antenna port 422 may also be coupled to one or more than one antenna such as, for example, the plurality of antennas 424 shown or can be one or more than one virtual antenna port. The antennas 118 to 120 are embodiments of such a plurality of antennas 424. The precoding performed by the precoder 420 may be chosen from a finite set of precoding matrices 426, called a codebook. The codebook is known to both a receiver and a transmitter. The precoder 420 is configured to output coded symbols 428.

The one or more than one precoder 420 can precode at least one of actual data symbols, one or more than one reference signal, one or more than one positioning signal, one or more than one synchronization signal or one or more than one control information symbol, taken jointly and severally in any and all permutations. Such a reference signal can comprise a DM-RS.

Therefore, the precoder 420 is, or is optionally, responsive to or receives a DM-RS 451A output by a DM-RS generator 451B. The DM-RS generator 451B can be responsive to one or more than one seed parameter that influences the DM-RS generating process or operation. Embodiments can be realized in which the one or more than one seed parameter comprises at least one of a scrambling identity 451C in accordance with, for example, 4GPP TS 36.211 v12.7.0 (2015 September), section 6.10, or earlier technical standard (TS), and 4GPP TS 36.212, v12.6.0 or earlier TS. As appropriate, embodiments can provide an indication regarding whether or not a higher layer parameter Active-DM-RS-with orthogonal cover code signal (OCC) is set, which will influence the OCC used to transmit or spread the DM-RS signal. The terms “orthogonal cover code” and “orthogonal cover sequence” are used synonymously. Therefore, the DM-RS generator can also be responsive to an OCC control signal or OCC input 451D. The OCC control signal or input influences or controls whether or not an OCC is used in generating or representing the DM-RS 451A, which is described later in this specification. The signal 451D can additionally provide an indication of the length of the OCC to be used for transmission. Embodiments can be realized in which the OCC has a prescribed length. The prescribed OCC length can be at least one of 2 or 4 corresponding to orthogonal cover codes of length 2, denoted OCC-2, and orthogonal cover codes of length 4, denoted OCC-4.

The spread DM-RS signal is carried by respective DM-RS resources. The DM-RS resources support UE channel estimation on a per antenna port basis. The number of DM-RS resources can vary with the number of antennas or antenna ports. For each channel to be estimated, one of a number of DM-RS configurations is configured by UE higher layers, such as, for example, L3 or above, in response to respective higher layer signalling.

One or more than one resource element mapper 440 maps the coded symbols 428 output by the precoder 420 to respective resource elements. The resource element mapper 440 can map at least one of actual data symbols, one or more than one reference signal, one or more than one positioning signal, one or more than one synchronization signal or one or more than one control information symbol, taken jointly and severally in any and all permutations, into predetermined or selected respective resource elements in a resource grid. Such a reference signal can comprise a CSI-RS.

Therefore, the resource element mapper 440 is, or is optionally, also responsive to, or receives, a CSI-RS 441A output by a CSI-RS generator 441B. The CSI-RS generator 441B is responsive to one or more than one seed parameter that influences the CSI-RS generating process or operation. Embodiments can be realized in which the one or more than one seed parameter comprises at least one of a scrambling identity or a CSI-RS scrambling sequence seed 441C in accordance with, for example, 4GPP TS 36.211 v12.7.0 (2015 September), section 5.5, or earlier technical standard (TS), and 4GPP TS 36.212, v12.6.0 or earlier TS. As appropriate, embodiments can provide an indication regarding whether or not a higher layer parameter Active-CSI-RS-with orthogonal cover code signal (OCC) is set, which will influence the OCC used to transmit the CSI-RS signal. Therefore, the CSI-RS generator can also be responsive to an OCC enable/disable signal 441D. The OCC enable/disable signal influences or controls whether or not an OCC is used in generating or representing the CSI-RS 441A. Embodiments use an OCC of a prescribed length. Embodiments can be realized in which the OCC has a length of 4. Alternatively, or additionally, embodiments can be realized in which the OCC has a length of 2, 4, 8 or some other length.

The CSI-RS resources can support UE channel estimation.

One or more than one OFDM signal generator 442 is configured to generate a complex-valued time-division duplex (TDD) and/or frequency division duplex (FDD) OFDM signal 443 for the one or more than one antenna port 422 for transmission via the one or more than one antenna 424 after processing, such as up-conversion, by an RF front end 444, to a selectable frequency band. The one or more than one antenna 424 can comprise antennas such as the above antennas 118, 120, 126 and 128.

Also shown in FIG. 4, is a processor 446. The processor 446 comprises processing circuitry 448 to coordinate the operation of the system 400 and, in particular, to the control operation of the resource element mapper 440. The processing circuitry 448 can be realized using hardware or software or a combination of hardware and software. It will be appreciated that such processing circuitry can be an embodiment of logic. The software could be stored using a non-transitory or other non-volatile storage such as, for example, a read-only memory or the like.

Although FIG. 4 has been described with reference to a base station such as, for example, an eNB, embodiments are not limited thereto. Embodiments can additionally or alternatively be realized in the form of some other type of base station or access point, or as a component, apparatus or system for such an eNB or other type of base station or access point or as part of a UE. Furthermore, the apparatus 400 has been described as comprising a plurality of elements such as, for example, a multiplexer 402, a scrambler 408, a modulation mapper 412, a layer mapper 416, a DM-RS generator 451B, a precoder 420, a CSI-RS generator 441B, a resource element mapper 440 and an ODFM symbol generator 442, all of which can be taken jointly and severally in any and all permutations.

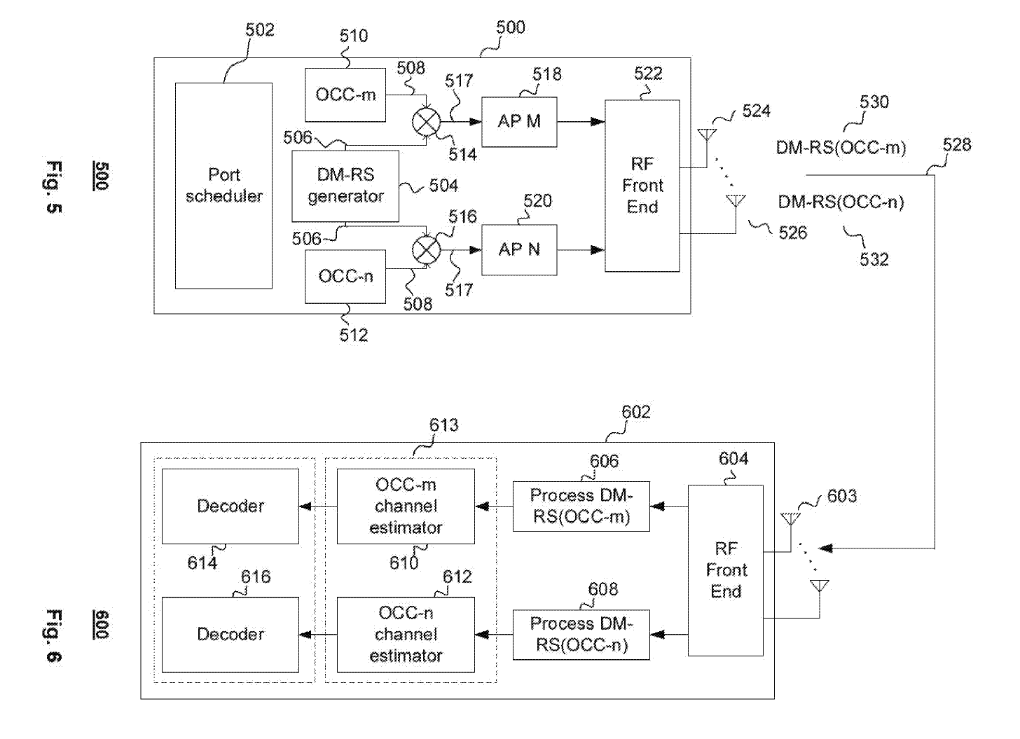

Referring to FIG. 5, there is shown a view 500 of a base station for transmitting wireless signals. Embodiments of such a base station 500 can be an eNB. The base station 500 comprises port scheduler 502. The port scheduler 502 can schedule one or more than one transmission over an antenna port using respective orthogonal cover codes. Scheduling of more than one transmission can be simultaneous, which is known as co-scheduling transmissions. The base station further comprises a signal generator 504 for generating a Demodulation Reference Signal (DM-RS) 506.

The signal generator 504 for generating the DM-RS 506 can be an embodiment of the above described DM-RS generator 451B. The DM-RS 506 is combined or spread with a number of Orthogonal Cover Codes (OCCs) 508. Such spreading or combining of a DM-RS with an orthogonal cover code is also known as, or are embodiments of, Code Division Multiplexing (CDM) in which orthogonal codes are used to simultaneously transmit signals such as, for example, DM-RS signals. The OCCs can be generated by a number of orthogonal cover code generators 510 and 512. The OCCs have respective code lengths and are represented via OCC-m, that is, an OCC of code length m, and OCC-n, that is, an OCC of code length n. In the embodiment depicted, two such orthogonal cover code generators are used. Embodiments can be realised in which m=n such as, for example, m=n=4, that is, OCC-4

The DM-RS 506 is spread using the OCCs 508 via using respective spreading circuitry. The spreading circuitry can take the form of a processor. In the embodiment shown, two instances of spreading circuitry 514 and 516 are shown schematically as mixers. The spread signals 517, that is, the DM-RS signals spread using the OCCs, are associated with respective antenna ports 518 and 520 and output for further processing. Such further processing can comprise, for example, transmission via an RF front end 522 and one or more than one physical antenna. The embodiment depicted shows a number of physical antennas 524 to 526. The physical antennas can be embodiments of the above described antennas 118 to 120.

Therefore, the spread signals 517 comprise symbols spread over a respective number of resource elements. The resource elements can be associated with one or more than one time slot of a resource block. Embodiments are provided in which two time slots can be used. FIG. 5 shows a transmitted signal 528 as comprising the spread DM-RS signals. The transmitted signal 528 bears resource elements carrying the one or more than one spread DM-RS signal. The transmitted signal 528 can carry a first DM-RS signal 530 associated with a predetermined antenna port spread with a respective OCC of a given length, m, that is, DM-RS(OCC-m) 530. For example, the transmitted signal can carry a DM-RS signal associated with antenna port 11 spread using an OCC selected from a set of OCC-4. Additionally, or alternatively, the transmitted signal can carry a DM-RS signal 532 associated with a different antenna port spread using a different respective OCC of a given length, n, that is, DM-RS(OCC-n) 532. For example, the transmitted signal can, additionally or alternatively, carry a DM-RS signal associated with antenna port 7 spread using an OCC selected from a set of OCC-2. Embodiments can be realised, however, in which m=n. For example, embodiments can be realised in which m=n=4, that is, both OCCs have the same length such as, for example, OCC-4. Embodiments are provided in which antenna port 11 can be a fixed antenna port. Embodiments can be provided in which modulation symbols under test are mapped to antenna port 11. Such modulations symbols can be tested in the presence of an interference signal. Suitably, modulation symbols of such an interference signal can be mapped onto an alternative antenna port. The alternative antenna port can be selected from a set of antenna ports. The set of antenna ports can comprise one or more than one of antenna ports 7, 8, and 13. The modulation symbols can be transmitted as part of a PDSCH. The modulation symbols can take the form of spread DM-RS symbols. Embodiments can be realised in which the target modulation symbols, that is, those transmitted via antenna port 11, and the inference modulation symbols are spread using OCC-4. Additionally, or alternatively, the target modulation symbols and the interference modulation symbols can be destined for notional or real respective UEs having respective UE scrambling identities nSCID. Embodiments can be realised in which the nSCIDs are both zero, that is, nSCID=0.

Referring to FIG. 6, there is shown a view 600 of a mobile station 602 for receiving and processing the combined signals, that is, the transmitted signal 528. Embodiments of such a mobile station can be a User Equipment (UE), such as, for example, a UE compatible with LTE-A Pro and LTE-A. The above described UE 104 is an example of such a UE. The transmitted signal 528 is received by one or more than one antenna 603 and fed to an RF front end 604. The RF front end 604 performs RF processing and directs the signal 528 to circuitry for recovering the DM-RS signals 506 from the spread DM-RS signals, that is, from the DM-RS signals that were spread by respective OCCs. Suitably, embodiments provide at least one DM-RS recovery circuit 606 for recovering one of the DM-RS signals that was spread using a respective OCC, which was OCC-m in the illustrated embodiment. A further DM-RS recovery circuit 608 can be provided for recovering a further DM-RS signal, if any, that was spread with a respective orthogonal cover code, which was OCC-n in the illustrated embodiment.

The recovered DM-RS signals are used by one or more than one channel estimator to determine channel characteristics associated with the one or more than one antenna port or one or more than one time slot of a given antenna port or given antenna ports. In the embodiment shown, two channel estimators 610 and 612 are used. The two channel estimators 610 and 612 are associated with the one or both of the two antenna ports 518 and 520 respectively. The channel estimators 610 and 612 can be realised as separate entities or as a combined entity that is capable of processing DM-RS signals in particular DM-RS signals that have been spread using OCCs having different code lengths; hence the dashed box 613 to signify a combined entity. The channel estimators 610 and 612 can be embodiments of the above channel estimators 130 and 304 described with reference to FIGS. 1 and 3.

It can be appreciated that the channel estimation can be performed by a channel estimator, such as, for example, one or more of channel estimators 304, 610, 612 and 613. Suitably, any and all embodiments can provide a method of processing a demodulation reference signal spread using a respective orthogonal cover code. It will be recalled that the demodulation reference signals have been spread using respective OCCs. One or more than one of the recovery circuits 606 and 608 performs despreading of the demodulation reference signal using a further orthogonal cover code, which is different to the OCC used to spread one or more of the demodulation reference signals. Therefore, embodiments can be realised in which a respective orthogonal cover code used for spreading a demodulation reference signal is different to a further orthogonal cover code used to despread the demodulation reference signal. Embodiments can be realised in which the respective orthogonal cover code and the further orthogonal cover code have different code lengths. For example, a spreading orthogonal cover code can have a length of four whereas a despreading orthogonal cover code can have a length of two. By despreading modulation symbols using a different length OCC allows a unified or simpler channel estimation technique to be used. For example, using OCC-2 despreading in respect of modulation symbols that have been spread using OCC-4 allows a simpler receiver to be realised.

It can be appreciated that the embodiments provide for the one or more than one demodulation reference signal being received by one or more than one antenna port. Accordingly, embodiments are provided comprising receiving the one or more than one demodulation reference signal via a respective antenna port. Alternatively, or additionally, embodiments can be provided in which the one or more than one demodulation reference signal is associated with a respective antenna port.

Having received the one or more than one demodulation reference signal, the characteristics of a channel bearing that one or more than one demodulation reference signal can be determined or assessed. Such a determination or assessment can optionally be conducted, for example, in the presence of an interference signal. The interference signal can comprise modulation symbols. The modulation symbols can represent the demodulation reference signal spread using a respective orthogonal cover code. The modulation symbols can be associated with a respective antenna port. The respective antenna port can comprise an antenna port selected from a set of antenna ports. The set of antenna ports can comprise one or more than one of antenna ports 7, 8, 11 and 13 taken jointly and severally in any and all permutations. Accordingly, embodiments can be provided in which the despreading of a demodulation reference signal using a further orthogonal cover code comprises despreading the demodulation reference signal using the further orthogonal cover code in the presence of an interference signal associated with an interfering antenna port.

Embodiments are provided in which the channel estimator(s) 610, 612 and/or 613 estimate channel characteristics using the despread demodulation reference signal 606 and/or 608. Such channel estimating, or such estimating of channel characteristics, can comprise performing at least a pair of channel estimates respectively associated with first and second time slots bearing the demodulation reference signal. Part of the processing of estimating can comprise multiplying the channel estimate associated with the second time slot by a factor such as, for example, the factor is −1.

Having obtained channel estimates, embodiments can perform channel interpolation filtering based on said at least a pair of channel estimates. For example, performing at least a pair of channel estimates respectively associated with first and second time slots bearing the demodulation reference signal can comprise performing a channel estimation for a first time slot associated with a respective antenna port.

Embodiments can be provided in which the channel estimate for the first time slot associated with a respective antenna port is ĥ_{1,1}=½(y₁s′₁+y₂s′₂)=h₁+η₁, where s′₁ and s′₂ are estimates corresponding to received modulation symbols associated with the first time slot, y₁ and y₂ are signals bearing the modulation symbols associated with the first time slot, η₁ is noise associated with the respective antenna port, and h₁ is the channel associated with the respective antenna port.

Additionally, or alternatively, embodiments are provided in which performing at least a pair of channel estimates respectively associated with first and second time slots bearing the demodulation reference signal comprises performing a channel estimation for a second time slot associated with a respective antenna port. For example, the channel estimate for the second time slot associated with a respective antenna port is given by ĥ_{1,2}=½(y₃s′₃+y₄s′₄)=−h₁+η₁, where s′₃ and s′₄ are estimates corresponding to received modulation symbols associated with the second time slot, y₃ and y₄ are signals bearing the modulation symbols associated with the second time slot, η₁ is noise associated with the respective antenna port, and h₁ is the channel associated with the respective antenna port. Having obtained ĥ_{1,2}, embodiments can provide for multiplying ĥ_{1,2}=½(y₃s′₃+y₄s′₄)=−h₁+η₁ by −1 to give ĥ_{1,2}=h₁+η′₃, where η′₃ is noise associated with the respective antenna port. At least one of ĥ_{1,1} and ĥ_{1,2} can be used in performing channel interpolation filtering based on the despread channel estimations in the first and second time slots. Embodiments can give a final channel estimate using

$$H = {W}^{T} [ \begin{matrix}{\hat{h}}_{1 , 1} \\ {\hat{h}}_{1 , 2}\end{matrix} ] ,$$

where H is the final channel estimate and W is the channel interpolation filter such as, for example, a Minimum Mean Square Error filter.

In light of the above, embodiments can be realised in which OCC-2 processing, that is, despreading using OCC-2, can be applied for despreading the demodulation reference signal. The despreading can be performed for a demodulation reference signal in respect of first and second time slots to provide channel estimates for the first and second time slots. Channel interpolation can be performed using the channel estimates for the first and second time slots. Such channel interpolation can comprise multiplying the channel estimate associated with the second time slot by −1.

Therefore, OCC-2 processing can be used to despread modulation symbols such as one or more than one of the demodulation reference signals even though one or both of demodulation reference signals was spread using a different length orthogonal cover code such as, for example, an OCC-4. Suitably, embodiments can be realised in which a target UE is scheduled with a demodulation reference signal that has been spread using OCC-4 via antenna port 11 or 13 and in respect of which an interference signal has been scheduled using an antenna port randomly selected from antenna ports {7, 8, 13} or {7, 8, 11} respectively and in which the above OCC-2 despreading and channel estimating is applied notwithstanding OCC-4 spreading. A further example comprises the target antenna port being port 11, and the co-scheduled antenna port being port 8.

Embodiments can be realised in which modulation symbols associated with a given target antenna port and a given co-scheduled antenna port are processed. The modulation symbols can represent or be associated with a demodulation reference signal. The demodulation reference signal can be spreading using OCC-4. The received signals are despreading using OCC-2 despreading for the modulation symbols in the first and second time slots and applied to determine respective channel estimates as follows: ĥ_{1,1}=½(y₁s′₁+y₂s′₂)=h₁+h₂+η₁, where s′₁ and s′₂ are estimates corresponding to received modulation symbols associated with the first time slot, y₁ and y₂ are signals bearing the modulation symbols associated with the first time slot, η′₁ is noise associated with the respective antenna port, and h₁ is the channel associated with the respective antenna port.

Additionally, or alternatively, embodiments are provided in which performing at least a pair of channel estimates respectively associated with first and second time slots bearing the demodulation reference signal comprises performing a channel estimation for a second time slot associated with a respective antenna port. For example, the channel estimate for the second time slot associated with a respective antenna port is given by ĥ_{1,2}=½(y₃s′₃+y₄s′₄)=(−h₁+h₂)+η′₃, where s′₃ and s′₄ are estimates corresponding to received modulation symbols associated with the second time slot, y₃ and y₄ are signals bearing the modulation symbols associated with the second time slot, η′₃ is noise associated with the respective antenna port, and h₁ is the channel associated with the respective antenna port. Having obtained ĥ_{1,2} embodiments can provide for multiplying ĥ_{1,2}=½(y₃s′₃+y₄s′₄)=(−h₁+h₂)+η′₃ by −1 to give ĥ_{1,2}=h₁=h₂−η′₃, where η′₃ is noise associated with the respective antenna port. At least one of ĥ_{1,1} and ĥ_{1,2} can be used in performing channel interpolation filtering based on the despread channel estimations in the first and second time slots. Embodiments can give a final channel estimate using

$$H = {W}^{T} [ \begin{matrix}{\hat{h}}_{1 , 1} \\ {\hat{h}}_{1 , 2}\end{matrix} ] ,$$

where H is the final channel estimate and W is the channel interpolation filter such as, for example, a Minimum Mean Square Error filter. In the foregoing, for low Doppler spread cases, the difference in interpolation filter coefficients in the first and second time slot will be small, which yields a relatively accurate final channel estimation.

Once the channel estimates have been determined, the data associated with those channels can be used in decoding data and other signals received via those channels. Suitably, embodiments can further provide one or more than one decoder 614 and 616 for decoding signals using the channel estimates. Although the embodiments have been described with reference to using one or more than one decoder, embodiments could additionally or alternatively provide one or more than one encoder that encodes data for transmission using the channel estimates.

The recovered DM-RS signals were transmitted using different length orthogonal cover codes. In the embodiment depicted, the orthogonal cover codes have code lengths of m and n. Embodiments can be realised in which the code lengths of the orthogonal cover codes are 2 and 4. Alternatively or additionally, any and all embodiments herein can be realised in which m=n. For example, embodiments can be realised in which m=n=4. Alternatively, or additionally, embodiments can be realised in which an OCC is selected from a set of OCCs that is a subset of another set of OCCs. Embodiments can be realised in which one of the OCCs is an OCC-2 while the other of the OCCs is an OCC-4. The antenna ports could be antenna ports selected from a set of antenna ports such as, for example, antenna ports {7, 8, 11, 13} taken jointly and severally in any and all permutations.

Embodiments can be realised that use the DM-RS signal as part of testing one or more than one target port. For example, embodiments can be realised in which a DM-RS signal is spread with a respective OCC and transmitted via a respective antenna port. An example, of such an embodiment would be testing antenna port 11 by receiving a DM-RS signal spread using an OCC-4. The testing can be done in isolation or in the presence of a further signal. The further signal can be, or can represent, an interference signal transmitted on a respective antenna port. For example, the further signal can comprise the DM-RS signal spread using a respective OCC, such as, for example, OCC-2 or OCC-4, and transmitted or received via antenna port 7.

Although the above embodiment has been described with reference to the signals being received by a UE 602, which can be an embodiment of any UE described herein, embodiments can be realised in which the signals are received by a plurality of UEs. The plurality of UE can comprise, for example, a pair of UE as described above with reference to FIG. 2.

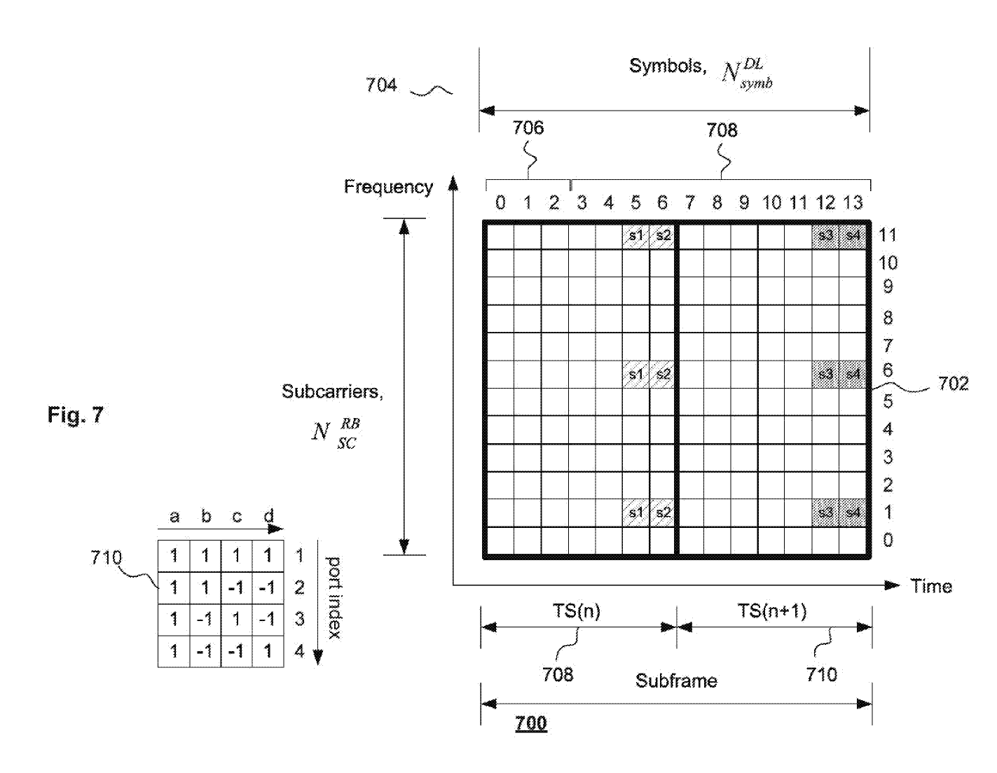

FIG. 7 schematically illustrates a view 700 of a resource block 702, bearing DM-RS resources, of a part of a subframe. The subframe can be, for example, a downlink LTE subframe or other subframe, showing, at least in part, the structure of DM-RS resources, also known as a DM-RS resource pattern, for transmission or output for further processing by a base station such as, for example, the eNB 102 or other entity.

The transmitted signals could represent, for example, a control channel or a data channel. For example, the transmitted signals could represent at least one or more than one of a Physical Downlink Control Channel (PDCCH), a Physical Downlink Shared Channel (PDSCH), an enhanced Physical Downlink Control Channel (ePDCCH) or an enhanced Physical Downlink Shared Channel (ePDSCH) taken jointly and severally in any and all permutations. It will be appreciated that the enhanced channel will span more resources elements in the time domain.

An illustrative resource block 702 of a total of NRB resource blocks of the subframe 700 is shown in FIG. 7. The subframe 700 can comprise a number, N_{symb}^{DL}, of OFDM symbols 704 along the time axis and N_{RB}·N_{SC}^{RB} subcarriers along the frequency axis of which N_{SC}^{RB} subcarriers are shown. The illustrated example shows 12 subcarriers. In the illustrated embodiment, it is assumed that normal cyclic prefixes are used such that there are fourteen symbols per subframe. Embodiments can be realized in which extended cyclic prefixes are used.

It can be appreciated that embodiments provide for the DM-RS signals to be carried by one or more than one respective resource element, otherwise known as DM-RS resources. In the illustrated embodiment, the DM-RS resources comprise a predetermined set of resource elements. The predetermined set of resource elements can comprise, or span, at least one or more ODFM symbols. The one or more OFDM symbols can comprise groups of symbols such as symbols 5 and 6, and 12 and 13. Embodiments are provided in which the OFDM symbols are adjacent to one another. The predetermined set of resource elements can comprise prescribed subcarriers. The prescribed subcarriers can be either adjacent subcarriers or non-adjacent subcarriers.

The subframe 700 can comprise a set of L OFDM symbols (L=1, 2, 3) at the beginning of each subframe in a PDCCH region 706 spanning a predetermined number of OFDM symbols; a set, or width, of three OFDM symbols in this example arrangement. In other embodiments, the subframe or PDCCH transmission can use a different pattern or a different number of OFDM symbols. There is shown a PDSCH region 708 for carrying downlink data, which spans the remaining OFDM symbols of the subframe. It will be appreciated that embodiments can be realized in which some other number of OFDM symbols are used per time slot such as, for example, 6 OFDM symbols in the case of an extended cyclic prefix.

Embodiments are provided in which additional DM-RS antenna ports can be provided and used for higher order MIMO with a larger number of UEs, such as more than 2 UEs, and/or a larger number of layers can be assigned per UE such as 2, 3, 4, 8, 12, 16, 32, 64 or more layers. Example implementations support higher order MU-MIMO using orthogonal DM-RS multiplexing or spreading.

Still referring to FIG. 7, there is shown a set 710 of orthogonal cover codes of a prescribed length. In the illustrated embodiment, the prescribed length is 4, that is, the set is a set of OCC-4. The set of OCCs is indexed according to resource elements corresponding to respective antenna ports. The set of OCCs 710 is also indexed according to an antenna port number. In the example illustrated, there are four antenna ports. The antenna ports can relate to a predetermined set of antenna ports. Embodiments are provided in which the predetermined set of antenna ports comprises antenna ports {7, 8, 11, 13}.

It can be appreciated that the resource elements are grouped into pairs and labelled s1 and s2 and s3 and s4. There are provided two sets of pairs of resource elements, each distinguished by the background shading and labelled s1 or s2 and s3 or s4.

A given value of a prescribed DM-RS is multiplied by a respective OCC-4 code according to the antenna port index and the result is distributed or spread across the prescribed resource elements. It will be appreciate that the distribution is an embodiment of processing such as, for example, spreading or multiplexing. Therefore, embodiments can be realised in which the DM-RS is spread or multiplexed over the prescribed resource elements. Similarly, when recovering the DM-RS, the DM-RS will be similarly processed, that is, demultiplexed or despread from prescribed resource elements.

In the embodiment illustrated, each DM-RS of an antenna port is associated with 4 resource elements. Therefore, assuming resource elements of the ODFM symbols 5 and 6 and subcarrier 11 correspond to a predetermined antenna port, such as, for example, antenna port 7, a given bit of a DM-RS signal would be multiplied by the respective OCC-4 values dictated by the a, b, c, d, indices and transmitted using the respective resource elements of OFDM symbols 5, 6 in a first time slot 708, and OFDM symbols 12, 13 in a second time slot 710 using subcarrier 11. Therefore, a given DM-RS bit value would be multiplied by OCC-4 of 1,1,1,1 for the first antenna port.

It can be appreciated that embodiments can be realised in which the same DM-RS signal, having been multiplied by or spread by the selected OCC-4, can be carried by at least one or more than one further subcarrier. In the embodiment depicted, it can be appreciated that the spread DM-RS signal is carried by a set of subcarriers. The set of subcarriers can comprise, for example, subcarriers 1, 6 and 11. The set of subcarriers could comprise different subcarriers or a different set of such subcarriers. It can be seen that the same OFDM symbols are used, that is, symbols 5, 6 and 12, 13.

Although the above embodiments have been described with reference to OCC-4 based antenna port multiplexing of DM-RS signals, embodiments are not limited thereto. Embodiments can be realised that, alternatively or additionally, use other OCC lengths such as, for example, OCC-2, which has a code length of 2. Embodiments can be realised that use mixed length OCCs. For example, any or all embodiments can use OCC-2 and OCC-4 simultaneously.

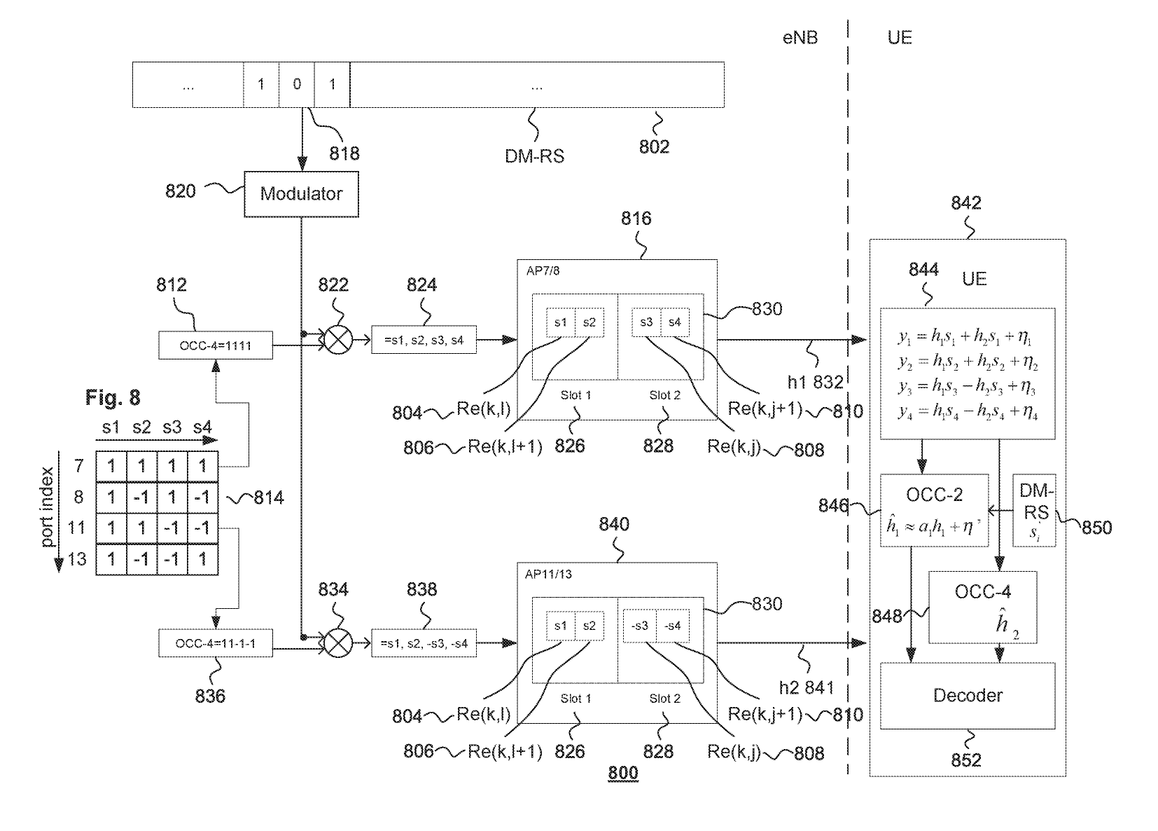

Referring to FIG. 8, there is shown a view 800 of an embodiment of DM-RS signal 802 multiplexing or spreading over DM-RS resources 804 to 810 using a prescribed or corresponding OCC 812. The prescribed or corresponding OCC can be selected from a set of OCCs 814. In the embodiment illustrated, the OCC 812 has a length of 4, that is, the OCC is OCC-4. The DM-RS resources 804 to 810 relate to at least one predetermined antenna port (AP) 816. The at least one predetermined antenna port 816 can be selected from a set of antenna ports. The set of antenna ports can comprise a predetermined number of antenna ports. Embodiments can be realised in which the predetermined number of antenna ports comprises four antenna ports. Embodiments can be realised in which the set of antenna ports comprises antenna ports {7, 8, 11, 13} taken jointly and severally in any and all permutations.

It can be appreciated that one or more data units, such as, for example, the depicted “0” 818, is or are converted, by a modulator 820, to a modulation symbol according to a prescribed modulation constellation. In the embodiment shown the prescribed modulation constellation is Quadrature Phase Shift Keying (QPSK). Therefore, the modulation symbols could be

$$\{ \frac{1 + j}{\sqrt{2}} , \frac{1 - j}{\sqrt{2}} , \frac{- 1 + j}{\sqrt{2}} , \frac{- 1 - j}{\sqrt{2}} \} .$$

The modulation symbol is multiplied, using a respective multiplier 822, by a selected OCC-4 such as, for example, the selected “1111” 812 OCC to produce a set of symbols 824. In the illustrated embodiment, the set of symbols comprises a predetermined number of symbols. The predetermined number of symbols can comprise four symbols. Therefore, an embodiment provides such a set of symbols as comprising symbols s1, s2, s3 and s4.

The symbols s1 to s4 are mapped to respective resource elements 804 to 810 of a respective antenna port 816. Symbols s1 and s2 can be associated with a respective time slot such as, for example, a first time slot 826. Symbols s3 and s4 can be associated with a respective time slot such as, for example, a second time slot 828. In the illustrated embodiment, the respective antenna port is antenna port 7. The symbols s1 to s4 can be transmitted, or can be output for transmission, as part of the same resource block 830. The symbols are transmitted over a respective channel such as, for example, channel h1 832.

The modulation symbol is also multiplied, using a respective multiplier 834, by a selected OCC-4 such as the selected “11-1-1” 836 OCC to produce a set of symbols 838. In the illustrated embodiment, the set of symbols comprises a predetermined number of symbols. The predetermined number of symbols can comprise four symbols. Therefore, an embodiment provides such a set of symbols as comprising symbols s1, s2, −s3 and −s4.

The symbols s1, s2, −s3 and −s4 are mapped to respective resource elements 804 to 810 of a respective antenna port 840. Symbols s1 and s2 are associated with a respective time slot such as, for example, the first time slot 826. Symbols s3 and s4 are associated with a respective time slot such as, for example, the second time slot 828. In the illustrated embodiment, the respective antenna port is antenna port 11. The symbols s1 to s4 are transmitted, or are output for transmission, as part of the same resource block 830. The symbols are transmitted, or output for transmission, over a respective channel such as, for example, channel h2 841.

FIG. 8 also shows a UE 842. The UE 842 can be an embodiment of any UE described in this specification. The UE 842 receives the symbols s1, s2, s3, s4 and s1, s2, −s3, −s4 transmitted over respective antenna ports as received signals y1, y2, y3 and y4 844.

It can be appreciated that

y₁=h₁s₁+h₂s₁+η₁,

y₂=h₁s₂+h₂s₂+η₂,

y₃=h₁s₃−h₂s₃+η₃ and

y₄=h₁s₄−h₂s₄+η₄,

where
h₁ is the channel transfer function for the first antenna port 816, h₂ is the channel transfer function for the second antenna port 840 and ηᵢ, i=1, 2, 3, 4 represent noise in the signals. The UE 842 processes the received signals to determine one or more than one estimate of at least one of the channel transfer functions h₁ and h₂.

Embodiments can be realised in which a legacy orthogonal cover code, OCC-2, is used to spread or despread the first antenna port signals such that channel estimations, ĥ_{1,1} and ĥ_{1,2} are determined for the first antenna port 816 after dispreading in the first 826 and second 828 slots, from ĥ_{1,1}=½(y₁s′₁+y₂s′₂)=h₁+h₂+η′₁ and ĥ_{1,2}=½(y₃s′₃+y₄s′₄)=h₁−h₂+η′₃, where ĥ_{i,j} represents the estimate of a transfer function for channel, hᵢ, using signals received in slot j, s′ᵢ, i=1, 2, 3, 4 represents

$$\frac{1}{{s}_{i}}$$

such that

$$\frac{{s}_{i}^{′}}{{s}_{i}} = 1$$

and η′ᵢ, i=1, 2, 3, 4 represent noise in the channels.

Interpolation can be used to generate channel estimates for resource elements other than those bearing DM-RS sequences. For example, interpolation based on time-frequency two dimension filtering or two one dimension MMSE can be realised. Embodiments can be realised that consider, firstly, time-domain MMSE and, secondly, frequency-domain interpolation such that a final channel estimation will jointly consider the channel dispreading results of the first 826 and second 828 time slots. Therefore, assuming that a₁ and a₂ are time domain filter coefficients for the first 826 and second 828 time slots respectively, embodiments can be realised in which a final time-domain channel estimation for a predetermined antenna port, such as, port 7 816, is given by ĥ₁=a₁(h₁+h₂+η′₁)+a₂(h₁−h₂+η′₃)≈a₁h₁+η′, where the difference between a₁ and a₂ is small. It can be appreciated that the estimate, ĥ₁, is independent of a contribution from h₂.

It can be appreciated that y₁ and y₂ are received in the first time slot 826 and y₃ and y₄ are received in the second time slot 828. Therefore, it can be appreciated that embodiments transmitting on port 7 using OCC-2 and port 11 using OCC-4 can provide a channel estimate for port 7 using OCC-2 with a relatively small error. Similarly, time-frequency two dimension filtering can provide an acceptable channel estimate.

The received signals 844 are processed by one or more than one channel estimator. In the embodiment shown, a first channel estimator 846 processes the received signals on the basis that the DM-RS signals are despread using OCC-2 to produce the above channel estimate. A second channel estimator 848 processes the received signals on the basis that the signals have been despread using OCC-4 to produce an estimate of the channel associated with the respective antenna port, which is AP 11 in the embodiment depicted. A duplicate signal, that is, the signal or symbols, s′ᵢ, that were initially transmitted such as, for example, the original DM-RS sequence or associated symbols, are generated by a respective generator 850. Generating the above symbols s′ᵢ can be responsive to a communication to generate such symbols received from a base station such as, for example, an eNB as described herein. Such a communication can comprise, for example, a DCI communication having a respective DCI format. The respective DCI format can be, for example, DCI format 0 or DCI format 4.

Having determined the channel estimates ĥ₁ and ĥ₂, a decoder 852, which can comprise a number of stages or entities but that is represented generically as a single entity, uses the channel estimates in processing subsequently received signals or in determining whether or not feedback to a transmitting entity would be beneficial. Such feedback can comprise the above Channel State Information. Such a transmitting entity could comprise the above described eNB.

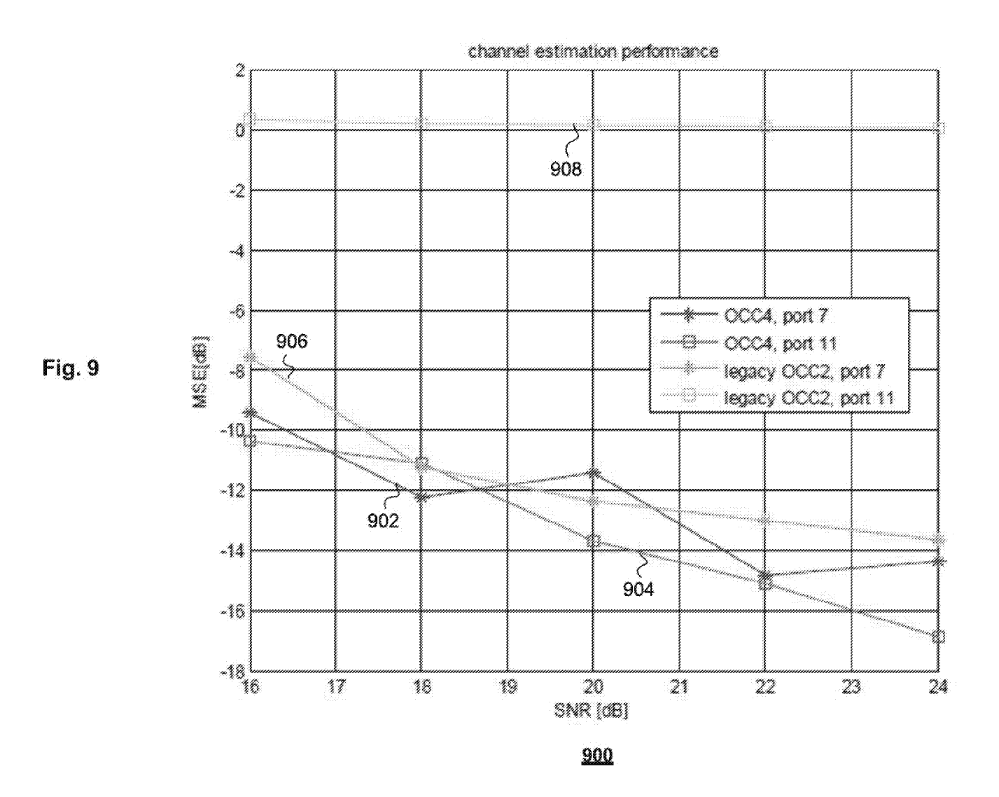

FIG. 9 shows a view 900 of a number of graphs comparing simulation results when using OCC-4 and OCC-2 spreading or despreading of the DM-RS. It can be appreciated that the channel estimation when using OCC-2 is good. First 902 and second 904 curves are shown for transmissions using OCC-4 spreading or despreading of a DM-RS on port 7 and OCC-4 spreading or despreading of a DM-RS on port 11. Third 906 and fourth 908 curves are shown for transmission using OCC-2 spreading or despreading of a DM-RS on port 7 and OCC-2 spreading or despreading of the DM-RS on port 11.

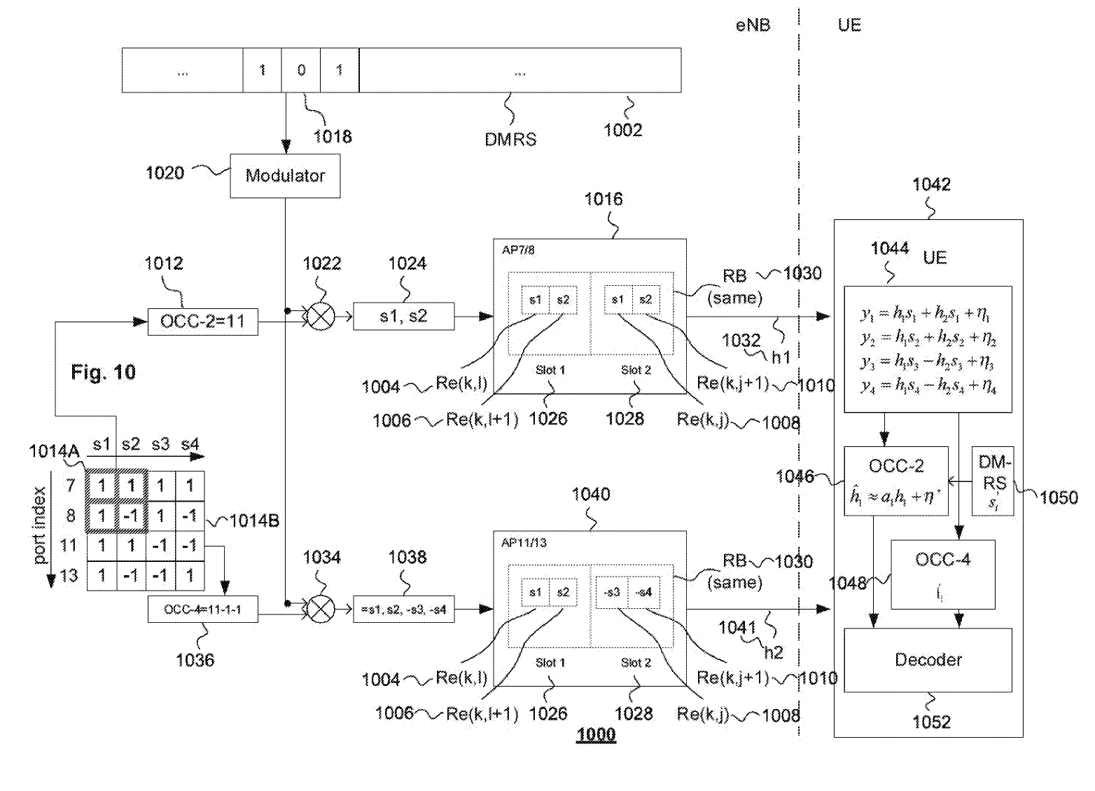

Referring to FIG. 10, there is shown a view 1000 of an embodiment of DM-RS signal 1002 multiplexing or spreading over DM-RS resources 1004 to 1010 using multiple orthogonal cover codes (OCCs). The multiple OCCs can be selected from a number of sets of OCCs 1014A and 1014B. In the embodiment depicted, a plurality of sets of OCCs are used. Embodiments can be realised in which two or more than two sets of OCCs are used. In the embodiment illustrated, the DM-RS signal 1002 is multiplexed over respective DM-RS resources 1004 to 1010 using a first set of OCCs 1014A and a second set of OCCs 1014B. Embodiments provide for the orthogonal cover code lengths of the first 1014A and second 1014B sets of OCCs being different. The first set of OCCs 1014A can comprise OCCs having a respective code length such as, for example, a length of 2. The second set of OCCs 1014B can comprise OCCs having a respective code length such as, for example, a length of 4. Therefore, embodiments can be realised in which the DM-RS signal 1002 is transmitted using mixed, that is, different length, OCCs. Embodiments can be realised in which the OCCs of the first set 1014A have a length of 2 while the OCCs of the second set 1014B have a length of 4.

The DM-RS resources 1004 to 1010 relate to at least one predetermined antenna port (AP) 1016. The at least one predetermined antenna port 1016 can be selected from a set of antenna ports. The set of antenna ports can comprise a predetermined number of antenna ports. Embodiments can be realised in which the predetermined number of antenna ports comprises two antenna ports. Embodiments can be realised in which the set of antenna ports comprises antenna ports {7, 8, 11, 13}. Embodiments can be realised in which selected pairs of antenna ports are used to transmit the DM-RS signal 1002. For example, the DM-RS signal 1002 can be transmitted using antenna ports 7 and 11; 7 and 13; 8 and 11; 8 and 13, or any other permutation of two ports selected from ports {7, 8, 11, 13}.

Therefore, embodiments can be realised in which a plurality of antenna ports are used to transmit a DM-RS signal using respective orthogonal cover codes. For example, antenna ports 7 and 11 could be used to transmit a DM-RS signal using respective OCCs. The respective OCCs could be OCC-2 and OCC-4 or vice versa.

It can be noted that OCC-2 is a subset of OCC-4, as can be appreciated from the heavy-lined box surrounding the first set of OCCs 1014A. Therefore, the mixed OCCs used for transmitting the DM-RS signal using different length OCCs can be derived from a common set of OCCs. In the embodiment shown, the first set of OCCs 1014A of length 2 can be derived from the second set of OCCs 1014B of length 4.

It can be appreciated that one or more data units, such as, for example, the depicted “0” 1018 is converted, by a modulator 1020, to a modulation symbol according to a prescribed modulation constellation. In the embodiment shown, the prescribed modulation constellation is Quadrature Phase Shift Keying (QPSK). Therefore, the modulation symbols could be

$$\{ \frac{1 + j}{\sqrt{2}} , \frac{1 - j}{\sqrt{2}} , \frac{- 1 + j}{\sqrt{2}} , \frac{- 1 - j}{\sqrt{2}} \} .$$

The modulation symbol is multiplied, using a respective multiplier 1022, by a selected OCC-2 such as the selected “11” 1012 OCC to produce a set of symbols 1024. The selected OCC-2 is selected from the first set 1014A of OCCS, or can be derived from a common set of OCCS. In the illustrated embodiment, the set of symbols comprises a predetermined number of symbols. The predetermined number of symbols comprises two symbols. Therefore, an embodiment provides such a set of symbols as comprising symbols s1 and s2.

The symbols s1 to s2 are mapped to respective resource elements 1004 to 1010 of a respective antenna port 1016. Would we need all of the resource elements 1004 to 1010? Would we used only two resources elements in the same time slot? Would we duplicate S1 and S2 in times slots 1 and 2? Symbols s1 1004 and s2 1006 can be associated with a respective time slot such as, for example, the first time slot 1026. Symbols s1 and s2 can be duplicated in, or associated with, a respective time slot such as, for example, the second time slot 1028. In the illustrated embodiment, the respective antenna port 1016 is antenna port 7. The symbols s1 1004 to s2 1010 can form part of, or be associated with, the same resource block 1030. The symbols can be transmitted, or output for transmission, over a respective channel such as, for example, channel h1 1032.

The modulation symbol is also multiplied, using a respective multiplier 1034, by a selected OCC-4 such as the selected “11-1-1” 1036 OCC to produce a set of symbols 1038. The selected OCC-4 is selected from the second set of OCCs 1014B. In the illustrated embodiment, the set of symbols comprises a predetermined number of symbols. The predetermined number of symbols can comprise four symbols. Therefore, an embodiment provides such a set of symbols as comprising symbols s1, s2, −s3 and −s4.

The symbols s1, s2, −s3 and −s4 are mapped to respective resource elements 1004 to 1010 of a respective antenna port 1040. Symbols s1 and s2 are in, or associated with, a respective time slot such as, for example, the first time slot 1026. Symbols s3 and s4 are in, or associated with, a respective time slot such as, for example, the second time slot 1028. In the illustrated embodiment, the respective antenna port is antenna port 11. The symbols s1 to s4 are transmitted, or are output to be transmitted, as part of the same resource block 1030. The symbols are transmitted, or output for transmission, over a respective channel such as, for example, channel h2 1041.

FIG. 10 also shows a UE 1042. The UE 1042 can be an embodiment of any UE described in this specification. The UE 1042 receives the symbols s1 and s2 and s1, s2, −s3, −s4 transmitted over respective antenna ports as received signals y1, y2, y3 and y4 1044.

It can be appreciated that

y₁=h₁s₁+h₂s₁+η₁,

y₂=h₁s₂+h₂s₂+η₂,

y₃=−h₂s₃+η₃ and

y₄=−h₂s₄+η₄,

where
h₁ is the channel transfer function for the first antenna port 1016, h₂ is the channel transfer function for the second antenna port 1040 and ηᵢ, i=1, 2,3, 4 represent noise in the signals. The UE 1042 processes the received signals to determine one or more than one estimate of at least one of the channel transfer functions h₁ and h₂. If a legacy orthogonal cover code, OCC-2, is used to despread the first antenna port signals, channel estimations, ĥ_{1,1} and ĥ_{1,2} are determined for the first antenna port 1016 after dispreading in the first 1026 and second 1028 slots, from ĥ_{1,1}=½(y₁s′₁+y₂s′₂)=h₁+h₂+η′₁ and ĥ_{1,2}=½(y₃s′₃+y₄s′₄)=h₁−h₂+η′₃, where ĥ_{i,j} represents the estimate of a transfer function for channel, hᵢ, using signals received in slot j, s′ᵢ, i=1, 2, 3, 4 represents

$$\frac{1}{{s}_{i}}$$

such that

$$\frac{{s}_{i}^{′}}{{s}_{i}} = 1$$

and η′ᵢ, i=1, 2, 3, 4 represent noise in the channels.

Interpolation can be used to generate channel estimates for resource elements other than those bearing DM-RS sequences. For example, interpolation based on time-frequency two dimension filtering or two one dimension MMSE can be realised. Embodiments can be realised that consider, firstly, time-domain MMSE and, secondly, frequency-domain interpolation such that a final channel estimation will jointly consider the channel dispreading results of the first 1026 and second 1028 time slots. Therefore, assuming that a₁ and a₂ are time domain filter coefficients for the first 1026 and second 1028 time slots respectively, embodiments can be realised in which a final time-domain channel estimation for port a predetermined antenna port, such as, port 7 1016, is given by ĥ₁=a₁(h₁+h₂+η′₁)+a₂(h₁−h₂+η′₃)≈a₁h₁+η′, where the difference between a₁ and a₂ is small.

It can be appreciated that y₁ and y₂ are received in the first time slot 1026 and y₃ and y₄ are received in the second time slot 1028. Therefore, it can be appreciated that embodiments transmitting on port 7 using OCC-2 and port 11 using OCC-4 can provide a channel estimate for port 7 using OCC-2 with a relatively small error. Similarly, time-frequency two dimension filtering can provide an acceptable channel estimate.

The received signals 1044 are processed by one or more than one channel estimator. In the embodiment shown, a first channel estimator 1046 processes the received DM-RS signals on the basis that the signals have been spread using OCC-2 to produce the above channel estimate, ĥ₁, for channel h₁. A second channel estimator 1048 processes the received DM-RS signals on the basis that the signals have been spread using OCC-4 to produce a channel estimate, ĥ₂, of the channel, h₂, associated with the respective antenna port, which is AP 11 in the embodiment depicted. A duplicate DM-RS signal, identical to the original DM-RS sequence, is generated by a respective generator 1050. Embodiments can be realised in which the generator 1050 generates the above symbols s′ᵢ. Generating the above symbols s′ᵢ can be responsive to a communication to generate such symbols received from a base station such as, for example, an eNB as described herein. Such a communication can comprise, for example, a DCI communication having a respective DCI format such as, for example, DCI format 0 or DCI format 4.

Having determined the channel estimates ĥ₁ and ĥ₂, a decoder 1052, which can comprise a number of stages or entities but that is represented generically as a single entity, uses the channel estimates in processing subsequently received signals or in determining whether or not feedback to a transmitting entity would be beneficial. Such feedback can comprise the above Channel State Information. Such a transmitting entity could comprise the above described eNB.

Although the embodiments described above use antenna ports 7 and 11 as the pair of antenna ports using different OCCs, embodiments can alternatively or additionally, be realised in which some other plurality of antenna ports can used such as, for example, antenna ports 8 and 13, antenna ports 7 and 13 and antenna ports 8 and 11. Still further, although the OCCs described with reference to FIG. 10 had different OCC lengths, embodiments can be realised in which OCCs having the same length, such as, for example OCC-4, are used. Furthermore, any and all embodiments herein can be realised in which transmissions can be co-scheduled using antenna ports 7 and 11 with respective length OCCs such as, for example, two, four or a mixture of two and four. Similarly, any and all embodiments herein can be realised in which transmissions can be co-scheduled using antenna ports 8 and 13 with respective length OCCs such as, for example, two, four or a mixture of two and four.

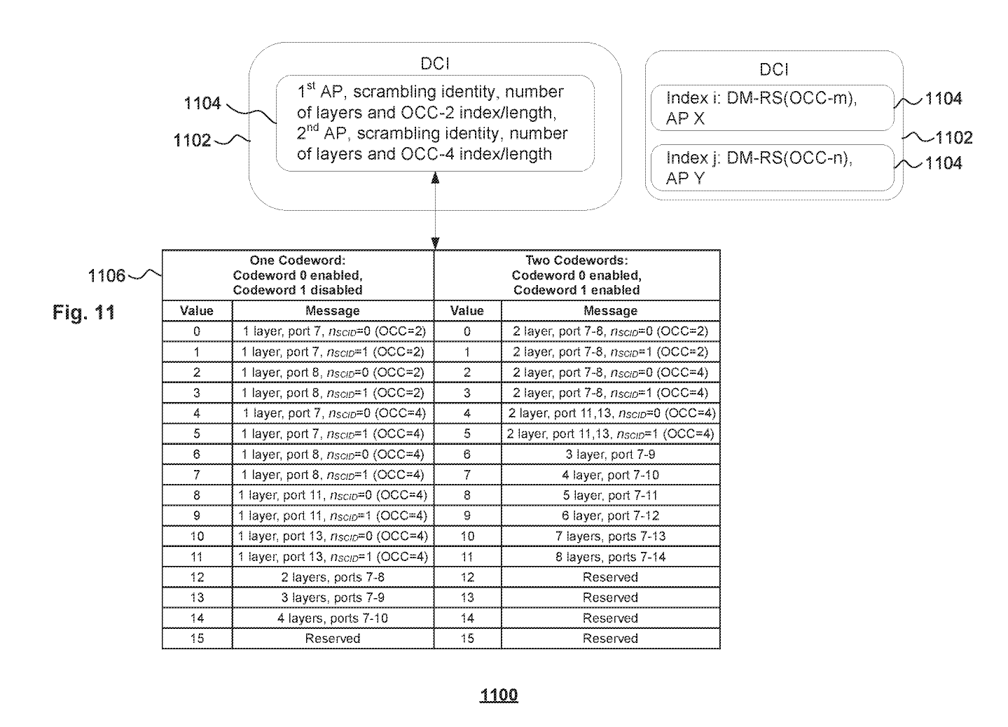

Referring to FIG. 11, there is shown a view 1100 of a message 1102 for communicating a prescribed configuration data to one or a plurality of UEs for use in supporting MU-MIMO communications. Such communications can comprise, for example, MU-MIMO based communications. The message 1102 can be associated with DM-RS port configuration or transmission. The message 1102 can comprise an index 1104, or other data, associated with, or representing, a number of configuration data sets or parameter sets. The configuration data sets or parameters sets can relate to at least one or more of respective antenna port(s) and orthogonal cover codes, with or without data additionally relating to a respective scrambling identity or respective scrambling identities or number of layers all taken jointly and severally in any and all permutations. The index 1104 can relate to one or more than one of the values shown in a configuration table 1106. The configuration table shows DM-RS port configurations that can be communicated in the message 1102. The table can comprise or be table 5.3.3.1.5C-2 from 3GPP TS 36.212 V13.1.0 (2016 March). Embodiments of the message can be realised as a DCI such as, for example DCI format 4, which is associated with DM-RS configuration.

Embodiments can be realised in which the configuration table comprises a number of sets of configuration data or parameter sets associated with at least antenna ports and respective orthogonal cover codes for DM-RS configuration. In the embodiment illustrated the configuration data comprises 16 sets of configuration data or 16 parameter sets; although the 16th set for both the single and double codewords are reserved.

The message 1102 is arranged to convey to the eNB and the UE the configuration for processing a DM-RS associated with prescribed antenna ports using respective orthogonal cover codes. The respective orthogonal cover codes have different code lengths or have the same code lengths.

Embodiments can be realised in which the message comprises data associated with a 1st antenna port and a respective OCC index/length and data associated with a 2nd antenna port and a respective OCC index/length. In the illustrated embodiment, the OCC code lengths can be different. Example implementations can use OCC-2 and OCC-4. The data can also additionally comprise data relating to respective scrambling identities, data relating to respective numbers of layers for transmission or data relating to both scrambling identities and such respective numbers of layers. For example, a DM-RS antenna port configuration might comprise data associated with antenna port 7 with a respective OCC-2 and antenna port 11 with a respective OCC-4. Example implementations can both use OCC-4 when the 1st antenna port is port 11 and the second antenna port is a port selected from {7, 8, 13} together with UE scrambling identities nSCID=0. Example implementations provide for one or more than one such message being associated with, or defining, a test or verification. Therefore, embodiments can be realised in which data associated with the 1st antenna port comprises data associated with a target antenna port of antenna port 11 bearing, or to bear, modulation symbols under test mapped to antenna port 11, and data associated the 2nd antenna port is data identifying or defining an interference antenna port as an antenna port selected from antenna ports 7, 8 and 13 bearing, or to bear, modulation symbols of an interference signal. Target and interference signals can be destined for different real or notional UEs. The UEs can have respective scrambling identities such as, for example, both scrambling identities being nSCID=0. The modulation symbols of both the target and interference modulation symbols can both be spread using OCC-4.

The message 1102 can be arranged to contain the foregoing data explicitly or can use the values of the “Value” column of the table as indices to a desired DM-RS antenna port configuration. For example, the indices or values could be 0 and 9 in a situation where a single codeword is used, or 0 and 4 in a situation where a double codeword is used. As indicated above, embodiments can be realised in which pairs of antenna ports, selected from the group {7, 8, 11, 13}, with different length orthogonal cover code are used for DM-RS antenna port configuration. In general, embodiments can be realised in which the pairs of antenna port configurations are selected such that a 1st AP and a respective orthogonal cover code of length m, OCC-m, and a 2nd AP and a respective orthogonal cover code of length n, OCC-n, are used for DM-RS antenna port configuration. Such embodiments can be realised in which n=m. Embodiments can be realised in which n=m=4, that is, OCC-4 is used for spreading the above modulation symbols.

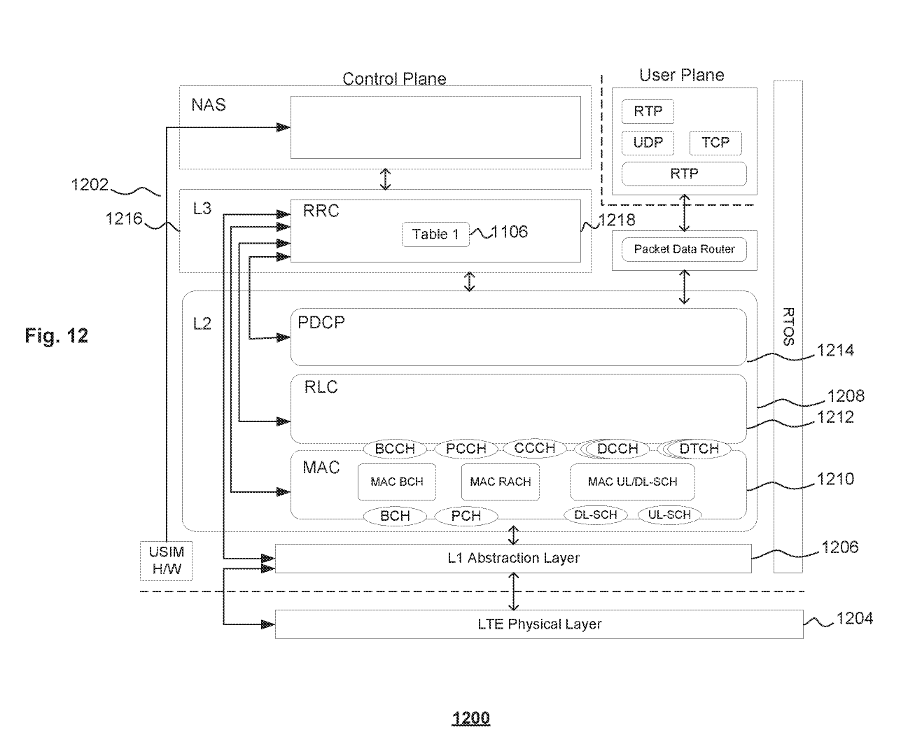

FIG. 12 shows a view 1200 of a Long Term Evolution-Advanced (LTE-A)/LTE-A Pro protocol stack 1202. The stack 1202 comprises a physical layer 1204 coupled, via an L1 abstraction layer 1206, to an L2 layer 1208, more particularly, to a Media Access Control (MAC) layer 1210 within the L2 layer 1208. The L2 layer 1208 can additionally comprise a Radio Link Control (RLC) layer 1212 and a Packet Data Convergence Protocol (PDCP) layer 1214.

The L2 layer 1208 is coupled to a higher layer. An embodiment of such a higher layer is an L3 layer 1216. The L3 layer 1216 can comprise a Radio Resource Control layer (RRC) 1218. The RRC 1218 can control the entities of the L2 layer 1208.

Such a higher layer entity, such as, for example, a L3 layer entity like the RRC 1218, can be arranged to establish a desired or selectable configuration for DM-RS antenna port configuration, which, as indicated above, can comprise a number of antenna ports and respective orthogonal cover code lengths, optionally together with respective scrambling identities and numbers of layers taken jointly and severally in any and all permutations. Embodiments can be provided in which the configuration tables comprise configuration data or parameters sets for indicating antenna port(s), scrambling identity, number of layers and OCC configurations taken jointly and severally in any and all permutations for DM-RS transmissions.

A desired DM-RS antenna port configuration is selected from a configuration table such as, for example, the configuration table 1106 described with reference to and/or as shown in FIG. 11. Furthermore, one or more additional tables can be provided that comprise a legacy table such as, for example, Table 5.3.3.1.5C-1 as defined in 3GPP TS 36.212 V12.6.0 (2015 September) or earlier Technical Standard.

It will be appreciated that embodiments extend DM-RSs for UEs in a manner to manage, such as, reduce, mutual interference as between DM-RS ports. Consequently, an eNB, such as the above described eNB 102, can increase the number of non-interfering DM-RS ports for MU-MIMO such as, for example, an increased number of orthogonal DM-RS ports for MU-MIMO or an increased number of DM-RS ports for MU-MIMO that are associated with non-interfering antenna beams or patterns.

Enabling of co-scheduled antenna ports using different length orthogonal cover codes can be facilitated by using higher layer configuration similar to higher layer configuration of an alternative modulation and coding scheme (MCS) table for 256QAM.

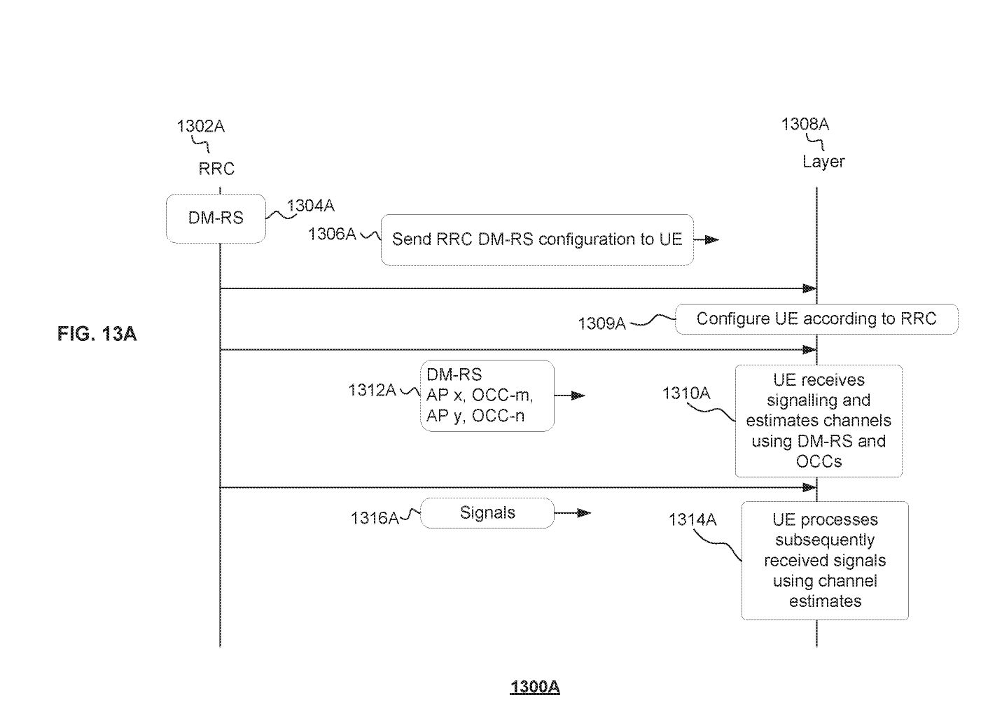

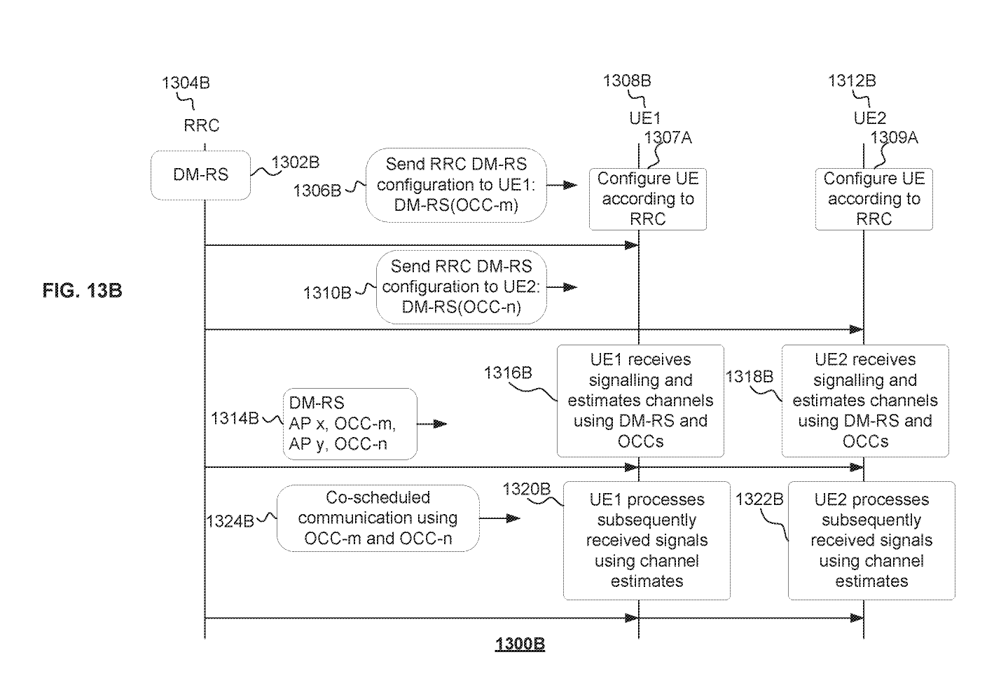

Referring to FIG. 13A, there is shown a view 1300A of a protocol for communicating a DM-RS antenna port or resource configuration. The prescribed DM-RS antenna port configuration comprises information relating to a target resource configuration for transmitting a DM-RS signal. The DM-RS antenna port configuration can comprise, at least, a number of antenna ports and respective OCCs for DM-RS spreading across respective resource elements. Embodiments can be realized in which the configuration is a higher layer configuration prescribed by, or associated with, a higher layer such as, for example, L3 or above. Embodiments can be realized in which the protocol is realized using the Radio Resource Control (RRC) messages or signalling.

A determination can be made by a radio resource controller 1302A regarding a prescribed DM-RS antenna port configuration selected from table 1104. The radio resource controller 1302A can be an embodiment of the above described radio resource controller 1216.

A message 1306A for communicating the prescribed DM-RS antenna port configuration is output for transmission to a predetermined layer 1308A of a device such as, for example, a UE. The message can be, for example, the above message described with reference to and/or as shown in FIG. 11. The UE processes, at 1309A, the RRC DM-RS antenna port configuration and, can optionally, pass the data to a relevant higher layer such as, for example, L3 or above. The UE can then be configured to receive and process the DM-RS signals multiplexed across multiple resource elements and/or antenna ports using respective length orthogonal cover codes to produce channel estimates using the above described channel estimator 130. The OCCs can have the same length, such as, for example, OCC-4, or different lengths such as, for example, OCC-2 and OCC-4. One skilled in the art will appreciate that communicating the lengths of the OCC provides a receiving UE with an indication of how to process an associated DM-RS to recover one or more than one DM-RS previously spread over a set of resource elements. Having been appropriately configured to receive prescribed DM-RS antenna port configurations, the UE can receive and commence channel estimation at 1310A using the DM-RS signals 1312A.

Having obtained channel estimates for the prescribed antenna ports from the DM-RS signals transmitted using respective length OCCs, the UE can process and decode, at 1314A, subsequently received signals, 1316A, using the channel estimates in the decoder such as, for example, decoders 852 and 1052. Embodiments can be realised in which OCC-m has a different length to OCC-n. Embodiments can be realised in which the lengths of OCC-m and OCC-n are the same such as, for example, 4, that is, OCC-4.

Referring to FIG. 13B, there is shown a view 1300B of a protocol. The protocol can be used for at least one of communicating a DM-RS antenna port or resource configuration or supporting multi-user communication, or both. The multi-user communication can comprise communications realised using respective OCCs. The OCCs can have different lengths.

The prescribed DM-RS antenna port configuration comprises information relating to a target resource configuration for transmitting a DM-RS signal. The DM-RS antenna port configuration can comprise a number of antenna ports and respective OCCs for DM-RS spreading across respective resource elements. Embodiments can be realized in which the configuration is a higher layer configuration prescribed by, or associated with, a higher layer such as, for example, L3 or above. Embodiments can be realized in which the protocol is realized using, at least in part, the Radio Resource Control (RRC) messages or signalling.

A determination 1302B can be made by a radio resource controller 1304B regarding a prescribed DM-RS antenna port configuration selected from table 1104. The determination can comprise or relate to a command received, or command to be issued, or both, to use one or more than one OCC for communications. Embodiments can be realized in which the one or more than one OCC comprises a plurality of OCCs. The plurality of OCCs can comprise OCCs having different code lengths. The radio resource controller 1304B can be an embodiment of the above described radio resource controller 1216 or any other entity associated with configuring communications.

A message 1306B for communicating the prescribed DM-RS antenna port configuration is output for transmission, or is transmitted, to a predetermined layer of a device such as, for example, a first UE 1308B. The message can be, for example, a message such as those described with reference to and/or as shown in FIG. 11.

A message 1310B for communicating a prescribed DM-RS antenna port configuration is output for transmission to a predetermined layer of a device such as, for example, a second UE 1312B. The message can be, for example, a message such as those described with reference to and/or as shown in FIG. 11.

The above messages can both comprise data associated with the same DM-RS signal. The above messages can comprise data associated with respective lengths of orthogonal cover codes to be used in dispreading signals received by the UEs 1308B and 1312B.

The first UE 1308B processes, at 1307B, the RRC DM-RS antenna port configuration and, can optionally, pass the data to a relevant higher layer such as, for example, L3 or above. The first UE 1308B can then be configured to receive and process the DM-RS signals multiplexed across multiple resource elements and/or antenna ports using respective length orthogonal cover codes to produce channel estimates using the above described channel estimator 130. One skilled in the art will appreciate that communicating the lengths of the OCC provides a receiving UE with an indication of how to process an associated DM-RS to recover one or more than one DM-RS signal previously spread over a set of resource elements. Having been appropriately configured to receive signals according to the prescribed DM-RS antenna port configurations, the first UE 1308B can receive one or more than one DM-RS signal 1314B output by the eNB 1304B and commence channel estimation at 1316B using the DM-RS signals 1314A.

The second UE 1312B processes, at 1309B, the RRC DM-RS antenna port configuration and, can optionally, pass the data to a relevant higher layer such as, for example, L3 or above. The second UE 1312B can then be configured to receive and process the DM-RS signals multiplexed across multiple resource elements and/or antenna ports using different length orthogonal cover codes to produce channel estimates using the above described channel estimator 130. One skilled in the art will appreciate that communicating the lengths of the OCC provides a receiving UE with an indication of how to process an associated DM-RS to recover one or more than one DM-RS signal previously spread over a set of resource elements. Having been appropriately configured to receive signals according to the prescribed DM-RS antenna port configurations, the second UE 1312B can receive one or more than one DM-RS signal 1314B output by the eNB 1304B and commence channel estimation at 1318B using the DM-RS signals 1314A.

Additionally or alternatively, having obtained respective channel estimates using the DM-RS signals transmitted using respective length OCCs, the UEs 1308B and 1312B can process and decode, at 1320B and 1322B, subsequently received co-scheduled signals, 1324B, using the channel estimates in respective decoders such as, for example, decoders 852 and 1052. The subsequently received co-scheduled signals 1324B can be transmitted using different length orthogonal cover codes via respective antenna ports.

The lengths of the orthogonal cover codes can comprise code lengths of 2 and 4 such that, for example, OCC-m can be OCC-2 and OCC-n can be OCC-4. Each DM-RS configuration can relate to one or more than one respective antenna port such as, for example, antenna ports x and y, represented as APx and APy. The antenna ports can be selected from a set of antenna ports. The set of antenna ports can be {7, 8, 11, 13}. Embodiments can be realized in which a first antenna port of APx and APy is antenna port 11 and a second antenna port of APx and APy is selected from one or more than one of the remaining antenna ports. Suitably, embodiments can be realised in which APx is antenna port 11 and APy is antenna port 7. Alternatively, or additionally, embodiments can be realized in which APx is antenna port 11 and APy is antenna port 8. Alternatively, or additionally, embodiments can be realized in which APx is antenna port 11 or 13 and APy is antenna port 7 or 8. Embodiments can be realised in which modulation symbols under test can be mapped to antenna port 11 and modulation symbols of an interference signal can be mapped to one of antenna ports 7, 8 and 13. Antenna port 11 can be associated with a respective real or virtual UE, having a UE scrambling identity of nSCID=0 and use OCC-4. Additionally, one of antenna ports 7, 8 and 13 can be associated with a respective real or virtual UE, having a UE scrambling identity of nSCID=0 and use OCC-4.

Embodiments can be realized in which the first antenna port is a target antenna port to be assessed for performance against one or more than one performance criterion and in which the second antenna port is configured to bear an interference signal in the presence of which the performance of the first antenna port is to be assessed.

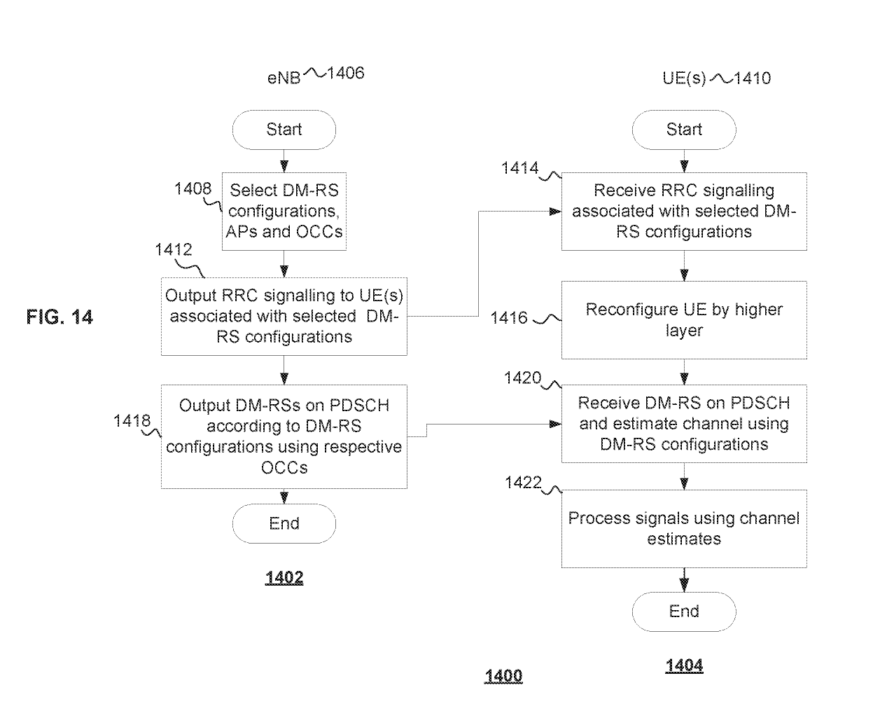

Referring to FIG. 14, there is shown a view 1400 of flowcharts 1402 and 1404 of embodiments for configuring at least one device such as, for example, a UE to operate using DM-RS antenna port configurations using different length orthogonal cover codes.

An apparatus, such as, for example, an eNB 1406, which can be an embodiment of the above eNB 102 or other base station, or an apparatus for such an eNB or other base station, configures or selects, at 1408, a multi-port DM-RS resource configuration, using respective OCCs, for transmission to a UE 1410, which can be the above UE 104, using higher layer signaling such as, for example, RRC signalling. Embodiments can be realised in which the multi-port configuration comprises antenna port 11, as a target antenna port under test for bearing modulation symbols of a signal under test, and a further antenna port, selected from antenna ports 7, 8, and 13, to bear modulation symbols of an interference signal. The antenna ports can use respective OCCs. Embodiments can be realised in which the respective OCCs are both OCC-4.

The eNB 1406 transmits, at 1412, a message such as, for example, a RRC message or messages, indicating a prescribed DM-RS antenna port configuration to the UE 1410. The message can be an embodiment of the messages described above with reference to FIG. 11.

At 1414, the UE 1410 receives the message associated with the DM-RS antenna port resource configuration and is reconfigured, at 1416, by a higher layer to operate or otherwise process the DM-RS signals according to the antenna port DM-RS mapping. The higher layer can be, for example, Layer 3 or above, such as, for example, the RRC layer, At 1418, the apparatus such as, for example, the above eNB, outputs data or signals for transmission to the UE 1410, or transmits DM-RS signals, spread using respective length orthogonal cover codes, over respective antenna ports according to the above DM-RS resource configurations to the UE 1410.

At 1420, the UE 1210 receives and decodes prescribed DM-RS signals in accordance with the DM-RS resource configurations and uses the DM-RS signals to estimate one or more characteristics of one or more than one wireless communication channel or a parameter associated with such a channel. The DM-RS signals can be conveyed using a channel. The channel can be a shared channel. The shared channel can be, for example, a PDSCH.

At 1422, the UE 1410 processes subsequently received signals sent via the channels corresponding to the channel estimates. Embodiments can be realised in which the channel estimates use one or more of the above channel estimates described with reference to FIG. 6. The UE 1410 uses the channel estimates to decode the subsequently received signals.

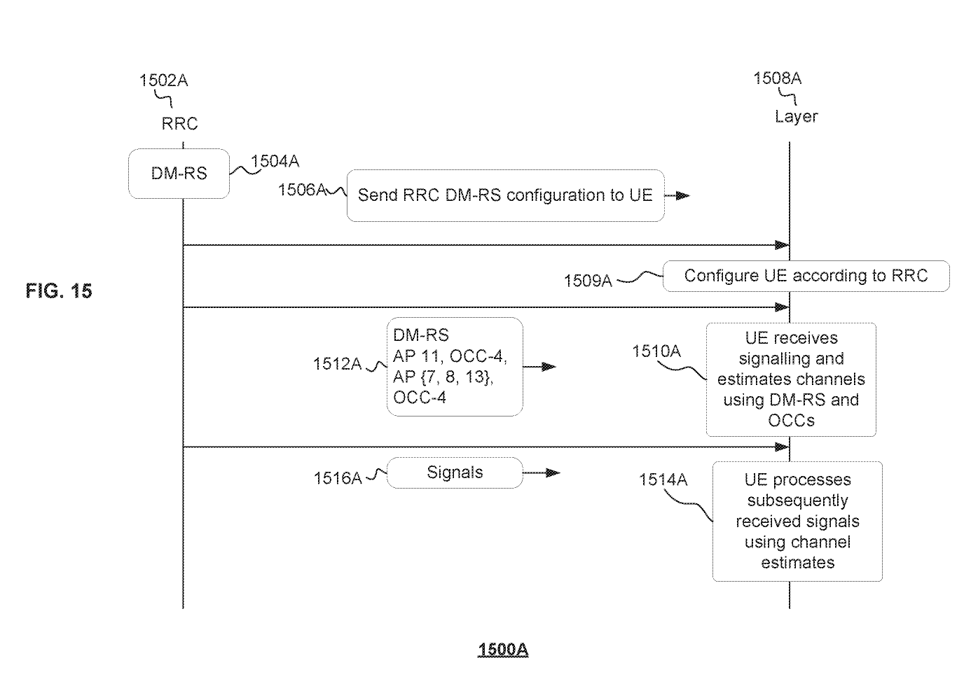

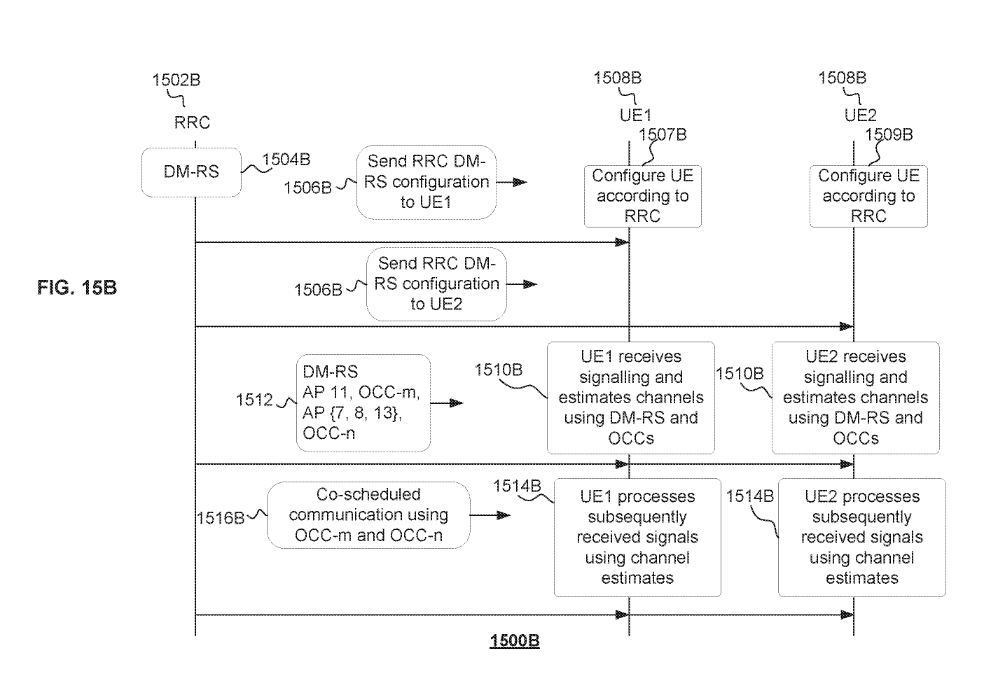

Referring to FIG. 15A, there is shown a view 1500A of a protocol for communicating a DM-RS antenna port or resource configuration associated with testing antenna port performance. The antenna port performance could comprise testing for a level of interference or could be any other test. The prescribed DM-RS antenna port configuration can comprise information relating to a target resource configuration for carrying, that is, transmitting or receiving, modulation symbols. Embodiments can be realised in which the modulation symbols comprise or represent a DM-RS signal, spread or to be spread using a respective OCC. The DM-RS antenna port configuration can comprise at least one or more than one antenna port and one or more than one respective OCC. The one or more than one respective OCC is used to spread a respective DM-RS signal over respective resource elements.

Embodiments can be realized in which the configuration is a higher layer configuration prescribed by, or associated with, a higher layer such as, for example, L3 or above. Embodiments can be realized in which the protocol signalling is realized, at least in part, using the Radio Resource Control (RRC) messages or signalling.

A determination can be made by a radio resource controller 1502A regarding a prescribed DM-RS antenna port configuration 1504A.

A message 1506A for communicating the prescribed DM-RS antenna port configuration is output for transmission to a predetermined layer 1508A of a device such as, for example, a UE. The message can be, for example, the above message described with reference to and/or as shown in FIG. 11. The UE processes, at 1509A, the DM-RS antenna port configuration and, can optionally, pass the data to a relevant higher layer such as, for example, L3 or above. The UE can then be configured to receive and process the one or more than one DM-RS signal spread over one or more respective antenna ports using respective length orthogonal cover codes to produce channel estimates using the above described channel estimator 130. One skilled in the art will appreciate that communicating the lengths of the OCCs can comprise providing a receiving UE with an indication of how to process an associated DM-RS to recover one or more than one DM-RS previously spread over a set of resource elements. Having been appropriately configured to receive prescribed DM-RS antenna port configurations, the UE can receive and commence channel estimation at 1510A using the DM-RS signals 1512A.

Having obtained channel estimates for the prescribed antenna ports from the DM-RS signals transmitted using different length OCCs, the UE can process and decode, at 1514A, subsequently received signals, 1516A, using the channel estimates in the decoder such as, for example, decoders 852 and 1052.

Embodiments can be realised in which the RRC 1502 prescribes a target port for testing using a DM-RS spread with a corresponding OCC. In the illustrated embodiment, the target port is antenna port 11 and the spreading OCC has a code length of 4. In the embodiment illustrated, a scrambling identifier, nSCID, can be provided. Embodiments can be realised in which the nSCID has a value of zero. Suitably, an embodiment can be realised in which a target antenna port for testing has DM-RS configuration data of antenna port 11, OCC-4 and nSCID=0.

Embodiments can be realised in which an additional predetermined signal such as, for example, a DM-RS transmission via a respective antenna port, spread using a respective OCC, is also transmitted. Embodiments can be realised in which an interfering antenna port or further test antenna port is configured to transmit a predetermined signal. The predetermined signal can be the DM-RS signal transmitted on another antenna port selected from a set of antenna ports {7, 8, 13} such as antenna port 7. The predetermined signal can be spread with an OCC having a respective code length. Therefore, an embodiment can be realised in which an interfering antenna port or further test antenna port is antenna port 7 carrying the DM-RS signal spread using an OCC having a code length of 4. Although the embodiment described uses antenna port 7 as the interfering or further test antenna port, embodiments are not limited to that antenna port. Embodiments can be realised in which the antenna port is selected from a set of antenna ports. The set of antenna ports can comprise antenna ports {7, 8, 13}.

Referring to FIG. 15B, there is shown a view 1500B of a protocol for communicating a DM-RS antenna port or resource configuration associated with testing antenna port performance. The antenna port performance could comprise testing for a level of interference or any other test. The prescribed DM-RS antenna port configuration can comprise information relating to a target resource configuration for carrying, that is, transmitting or receiving, a DM-RS signal. The DM-RS antenna port configuration can comprise, at least one or more than one antenna port and one or more than one respective OCC. The one or more than one respective OCC is used to spread a respective DM-RS signal over respective resource elements.

Embodiments can be realized in which the configuration is a higher layer configuration prescribed by, or associated with, a higher layer such as, for example, L3 or above. Embodiments can be realized in which the protocol signalling is realized, at least in part, using the Radio Resource Control (RRC) messages or signalling.

A determination can be made by a radio resource controller 1502B regarding a prescribed DM-RS antenna port configuration 1504B.

A message 1506B for communicating the prescribed DM-RS antenna port configuration is output for transmission to a predetermined layer 1508B of a device such as, for example, a UE. The message can be, for example, the above message described with reference to and/or as shown in FIG. 11. The UE processes, at 1507B, the DM-RS antenna port configuration and, can optionally, pass the data to a relevant higher layer such as, for example, L3 or above. The UE can then be configured to receive and process the one or more than one DM-RS signal spread over one or more respective antenna ports using respective length orthogonal cover codes to produce channel estimates using the above described channel estimator 130. One skilled in the art will appreciate that communicating the lengths of the OCCs can comprise providing a receiving UE with an indication of how to process an associated DM-RS to recover one or more than one DM-RS previously spread over a set of resource elements. Having been appropriately configured to receive prescribed DM-RS antenna port configurations, the UE can receive and commence channel estimation at 1510B using the DM-RS signals 1512B.

Having obtained channel estimates for the prescribed antenna ports from the DM-RS signals transmitted using different length OCCs, the UE can process and decode, at 1514B, subsequently received signals, 1516B, using the channel estimates in the decoder such as, for example, decoders 852 and 1052.

Embodiments can be realised in which the RRC 1502 prescribes a target port for testing using a DM-RS spread with a corresponding OCC. In the illustrated embodiment, the target port is antenna port 11 and the spreading OCC has a code length of 4. In the embodiment illustrated, a scrambling identifier, nSCID, can be provided. Embodiments can be realised in which the nSCID has a value of zero. Suitably, an embodiment can be realised in which a target antenna port for testing has DM-RS configuration data of antenna port 11, OCC-4 and nSCID=0.

Embodiments can be realised in which an interfering signal, such as, for example, a DM-RS transmission via a respective antenna port, spread using a respective OCC, is also transmitted. The predetermined signal can be the DM-RS signal transmitted on another antenna port such as antenna port 7, 8 or 13. The predetermined signal can be spread with an OCC having a respective code length. Therefore, an embodiment can be realised in which an interfering antenna port or further test antenna port is antenna port 7 carrying the DM-RS signal spread using an OCC having a code length of 4. Although the embodiment described uses antenna port 7 as the interfering or further test antenna port, embodiments are not limited to that antenna port. Embodiments can be realised in which the antenna port is selected from a set of antenna ports. The set of antenna ports can comprise antenna ports {7, 8, 13}.

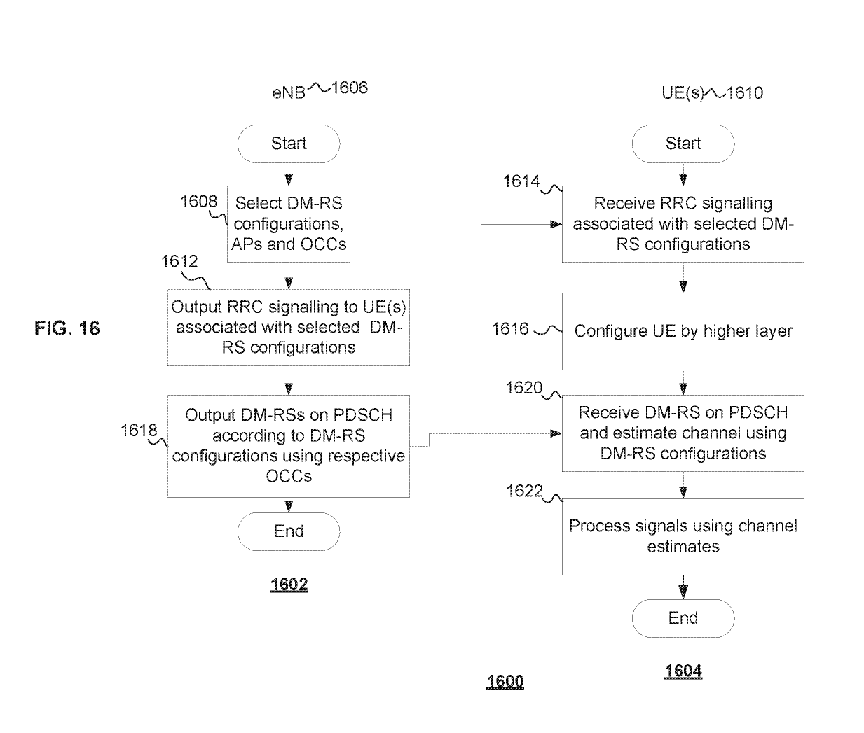

Referring to FIG. 16, there is shown a view 1600 of flowcharts 1602 and 1604 of embodiments for testing transmissions of DM-RS signals spread using respective OCCs as received by, or as output for receipt by, at least one device such as, for example, a UE configured to operate using DM-RS antenna port configurations with respective length orthogonal cover codes.

An apparatus, such as, for example, an eNB 1606, which can be the above eNB 102, or an apparatus for such an eNB, configures or selects, at 1608, a DM-RS resource configuration, using respective OCCs, for transmission to a UE 1610, which can be the above UE 104, using higher layer signaling such as, for example, RRC signalling.

The eNB 1606 transmits, at 1612, a message such as, for example, a RRC message or messages, indicating one or more than one prescribed DM-RS antenna port configuration to the UE 1610.

At 1614, the UE 1610 receives the message associated with the DM-RS antenna port resource configuration and is configured, at 1616, by a higher layer to operate or otherwise process the DM-RS signals according to the antenna DM-RS mapping. The higher layer can be, for example, Layer 3 or above, such as, for example, the RRC layer,

At 1618, the apparatus such as, for example, the above eNB, transmits to the UE 1610 one or more than one DM-RS signal, spread using one or more than one respective orthogonal cover codes, over one or more than one respective antenna port according to the above DM-RS resource configuration previously sent to the UE 1610. The channel can be, for example, the PDSCH. Although the embodiment has been described with reference to the PDSCH, embodiments can be realized that use a different physical channel such as, for example, any of the channels described in this specification.

At 1620, the UE 1610 receives and decodes the prescribed one or more than one DM-RS signal in accordance with the DM-RS resource configuration. The UE 1610 uses the one or more than one DM-RS signal to estimate one or more characteristics of one or more than one wireless communication channel or a parameter associated with such respective channels or antenna ports.

At 1622, the UE processes subsequently received signals sent via the channels or antenna ports corresponding to the channel estimates. Embodiments can be realised in which the channel estimates use one or more of the above channel estimates described with reference to FIG. 6. The UE uses the channel estimates to decode subsequently received signals using a decoder.

After channel estimation, an interference covariance matrix can be calculated from

Rᵢ=E[(y−h₁s₁)(y−h₁s₁)^{H}]

where (y−h₁s₁)^{H} is the Hermitian of (y−h₁s₁), y is the received signal, h₁ is the estimated channel and s₁ is the interference. Once the covariance matrix has been established, an MMSE-IRC receiver can decode the received data.

However, if a target UE uses OCC-2 on port 8 and an interfering UE uses OCC-4 on port 13, the performance of the OCC-2 on port 8 can still be relatively good. A test case or performance criterion can be established to assess the performance of OCC-4 in a particular environment. Such an environment can comprise a multi-user MIMO environment. Any such test or performance criterion could be directed to discriminating between UE behavior using OCC-2 and OCC-4. It will be appreciated from the above, therefore, that if a base station, or eNB, selected port 7 as the target port and selected an interference port from the set {8, 11, 13}, the performance of communications using OCC-4 could not be reliably tested since transmitting over port 7 using OCC-2, as indicated above, achieves good performance results. Suitably, embodiments provide for the target port being fixed as port 11 using OCC-4. Additionally, or alternatively, embodiments provide for the target port being fixed as port 11 with a prescribed scrambling identity and using OCC-4. The prescribed scrambling identity could be, for example, nSCID=0 or nSCID=1.

Additionally, or alternatively, the target port can be dynamically selected to use or otherwise operate using a predetermined combination of characteristics comprising at least one of a selected port, a corresponding scrambling identity and a corresponding orthogonal cover code. Embodiments can be realised in which the selected port can be one or more than one port selected from ports {7, 8, 11, 13}, and/or the scrambling identity can be selected from nSCID=0 and nSCID=1 and/or the orthogonal cover code can be selected from OCC-4 and OCC-2, the elements of the enumerated list being taken jointly and severally in any and all permutations. Embodiments can be realized in which the port can be dynamically selected from ports {7, 8, 11, 13} with a prescribed or corresponding OCC length. Suitably, example implementations can provide for an antenna port being dynamically selected from a predetermined set of ports such as, for example, antenna ports {7, 8, 11, 13} with a scrambling identity of nSCID=O and OCC-4.

It will be appreciated that the above embodiments can be used to test DM-RS multiplexed transmissions, single or multi-layer, with an interfering simultaneous transmission.

Any or all of the embodiments above can use a first OCC length for a target signal, such as, for example, a signal to test, and use a different OCC length for the interference signal. For example, modulation symbols such as modulation symbols of a signal or antenna port under test can be transmitted using OCC-2 and modulation symbols such as modulation symbols of an interfering signal or interfering antenna port can be transmitted with using an OCC-2 or OCC-4, or some other length OCC. Furthermore, processing such modulation symbols such as, for example, the modulation symbols under test, or the antenna port under test, using OCC-2 despreading, simplifies the receiver.

In any and all of the above embodiments, the simplified receiver design can be used in any or all embodiments.

The above flowcharts can be realized in the form of, for example, machine executable instructions executable by processor circuitry. The machine executable instructions can be stored on machine readable storage. The machine readable storage can be transitory or non-transitory storage.

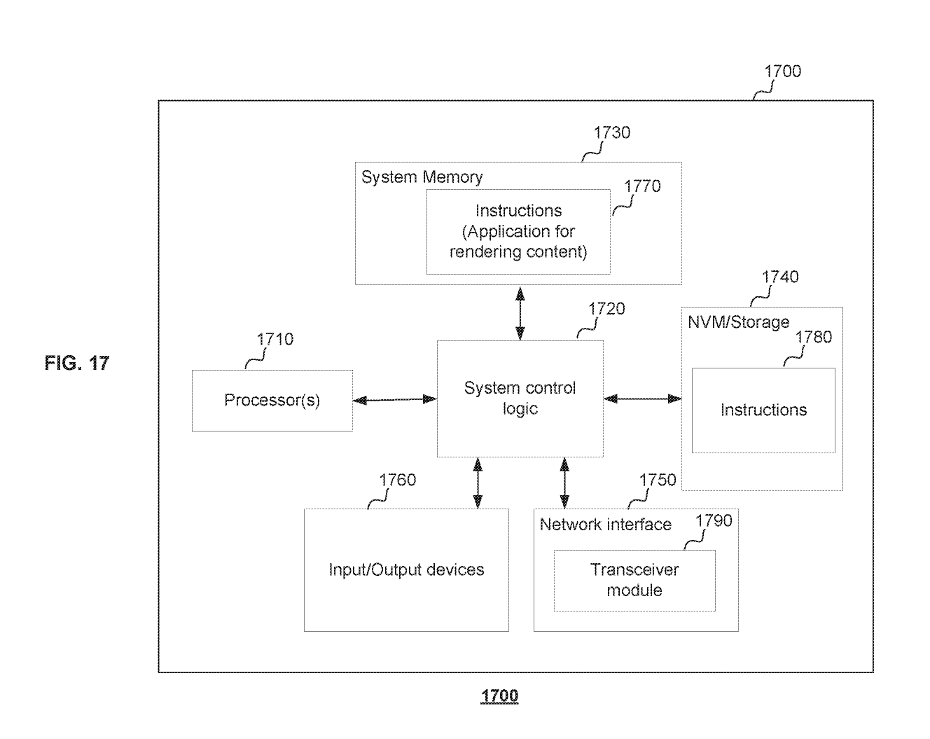

FIG. 17 illustrates, for one embodiment, an example system 1700 for realizing a UE 104 or component thereof. The system 1700 comprises one or more processor(s) 1710, system control logic 1720 coupled with at least one of the processor(s) 1710, system memory 1730 coupled with system control logic 1720, non-volatile memory (NVM)/storage 1740 coupled with system control logic 1720, and a network interface 1750 coupled with system control logic 1720. The system 1700 control logic 1720 may also be coupled to Input/Output devices 1760. The system can be arranged to receive and process one or more than one instance of the above NZP CSI-RS signals.

Processor(s) 1710 may include one or more single-core or multi-core processors. Processor(s) 1710 may include any combination of general-purpose processors and/or dedicated processors (e.g., graphics processors, application processors, baseband processors, etc.). Processors 1710 may be operable to carry out the above described methods or realise the above embodiments and examples using suitable instructions or programs (i.e. to operate via use of processor, or other logic, instructions). The instructions may be stored in system memory 1730, as system memory instructions 1770, or, additionally or alternatively, may be stored in (NVM)/storage 1740, as NVM instructions 1780.

System control logic 1720, for one embodiment, may include any suitable interface controllers to provide for any suitable interface to at least one of the processor(s) 1710 and/or to any suitable device or component in communication with system control logic 1720.

System control logic 1720, for one embodiment, may include one or more memory controller(s) to provide an interface to system memory 1730. System memory 1730 may be used to load and store data and/or instructions for the system 1700. A system memory 1730, for one embodiment, may include any suitable volatile memory, such as suitable dynamic random access memory (DRAM), for example.

NVM/storage 1740 may include one or more than one tangible, non-transitory computer-readable medium used to store data and/or instructions, for example. NVM/storage 1740 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example.

The NVM/storage 1740 may include a storage resource that is physically part of a device on which the system 1700 is installed or it may be accessible by, but not necessarily a part of, the system 1700. For example, the NVM/storage 1740 may be accessed over a network via the network interface 1750.

System memory 1730 and NVM/storage 1740 may respectively include, in particular, temporal and persistent, that is, non-transient, copies of, for example, the instructions 1770 and 1780, respectively. Instructions 1770 and 1780 may include instructions that when executed by at least one of the processor(s) 1710 result in the system 1700 implementing the processing of the method(s) of any embodiment described herein or as shown in any of the figures. In some embodiments, instructions 1770 and 1780, or hardware, firmware, and/or software components thereof, may additionally/alternatively be located in the system control logic 1720, the network interface 1750, and/or the processor(s) 1710.

Network interface 1750 may have a transceiver module 1790 to provide a radio interface for system 1700 to communicate over one or more network(s) (e.g. wireless communication network) and/or with any other suitable device. The transceiver 1790 may implement receiver module that performs the above processing of the received signals to realize interference mitigation. In various embodiments, the transceiver 1790 may be integrated with other components of the system 1700. For example, the transceiver 1790 may include a processor of the processor(s) 1710, memory of the system memory 1730, and NVM/Storage of NVM/Storage 1740. Network interface 1750 may include any suitable hardware and/or firmware. Network interface 1750 may be operatively coupled to the antenna, or to one or more than one antenna to provide SISO or a multiple input, multiple output radio interface. Network interface 1750 for one embodiment may include, for example, a network adapter, a wireless network adapter, a telephone modem, and/or a wireless modem.

In the embodiments herein, at least one of the processor(s) 1710 may be packaged together with logic for one or more controller(s) of the system control logic 1720. For one embodiment, at least one of the processor(s) 1710 may be packaged together with logic for one or more controllers of the system control logic 1720 to form a System in Package (SiP). For one embodiment, at least one of the processor(s) 1740 may be integrated on the same die with logic for one or more controller(s) of the system control logic 1720. For one embodiment, at least one of the processor(s) 1710 may be integrated on the same die with logic for one or more controller(s) of system control logic 1720 to form a System on Chip (SoC).

In various embodiments, the I/O devices 1760 may include user interfaces designed to enable user interaction with the system 1700, peripheral component interfaces designed to enable peripheral component interaction with the system 1700, and/or sensors designed to determine environmental conditions and/or location information related to the system 1700.

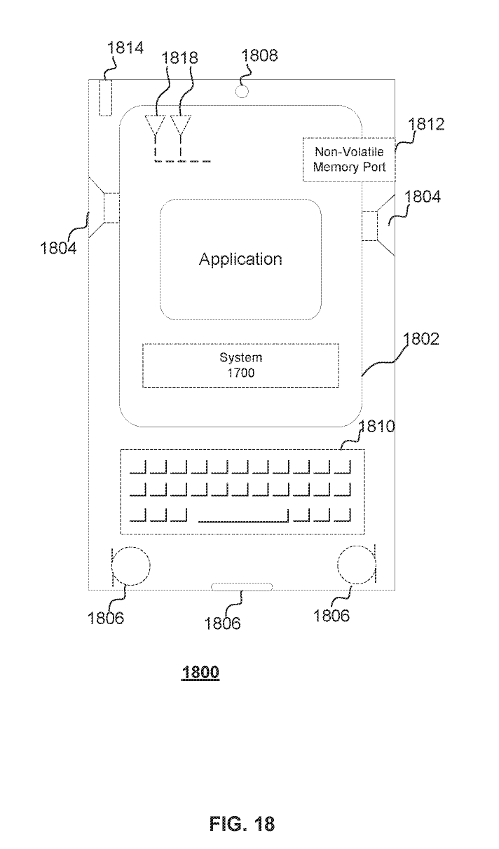

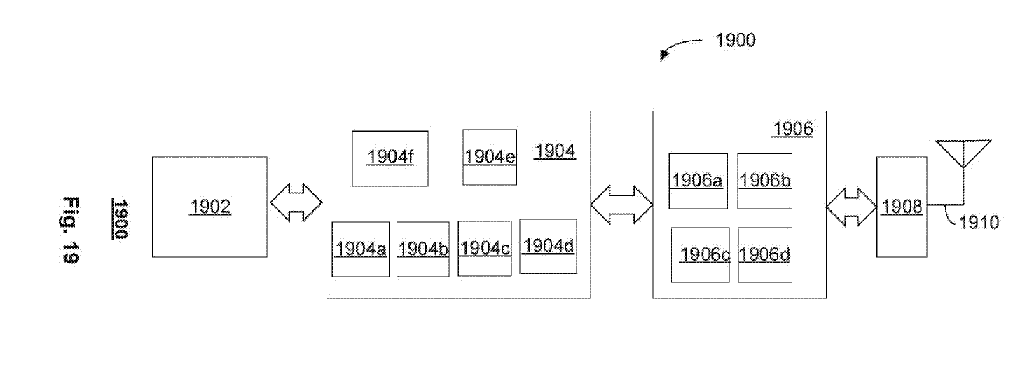

FIG. 18 shows an embodiment in which the system 1700 can be used to realize a UE such as UE 104, 200. Such a user equipment 104, 200 can be realized in form of a mobile device 1800.

In various embodiments, user interfaces of the mobile device 1800 could include, but are not limited to, a display 1802 (e.g., a liquid crystal display, a touch screen display, etc.), a speaker 1804, a microphone 1806, one or more cameras 1808 (e.g., a still camera and/or a video camera), a flashlight (e.g., a light emitting diode), or a keyboard 1810 taken jointly and severally in any and all permutations.

In various embodiments, one or more than one peripheral component interface may be provided including, but not limited to, a non-volatile memory port 1812, an audio jack 1814, or a power supply interface 1816 taken jointly and severally in any and all permutations.

In various embodiments, one or more sensors may be provided including, but not limited to, a gyro sensor, an accelerometer, a proximity sensor, an ambient light sensor, and a positioning unit. The positioning unit may also be part of, or interact with, the network interface to communicate with components of a positioning network, e.g., a global positioning system (GPS) satellite.

In various embodiments, the system 1800 may be a mobile computing device such as, but not limited to, a laptop computing device, a tablet computing device, a netbook, a mobile phone, etc. In various embodiments, the system 1800 may have more or fewer components, and/or different architectures.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

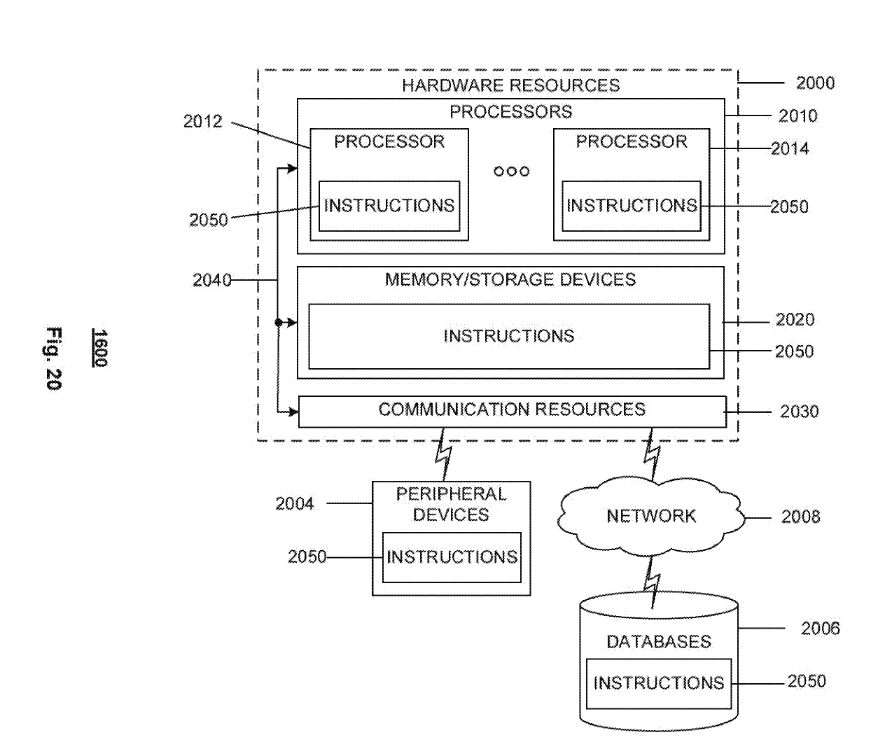

Embodiments described herein may be implemented into a system using any suitably configured hardware and/or software. FIG. 19 illustrates, for one embodiment, example components of at least one of a User Equipment (UE) device 1900 or a base station such as, for example, an eNB, or any other type of base station. In some embodiments, the UE device 1900 may include application circuitry 1902, baseband circuitry 1904, Radio Frequency (RF) circuitry 1906, front-end module (FEM) circuitry 1908 and one or more antennas 1910, coupled together at least as shown. It will be appreciated that embodiments can be realized in which at least one of the application circuitry 1902 or baseband circuitry 1904 can implement or be used to implement one or more elements of FIG. 1.

The application circuitry 1902 may include one or more application processors. For example, the application circuitry 1902 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 1904 may include circuitry such as, but not limited to, one or more single-core or multi-core processors. The baseband circuitry 1904 may include one or more baseband processors and/or control logic to process baseband signals received from a receive signal path of the RF circuitry 1906 and to generate baseband signals for a transmit signal path of the RF circuitry 1906. Baseband processing circuitry 1904 may interface with the application circuitry 1902 for generation and processing of the baseband signals and for controlling operations of the RF circuitry 1906. For example, in some embodiments, the baseband circuitry 1904 may include a second generation (2G) baseband processor 1904a, third generation (3G) baseband processor 1904b, fourth generation (4G) baseband processor 1904c, and/or other baseband processor(s) 1904d for other existing generations, generations in development or to be developed in the future (e.g., fifth generation (5G), 6G, etc.). The baseband circuitry 1904 (e.g., one or more of baseband processors 1904a-d) may handle various radio control functions that enable communication with one or more radio networks via the RF circuitry 1906. The radio control functions may include, but are not limited to, signal modulation/demodulation, encoding/decoding, radio frequency shifting, etc. In some embodiments, modulation/demodulation circuitry of the baseband circuitry 1904 may include Fast-Fourier Transform (FFT), precoding, and/or constellation mapping/demapping functionality. In some embodiments, encoding/decoding circuitry of the baseband circuitry 1904 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1904 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 1904e of the baseband circuitry 1904 may be configured to run elements of the protocol stack for signaling of the PHY, MAC, RLC, PDCP and/or RRC layers. In some embodiments, the baseband circuitry may include one or more audio digital signal processor(s) (DSP) 1904f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1904 and the application circuitry 1902 may be implemented together such as, for example, on a system on a chip (SOC).

In some embodiments, the baseband circuitry 1904 may provide for communication compatible with one or more radio technologies. For example, in some embodiments, the baseband circuitry 1904 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 1904 is configured to support radio communications of more than one wireless protocol may be referred to as multi-mode baseband circuitry.

RF circuitry 1906 may enable communication with wireless networks using modulated electromagnetic radiation through a non-solid medium. In various embodiments, the RF circuitry 1906 may include switches, filters, amplifiers, etc. to facilitate the communication with the wireless network. RF circuitry 1906 may include a receive signal path which may include circuitry to down-convert RF signals received from the FEM circuitry 1908 and provide baseband signals to the baseband circuitry 1904. RF circuitry 1906 may also include a transmit signal path which may include circuitry to up-convert baseband signals provided by the baseband circuitry 1904 and provide RF output signals to the FEM circuitry 1908 for transmission. In some embodiments, the RF circuitry 1906 may include a receive signal path and a transmit signal path. The receive signal path of the RF circuitry 1906 may include mixer circuitry 1906a, amplifier circuitry 1906b and filter circuitry 1906c. The transmit signal path of the RF circuitry 1906 may include filter circuitry 1906c and mixer circuitry 1906a. RF circuitry 1906 may also include synthesizer circuitry 1906d for synthesizing a frequency for use by the mixer circuitry 1906a of the receive signal path and the transmit signal path. In some embodiments, the mixer circuitry 1906a of the receive signal path may be configured to down-convert RF signals received from the FEM circuitry 1908 based on the synthesized frequency provided by synthesizer circuitry 1906d. The amplifier circuitry 1906b may be configured to amplify the down-converted signals and the filter circuitry 1906c may be a low-pass filter (LPF) or band-pass filter (BPF) configured to remove unwanted signals from the down-converted signals to generate output baseband signals. Output baseband signals may be provided to the baseband circuitry 1904 for further processing. In some embodiments, the output baseband signals may be zero-frequency baseband signals. In some embodiments, mixer circuitry 1906a of the receive signal path may comprise passive mixers, although the scope of the embodiments is not limited in this respect.

In some embodiments, the mixer circuitry 1906a of the transmit signal path may be configured to up-convert input baseband signals based on the synthesized frequency provided by the synthesizer circuitry 1906d to generate RF output signals for the FEM circuitry 1908. The baseband signals may be provided by the baseband circuitry 1904 and may be filtered by filter circuitry 1906c. The filter circuitry 1906c may include a low-pass filter (LPF), although the scope of the embodiments is not limited in this respect.

In some embodiments, the mixer circuitry 1906a of the receive signal path and the mixer circuitry 1906a of the transmit signal path may include two or more mixers and may be arranged for quadrature down-conversion and/or up-conversion respectively. In some embodiments, the mixer circuitry 1906a of the receive signal path and the mixer circuitry 1906a of the transmit signal path may include two or more mixers and may be arranged for image rejection (e.g., Hartley image rejection). In some embodiments, the mixer circuitry 1906a of the receive signal path and the mixer circuitry 1906a may be arranged for direct down-conversion and/or direct up-conversion, respectively. In some embodiments, the mixer circuitry 1906a of the receive signal path and the mixer circuitry 1906a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1906 may include analog-to-digital converter (ADC) and digital-to-analog converter (DAC) circuitry and the baseband circuitry 1904 may include a digital baseband interface to communicate with the RF circuitry 1906.

In some dual-mode embodiments, a separate radio IC circuitry may be provided for processing signals for each spectrum, although the scope of the embodiments is not limited in this respect.

In some embodiments, the synthesizer circuitry 1906d may be a fractional-N synthesizer or a fractional N/N+1 synthesizer, although the scope of the embodiments is not limited in this respect as other types of frequency synthesizers may be suitable. For example, synthesizer circuitry 1906d may be a delta-sigma synthesizer, a frequency multiplier, or a synthesizer comprising a phase-locked loop with a frequency divider.

The synthesizer circuitry 1906d may be configured to synthesize an output frequency for use by the mixer circuitry 1906a of the RF circuitry 1906 based on a frequency input and a divider control input. In some embodiments, the synthesizer circuitry 1906d may be a fractional N/N+1 synthesizer.

In some embodiments, frequency input may be provided by a voltage controlled oscillator (VCO). Divider control input may be provided by either the baseband circuitry 1904 or the applications processor 1902 depending on the desired output frequency. In some embodiments, a divider control input (e.g., N) may be determined from a look-up table based on a channel indicated by the applications processor 1902.

Synthesizer circuitry 1906d of the RF circuitry 1906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1906d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1906 may include an IQ/polar converter.

FEM circuitry 1908 may include a receive signal path which may include circuitry configured to operate on RF signals received from one or more antennas 1910, amplify the received signals and provide the amplified versions of the received signals to the RF circuitry 1906 for further processing. FEM circuitry 1908 may also include a transmit signal path which may include circuitry configured to amplify signals for transmission provided by the RF circuitry 1906 for transmission by one or more of the one or more antennas 1910.

In some embodiments, the FEM circuitry 1908 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1906). The transmit signal path of the FEM circuitry 1908 may include a power amplifier (PA) to amplify input RF signals (e.g., provided by RF circuitry 1906), and one or more filters to generate RF signals for subsequent transmission (e.g., by one or more of the one or more antennas 1910.

In some embodiments, the UE device 1900 may include additional elements such as, for example, memory/storage, display, camera, sensor, and/or input/output (I/O) interface.

In various embodiments, the UE and/or the eNB may include a plurality of antennas to implement a multiple-input-multiple-output (MIMO) transmission system, which may operate in a variety of MIMO modes, including single-user MIMO (SU-MIMO), multi-user MIMO (MU-MIMO), closed loop MIMO, open loop MIMO or variations of smart antenna processing. The UE may provide some type of channel state information (CSI) feedback to the eNB via one or more up link channels, and the eNB may adjust one or more down link channels based on the received CSI feedback. The feedback accuracy of the CSI may affect the performance of the MIMO system.

In various embodiments, the uplink channels and the downlink channels may be associated with one or more frequency bands, which may or may not be shared by the uplink channels and the downlink channels. The one or more frequency bands may be further divided into one or more subbands, which may or may not be shared by the uplink and downlink channels. Each frequency subband, one or more aggregated subbands, or the one or more frequency bands for the uplink or downlink channels (wideband) may be referred to as a frequency resource.

In various embodiments, the UE may transmit CSI feedback to the eNB. The CSI feedback may include information related to channel quality index (CQI), precoding matrix indicator (PMI), and rank indication (RI). PMI may reference, or otherwise uniquely identify, a precoder within the codebook. The eNB may adjust the downlink channel based on the precoder referenced by the PMI.

The components and features of the above eNBs and UEs may be implemented using any combination of discrete circuitry, application specific integrated circuits (ASICs), logic gates and/or single chip architectures. Further, the features of UE may be implemented using microcontrollers, programmable logic arrays and/or microprocessors or any combination of the foregoing where suitably appropriate. It is noted that hardware, firmware and/or software elements may be collectively or individually referred to as “logic” or “circuit”.

The various embodiments may be used in a variety of applications including transmitters and receivers of a radio system, although the embodiments are not limited in this respect. Radio systems specifically included within the scope of the present application include, but are not limited to, network interface cards (NICs), network adaptors, fixed or mobile client devices, relays, eNodeB or transmit points, femtocells, gateways, bridges, hubs, routers, access points, or other network devices. Further, the radio systems within the scope of the embodiments may be implemented in cellular radiotelephone systems, satellite systems, two-way radio systems as well as computing devices including such radio systems including personal computers (PCs), tablets and related peripherals, personal digital assistants (PDAs), personal computing accessories, hand-held communication devices and all systems which may be related in nature and to which the principles of the inventive embodiments could be suitably applied.

FIG. 20 is a block diagram illustrating components, according to some example embodiments, able to read instructions from a machine-readable or computer-readable medium (e.g., a machine-readable storage medium) and perform any one or more of the methodologies discussed herein. Specifically, FIG. 20 shows a diagrammatic representation of hardware resources 2000 including one or more processors (or processor cores) 2010, one or more memory/storage devices 2020, and one or more communication resources 2030, each of which are communicatively coupled via a bus 2040.

The processors 2010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 2012 and a processor 2014. The memory/storage devices 2020 may include main memory, disk storage, or any suitable combination thereof.

The communication resources 2030 may include interconnection and/or network interface components or other suitable devices to communicate with one or more peripheral devices 2004 and/or one or more databases 2006 via a network 2008. For example, the communication resources 2030 may include wired communication components (e.g., for coupling via a Universal Serial Bus (USB)), cellular communication components, Near Field Communication (NFC) components, Bluetooth® components (e.g., Bluetooth® Low Energy), Wi-Fi® components, and other communication components.

Instructions 2050 may comprise software, a program, an application, an applet, an app, or other executable code for causing at least any of the processors 2010 to perform any one or more of the methodologies discussed herein. The instructions 2050 may reside, completely or partially, within at least one of the processors 2010 (e.g., within the processor's cache memory), the memory/storage devices 2020, or any suitable combination thereof. Furthermore, any portion of the instructions 2050 may be transferred to the hardware resources 2000 from any combination of the peripheral devices 2004 and/or the databases 2006. Accordingly, the memory of processors 2010, the memory/storage devices 2020, the peripheral devices 2004, and the databases 2006 are examples of computer-readable and machine-readable media.

It will be appreciated that embodiments can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or machine readable storage such as, for example, DVD, memory stick, chip, electronic device or solid state medium. It will be appreciated that the storage devices and storage media are embodiments of machine-readable storage, for example, non-transitory machine-readable storage, that are suitable for storing a program or programs comprising instructions that, when executed, implement embodiments described and claimed herein. Accordingly, embodiments provide machine executable code for implementing a system, apparatus, eNB, UE, device or method as described herein or as claimed herein and machine readable storage storing such a program or programs. Still further, such programs may be conveyed electronically via any medium such as a communication signal carried over a wired or wireless connection and embodiments suitably encompass the same.

In any or all of the above embodiments, it can be appreciated that a given serving cell can be configured with a predetermined number of parameter sets by higher layer signalling to support a UE decoding the PDSCH or EPDDCH in accordance with a predetermined message or information element such as at least one of a predetermined format DCI intended for the UE or a PDSCH configuration information element. The PDSCH configuration information element can specify at least one of a common PDSCH configuration or a UE-specific PDSCH configuration.

Due to a base station scheduling a UE antenna port in MU-MIMO with mixed OCC-2 and OCC-4, cell capacity can be increased. Examples implementations support base station scheduling of a UE port or multiple UE ports with mixed OCC-2 and OCC-4 without affecting the performance of an OCC-2 user. Embodiments herein may include a base station user port scheduler to address the question.

For the UE implementation, the UE can have two processing schemes for OCC-2 and OCC-4 respectively to estimate the channel. If the UE is scheduled by OCC-4, e.g. port 11,13, the UE can change UE receiver processing procedure from OCC-2 to OCC-4, which will greatly increase the implementation complexity. However, example implementations can be realized in which the UE can keep the OCC-2 processing implementation unchanged while achieving good throughput performance. Consequently, receiver complexity can be significantly reduced. Embodiments may include a unified UE channel estimation technique that can handle both OCC-2 and OCC-4 case.

Embodiments herein may include one or more of the following aspects:

A base station UE port scheduler for MU-MIMO with mixed OCC-2 and OCC-4

A unified channel estimation scheme for both OCC-2 and OCC-4

Embodiments are also provided according to the following examples:

An base station, eNB, UE, device, apparatus or system as described or claimed herein, and/or as expressed in any and all examples, further comprising at least one of:

a display, such as, for example, a touch sensitive display, an input device, such as, for example, one or more than one of a button, a key pad, an audio input, a video input, and/or
an output device such as, for example, an audio output, a video output, a haptic device taken jointly and severally in any and all permutations.

A base station comprises one or more than one of a Node B, an eNB, a gNB, a geNB, or an access point. Any or all embodiments, taken jointly and severally, can be realised in the form of such a base station, unless the context demands otherwise.

As used in this specification, the formulation “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order, which encompasses all permutations of all elements of the list or set {A, B, C}. In this example, the set comprises three elements, but could equally well comprise some other number of elements.

Although any embodiments make reference to an interference signal or an interfering signals, embodiments can be realised in which such a signal is merely an intentional co-scheduled signal.

Such an intentional co-scheduled signal can increase the overall capacity of a base station.

Embodiments can be realised what use a fixed antenna port. A fixed antenna port comprises an antenna port that is selected for an intended purpose.

It will be understood that the terms “receiving” and “transmitting” encompass “inputting” and “outputting” and are not limited to an RF context of transmitting and receiving radio waves. Therefore, for example, a chip, device or other component for realizing embodiments could generate data for output to another chip, device or component, or have as an input data from another chip, device or component, and such an output or input could be referred to as “transmit” and “receive” including gerund forms, that is, “transmitting” and “receiving”, and infinitive forms, as well as or instead of such “transmitting” and “receiving” within an RF or wireless context.

In Example 1, there is provided a method of processing a demodulation reference signal; the method comprising processing a demodulation reference signal spread using a respective orthogonal cover code of a respective length associated with antenna port 7 of a physical downlink shared channel, processing a co-scheduled demodulation reference signal spread using an associated orthogonal cover code of a prescribed length associated with antenna port 11 of the physical downlink shared channel; and despreading at least one of the demodulation reference signal spread using said respective orthogonal cover code of said respective length to recover the demodulation reference signal, or the co-scheduled demodulation reference signal spread using said associated orthogonal cover code of said prescribed length to recover the demodulation reference signal.

In Example 2, the subject matter of example 1, or any of the examples described herein further comprising estimating channel characteristics of a channel associated with antenna port 7 using the despread demodulation reference signal.

In Example 3, the subject matter of example 2, or any of the examples described herein further comprising decoding data using said channel characteristics.

In Example 4, the subject matter of any of examples 1 to 3, or any of the examples described herein further comprising estimating channel characteristics of a channel associated with antenna port 11 using the despread co-scheduled demodulation reference signal.

In Example 5, the subject matter of example 4, or any of the examples described herein further comprising decoding data using said channel characteristics associated with antenna port 11 using the despread co-scheduled demodulation reference signal.

In Example 6, the subject matter of any of examples 1 to 5, or any of the examples described herein in which the respective orthogonal cover code of a respective length associated with antenna port 7 has a length of two or four.

In Example 7, the subject matter of any of examples 1 to 6, or any of the examples described herein in which the associated orthogonal cover code of a prescribed length associated with antenna port 11 has a length of two or four.

In Example 8, there is provided a method of processing a demodulation reference signal; the method comprising processing a demodulation reference signal spread using a respective orthogonal cover code of a respective length associated with antenna port 8 of a physical downlink shared channel, processing a co-scheduled demodulation reference signal spread using an associated orthogonal cover code of a prescribed length associated with antenna port 13 of a physical downlink shared channel; and despreading at least one of the demodulation reference signal spread using said respective orthogonal cover code of length to recover the demodulation reference signal, or the co-scheduled demodulation reference signal spread using said associated orthogonal cover code of said prescribed length to recover the demodulation reference signal.

In Example 9, the subject matter of example 8, or any of the examples described herein further comprising estimating channel characteristics of a channel associated with antenna port 8 using the despread demodulation reference signal.

In Example 10, the subject matter of example 9, or any of the examples described herein further comprising decoding data using said channel characteristics.

In Example 11, the subject matter of any of examples 8 to 10, or any of the examples described herein further comprising estimating channel characteristics of a channel associated with antenna port 13 using the despread co-scheduled demodulation reference signal.

In Example 12, the subject matter of example 11, or any of the examples described herein further comprising decoding data using said channel characteristics associated with antenna port 13 using the despread co-scheduled demodulation reference signal.

In Example 13, the subject matter of any of examples 8 to 12, or any of the examples described herein in which the respective orthogonal cover code of a respective length associated with antenna port 8 has a length of two or four.

In Example 14, the subject matter of any of examples 8 to 13, or any of the examples described herein in which the associated orthogonal cover code of a prescribed length associated with antenna port 13 has a length of two or four.

In Example 15, there is provided a method of processing a demodulation reference signal; the method comprising generating a demodulation reference signal, spreading an instance of the demodulation reference signal using a prescribed orthogonal cover code of a prescribed length for transmission via antenna port 7, spreading an instance of the demodulation reference signal using a further orthogonal cover code of a further prescribed length for transmission via antenna port 11, and co-scheduling transmission of the spread instances of the demodulation reference signals.

In Example 16, the subject matter of example 15, or any of the examples described herein in which the prescribed orthogonal cover code has a prescribed length of two or four.

In Example 17, the subject matter of either of examples 15 and 16, or any of the examples described herein in which the further prescribed orthogonal cover code has a further prescribed length of two or four.

In Example 18, the subject matter of any of examples 15 to 17, or any of the examples described herein in which generating the demodulation reference signal is responsive to an associated scrambling identity (nSCID).

In Example 19, the subject matter of any of examples 15 to 18, or any of the examples described herein in which said co-scheduling comprises associating the spread instances of the demodulation reference signals with corresponding resources.

In Example 20, the subject matter of example 19 in which the corresponding resources comprise at least one of: corresponding resource elements, one or more than one time slot, one or more than one symbol, or a physical resource block.

In Example 21, there is provided a method of processing a demodulation reference signal; the method comprising generating a demodulation reference signal, spreading an instance of the demodulation reference signal using a prescribed orthogonal cover code of a prescribed length for transmission via antenna port 8, spreading an instance of the demodulation reference signal using a further orthogonal cover code of a further prescribed length for transmission via antenna port 13, and co-scheduling transmission of the spread instances of the demodulation reference signals.

In Example 22, the subject matter of example 21, or any of the examples described herein in which the prescribed orthogonal cover code has a prescribed length of two or four.

In Example 23, the subject matter of either of examples 21 and 22, or any of the examples described herein in which the further prescribed orthogonal cover code has a further prescribed length of two or four.

In Example 24, the subject matter of any of examples 25 to 23, or any of the examples described herein in which generating the demodulation reference signal is responsive to an associated scrambling identity (nSCID).

In example 25, the subject matter of any of examples 21 to 24, or any of the examples described herein in which said co-scheduling comprises associating the spread instances of the demodulation reference signals with corresponding resources.

In Example 26, the subject matter of example 25, or any of the examples described herein in which the corresponding resources comprise at least one of: corresponding resource elements, one or more than one time slot, one or more than one symbol, or a physical resource block.

In Example 27, there is provided an apparatus for a user equipment to process a demodulation reference signal; the apparatus comprising means to process a demodulation reference signal spread using a respective orthogonal cover code of a respective length associated with antenna port 7 of a physical downlink shared channel, means to process a co-scheduled demodulation reference signal spread using an associated orthogonal cover code of a prescribed length associated with antenna port 11 of the physical downlink shared channel; and means to despread at least one of the demodulation reference signal spread using said respective orthogonal cover code of said respective length to recover the demodulation reference signal, or the co-scheduled demodulation reference signal spread using said associated orthogonal cover code of said prescribed length to recover the demodulation reference signal.

In Example 28, the subject matter of example 27, or any of the examples described herein further comprising means to estimate channel characteristics of a channel associated with antenna port 7 using the despread demodulation reference signal.

In Example 29, the subject matter of example 28, or any of the examples described herein further comprising means to decode data using said channel characteristics.

In Example 30, the subject matter of any of examples 27 to 29, or any of the examples described herein further comprising means to estimate channel characteristics of a channel associated with antenna port 11 using the despread co-scheduled demodulation reference signal.

In Example 31, the subject matter of example 30, or any of the examples described herein further comprising means to decode data using said channel characteristics associated with antenna port 11 using the despread co-scheduled demodulation reference signal.

In Example 32, the subject matter of any of examples 27 to 31, or any of the examples described herein in which the respective orthogonal cover code of a respective length associated with antenna port 7 has a length of two or four.

In Example 33, the subject matter of any of examples 27 to 32, or any of the examples described herein in which the associated orthogonal cover code of a prescribed length associated with antenna port 11 has a length of two or four.

In Example 34, there is provided an apparatus for a user equipment to process a demodulation reference signal; the apparatus comprising means to process a demodulation reference signal spread using a respective orthogonal cover code of a respective length associated with antenna port 8 of a physical downlink shared channel, means to process a co-scheduled demodulation reference signal spread using an associated orthogonal cover code of a prescribed length associated with antenna port 13 of a physical downlink shared channel; and means to despread at least one of the demodulation reference signal spread using said respective orthogonal cover code of said respective length to recover the demodulation reference signal, or the co-scheduled demodulation reference signal spread using said associated orthogonal cover code of said prescribed length to recover the demodulation reference signal.

In Example 35, the subject matter of example 34, or any of the examples described herein further comprising means to estimate channel characteristics of a channel associated with antenna port 8 using the despread demodulation reference signal.

In Example 36, the subject matter of example 34, or any of the examples described herein further comprising means to decode data using said channel characteristics.

In Example 37, the subject matter of any of examples 34 to 36, or any of the examples described herein further comprising means to estimate channel characteristics of a channel associated with antenna port 13 using the despread co-scheduled demodulation reference signal.

In Example 38, the subject matter of example 37, or any of the examples described herein further comprising means to decode data using said channel characteristics associated with antenna port 13 using the despread co-scheduled demodulation reference signal.

In Example 39, the subject matter of any of examples 34 to 38, or any of the examples described herein in which the respective orthogonal cover code of said respective length associated with antenna port 8 has a length of two or four.

In Example 40, the subject matter of any of examples 34 to 39, or any of the examples described herein in which the associated orthogonal cover code of said prescribed length associated with antenna port 13 has a length of two or four.

In Example 41, there is provided an apparatus for a base station to process a demodulation reference signal; the method comprising means to generate a demodulation reference signal, means to spread an instance of the demodulation reference signal using a prescribed orthogonal cover code of a prescribed length for transmission via antenna port 7, means to spread an instance of the demodulation reference signal using a further orthogonal cover code of a further prescribed length for transmission via antenna port 11, and means to co-schedule transmission of the spread instances of the demodulation reference signals.

In Example 42, the subject matter of example 41, or any of the examples described herein in which the prescribed orthogonal cover code has a prescribed length of two or four.

In Example 43, the subject matter of either of examples 41 and 42, or any of the examples described herein in which the further prescribed orthogonal cover code has a further prescribed length of two or four.

In Example 44, the subject matter of any of examples 41 to 43, or any of the examples described herein in which the means to generate the demodulation reference signal is responsive to an associated scrambling identity (nSCID).

In Example 45, the subject matter of any of examples 41 to 44, or any of the examples described herein in which said means to co-schedule comprises means to associate the spread instances of the demodulation reference signals with corresponding resources.

In Example 46, the subject matter of example 45 in which the corresponding resources comprise at least one of: corresponding resource elements, one or more than one time slot, one or more than one symbol, or a physical resource block.

In Example 47, there is provided an apparatus for a base station to process a demodulation reference signal; the apparatus comprising means to generate a demodulation reference signal, means to spread an instance of the demodulation reference signal using a prescribed orthogonal cover code of a prescribed length for transmission via antenna port 8, means to spread an instance of the demodulation reference signal using a further orthogonal cover code of a further prescribed length for transmission via antenna port 13, and means to co-schedule transmission of the spread instances of the demodulation reference signals.

In Example 48, the subject matter of example 47, or any of the examples described herein in which the prescribed orthogonal cover code has a prescribed length of two or four.

In Example 49, the subject matter of either of examples 47 and 48, or any of the examples described herein in which the further prescribed orthogonal cover code has a further prescribed length of two or four.

In Example 50, the subject matter of any of examples 47 to 49, or any of the examples described herein in which the means to generate the demodulation reference signal is responsive to an associated scrambling identity (nSCID).

In Example 51, the subject matter of any of examples 47 to 50, or any of the examples described herein in which said means to co-schedule comprises means to associate the spread instances of the demodulation reference signals with corresponding resources.

In Example 52, the subject matter of example 51 in which the corresponding resources comprise at least one of: corresponding resource elements, one or more than one time slot, one or more than one symbol, or a physical resource block.

In Example 53, there is provided machine readable storage storing machine executable instructions arranged, when executed by one or more processors, to process a demodulation reference signal; the instructions comprising instructions to: process a demodulation reference signal spread using a respective orthogonal cover code of respective length associated with antenna port 7 of a physical downlink shared channel, process a co-scheduled demodulation reference signal spread using an associated orthogonal cover code of a prescribed length associated with antenna port 11 of the physical downlink shared channel; and despread at least one of the demodulation reference signal spread using said respective orthogonal cover code of said respective length to recover the demodulation reference signal, or the co-scheduled demodulation reference signal spread using said associated orthogonal cover code of said prescribed length to recover the demodulation reference signal.

In Example 54, the subject matter of example 53, or any of the examples described herein further comprising instructions to estimate channel characteristics of a channel associated with antenna port 7 using the despread demodulation reference signal.

In Example 55, the subject matter of example 54, or any of the examples described herein further comprising instructions to decode data using said channel characteristics.

In Example 56, the subject matter of any of examples 53 to 55, or any of the examples described herein further comprising instructions to estimate channel characteristics of a channel associated with antenna port 11 using the despread co-scheduled demodulation reference signal.

In Example 57, the subject matter of example 56, or any of the examples described herein further comprising instructions to decode data using said channel characteristics associated with antenna port 11 using the despread co-scheduled demodulation reference signal.

In Example 58, the subject matter of any of examples 53 to 57, or any of the examples described herein in which the respective orthogonal cover code of said respective length associated with antenna port 7 has a length of two or four.

In Example 59, the subject matter of any of examples 53 to 58, or any of the examples described herein in which the associated orthogonal cover code of said prescribed length associated with antenna port 11 has a length of two or four.

In Example 60, there is provided machine readable storage storing machine executable instructions arranged, when executed by one or more processors, to process a demodulation reference signal; the instructions comprising instructions to: process a demodulation reference signal spread using a respective orthogonal cover code of a respective length associated with antenna port 8 of a physical downlink shared channel, process a co-scheduled demodulation reference signal spread using an associated orthogonal cover code of a prescribed length associated with antenna port 13 of a physical downlink shared channel; and despread at least one of the demodulation reference signal spread using said respective orthogonal cover code of said respective length to recover the demodulation reference signal, or the co-scheduled demodulation reference signal spread using said associated orthogonal cover code of said prescribed length to recover the demodulation reference signal.

In Example 61, the subject matter of example 60, or any of the examples described herein further comprising estimating channel characteristics of a channel associated with antenna port 8 using the despread demodulation reference signal.

In Example 62, the subject matter of example 61, or any of the examples described herein further comprising decoding data using said channel characteristics.

In Example 63, the subject matter of any of examples 60 to 62, or any of the examples described herein further comprising estimating channel characteristics of a channel associated with antenna port 13 using the despread co-scheduled demodulation reference signal.

In Example 64, the subject matter of example 63, or any of the examples described herein further comprising decoding data using said channel characteristics associated with antenna port 13 using the despread co-scheduled demodulation reference signal.

In Example 65, the subject matter of any of examples 60 to 64, or any of the examples described herein in which the respective orthogonal cover code of said prescribed length associated with antenna port 8 has a length of two or four.

In Example 66, the subject matter of any of examples 60 to 65, or any of the examples described herein in which the associated orthogonal cover code of said prescribed length associated with antenna port 13 has a length of two or four.

In Example 67, there is provided machine readable storage storing machine executable instructions arranged, when executed by one or more processors, to process a demodulation reference signal; the instructions comprising instructions to: generate a demodulation reference signal, spread an instance of the demodulation reference signal using a prescribed orthogonal cover code of a prescribed length for transmission via antenna port 7, spread an instance of the demodulation reference signal using a further orthogonal cover code of a further prescribed length for transmission via antenna port 11, and co-schedule transmission of the spread instances of the demodulation reference signals.

In Example 68, the subject matter of example 67, or any of the examples described herein in which the prescribed orthogonal cover code has a prescribed length of two or four.

In Example 69, the subject matter of either of examples 67 and 68, or any of the examples described herein in which the further prescribed orthogonal cover code has a further prescribed length of two or four.

In Example 70, the subject matter of any of examples 67 to 69, or any of the examples described herein in which the instructions to generate the demodulation reference signal is responsive to an associated scrambling identity (nSCID).

In Example 71, the subject matter of any of examples 67 to 70, or any of the examples described herein in which said instructions to co-schedule comprises instructions to associate the spread instances of the demodulation reference signals with corresponding resources.

In Example 72, the subject matter of example 71, or any of the examples described herein in which the corresponding resources comprise at least one of: corresponding resource elements, one or more than one time slot, one or more than one symbol, or a physical resource block.

In Example 73, there is provided machine readable storage storing machine executable instructions arranged, when executed by one or more processors, to process a demodulation reference signal; the instructions comprising instructions to: generate a demodulation reference signal, spread an instance of the demodulation reference signal using a prescribed orthogonal cover code of a prescribed length for transmission via antenna port 8, spread an instance of the demodulation reference signal using a further orthogonal cover code of a further prescribed length for transmission via antenna port 13, and co-schedule transmission of the spread instances of the demodulation reference signals.

In Example 74, the subject matter of example 73, or any of the examples described herein in which the prescribed orthogonal cover code has a prescribed length of two or four.

In Example 75, the subject matter of either of examples 73 and 74, or any of the examples described herein in which the further prescribed orthogonal cover code has a further prescribed length of two or four.

In Example 76, the subject matter of any of examples 73 to 75, or any of the examples described herein in which the instructions to generate the demodulation reference signal is responsive to an associated scrambling identity (nSCID).

In Example 77, the subject matter of any of examples 73 to 76, or any of the examples described herein in which said instructions to co-schedule comprise instructions to associate the spread instances of the demodulation reference signals with corresponding resources.

In Example 78, the subject matter of example 77, or any of the examples described herein in which the corresponding resources comprise at least one of: corresponding resource elements, one or more than one time slot, one or more than one symbol, or a physical resource block.

In Example 79, there is provided an apparatus for a user equipment to process a demodulation reference signal; the apparatus comprising an input to receive a demodulation reference signal spread using a respective orthogonal cover code of a respective length associated with antenna port 7 of a physical downlink shared channel, an input to receive a co-scheduled demodulation reference signal spread using an associated orthogonal cover code of a prescribed length associated with antenna port 11 of the physical downlink shared channel; and circuitry to despread at least one of the demodulation reference signal spread using said respective orthogonal cover code of said respective length to recover the demodulation reference signal, or the co-scheduled demodulation reference signal spread using said associated orthogonal cover code of said prescribed length to recover the demodulation reference signal.

In Example 80, the subject matter of example 79, or any of the examples described herein further comprising estimating channel characteristics of a channel associated with antenna port 7 using the despread demodulation reference signal.

In Example 81, the subject matter of example 80, or any of the examples described herein further comprising decoding data using said channel characteristics.

In Example 82, the subject matter of any of examples 79 to 81, or any of the examples described herein further comprising estimating channel characteristics of a channel associated with antenna port 11 using the despread co-scheduled demodulation reference signal.

In Example 83, the subject matter of example 82, or any of the examples described herein further comprising decoding data using said channel characteristics associated with antenna port 11 using the despread co-scheduled demodulation reference signal.

In Example 84, the subject matter of any of examples 79 to 83, or any of the examples described herein in which the respective orthogonal cover code of a respective length associated with antenna port 7 has a length of two or four.

In Example 85, the subject matter of any of examples 79 to 84, or any of the examples described herein in which the associated orthogonal cover code of said prescribed length associated with antenna port 11 has a length of two or four.

In Example 86, there is provided an apparatus for a user equipment to process a demodulation reference signal; the apparatus comprising an input to receive a demodulation reference signal spread using a respective orthogonal cover code of a respective length associated with antenna port 8 of a physical downlink shared channel, an input to receive a co-scheduled demodulation reference signal spread using an associated orthogonal cover code of a prescribed length associated with antenna port 13 of a physical downlink shared channel; and circuitry to despread at least one of the demodulation reference signal spread using said respective orthogonal cover code of said respective length to recover the demodulation reference signal, or the co-scheduled demodulation reference signal spread using said associated orthogonal cover code of said prescribed length to recover the demodulation reference signal.

In Example 87, the subject matter of example 86, or any of the examples described herein further comprising a channel estimator to estimate channel characteristics of a channel associated with antenna port 8 using the despread demodulation reference signal.

In Example 88, the subject matter of example 87, or any of the examples described herein further comprising a decoder to decode data using said channel characteristics.

In Example 89, the subject matter of any of examples 86 to 88, or any of the examples described herein further comprising a channel estimator to estimate channel characteristics of a channel associated with antenna port 13 using the despread co-scheduled demodulation reference signal.

In Example 90, the subject matter of example 89, or any of the examples described herein further comprising a decoder to decode data using said channel characteristics associated with antenna port 13 using the despread co-scheduled demodulation reference signal.

In Example 91, the subject matter of any of examples 86 to 90, or any of the examples described herein in which the respective orthogonal cover code of said respective length associated with antenna port 8 has a length of two or four.

In Example 92, the subject matter of any of examples 86 to 91, or any of the examples described herein in which the associated orthogonal cover code of said prescribed length associated with antenna port 13 has a length of two or four.

In Example 93, there is provided an apparatus for a base station to co-schedule demodulation reference signals; the apparatus comprising generator circuitry to generate a demodulation reference signal, spreader circuitry to spread an instance of the demodulation reference signal using a prescribed orthogonal cover code of a prescribed length for transmission via antenna port 7, spreader circuitry to spread an instance of the demodulation reference signal using a further orthogonal cover code of a further prescribed length for transmission via antenna port 11, and a scheduler to co-schedule transmission of the spread instances of the demodulation reference signals.

In Example 94, the subject matter of example 93, or any of the examples described herein in which the prescribed orthogonal cover code has a prescribed length of two or four.

In Example 95, the subject matter of either of examples 93 and 94, or any of the examples described herein in which the further prescribed orthogonal cover code has a further prescribed length of two or four.

In Example 96, the subject matter of any of examples 93 to 95, or any of the examples described herein in which the generator circuitry to generate the demodulation reference signal is responsive to an associated scrambling identity (nSCID).

In Example 97, the subject matter of any of examples 93 to 96, or any of the examples described herein in which said scheduler to co-schedule comprises circuitry to associate the spread instances of the demodulation reference signals with corresponding resources.

In Example 98, the subject matter of example 97, or any of the examples described herein in which the corresponding resources comprise at least one of: corresponding resource elements, one or more than one time slot, one or more than one symbol, or a physical resource block.

In Example 99, there is provided an apparatus for a base station to co-schedule demodulation reference signals; the apparatus comprising generator circuitry to generate a demodulation reference signal, spreader circuitry to spread an instance of the demodulation reference signal using a prescribed orthogonal cover code of a prescribed length for transmission via antenna port 8, spreader circuitry to spread an instance of the demodulation reference signal using a further orthogonal cover code of a further prescribed length for transmission via antenna port 13, and a scheduler to co-schedule transmission of the spread instances of the demodulation reference signals.

In Example 100, the subject matter of example 99, or any of the examples described herein in which the prescribed orthogonal cover code has a prescribed length of two or four.

In Example 101, the subject matter of either of examples 99 and 100, or any of the examples described herein in which the further prescribed orthogonal cover code has a further prescribed length of two or four.

In Example 102, the subject matter of any of examples 99 to 101, or any of the examples described herein in which the generator circuitry to generate the demodulation reference signal is responsive to an associated scrambling identity (nSCID).

In Example 103, the subject matter of any of examples 99 to 102, or any of the examples described herein in which said scheduler to co-schedule comprises circuitry to associate the spread instances of the demodulation reference signals with corresponding resources.

In Example 104, the subject matter of example 103, or any of the examples described herein in which the corresponding resources comprise at least one of: corresponding resource elements, one or more than one time slot, one or more than one symbol, or a physical resource block.

In Example 105, there is provided a method of processing a demodulation reference signal spread using a respective orthogonal cover code; the method comprising despreading the demodulation reference signal using a further orthogonal cover code; the respective orthogonal cover code and the further orthogonal cover code having different code lengths.

In Example 106, the subject matter of example 105, or any of the examples described herein comprising receiving the demodulation reference signal via a respective antenna port or wherein the demodulation reference signal is associated with a respective antenna port.

In Example 107, the subject matter of either of examples 105 to 106, or any of the examples described herein in which the respective orthogonal cover code has a length of two or four.

In Example 108, the subject matter of any of examples 105 to 107, or any of the examples described herein in which the further orthogonal cover code has a length of two or four.

In Example 109, the subject matter of any of examples 105 to 108, or any of the examples described herein wherein said despreading the demodulation reference signal using a further orthogonal cover code comprises despreading said demodulation reference signal using said further orthogonal cover code in the presence of an interference signal associated with an interfering antenna port.

In Example 110, the subject matter of example 109, or any of the examples described herein in which the interfering antenna port is an antenna port selected from a set of antenna ports.

In Example 111, the subject matter of example 110, or any of the examples described herein in which the set of antenna ports comprises antenna one or more than one of antenna ports 7, 8, 11 or 13.

In Example 112, the subject matter of any of examples 105 to 111, or any of the examples described herein comprising estimating channel characteristics using the despread demodulation reference signal.

In Example 113, the subject matter of example 112, or any of the examples described herein in which said estimating channel characteristics using the despread demodulation reference signal comprises performing at least a pair of channel estimates respectively associated with first and second time slots bearing the demodulation reference signal.

In Example 114, the subject matter of example 113, or any of the examples described herein further comprises multiplying the channel estimate associated with the second time slot by a factor; optionally, the factor is −1.

In Example 115, the subject matter of either of examples 113 and 114, or any of the examples described herein comprising performing channel interpolation filtering based on said at least a pair of channel estimates.

In Example 116, the subject matter of any of examples 113 to 115, or any of the examples described herein wherein said performing at least a pair of channel estimates respectively associated with first and second time slots bearing the demodulation reference signal comprises performing a channel estimation for a first time slot associated with a respective antenna port.

In Example 117, the subject matter of example 116, or any of the examples described herein in which the channel estimate for the first time slot associated with a respective antenna port is ĥ_{1,1}=½(y₁s′₁+y₂s′₂)=h₁+η₁, where s′₁ and s′₂ are estimates corresponding to received modulation symbols associated with the first time slot, y₁ and y₂ are signals bearing the modulation symbols associated with the first time slot, η₁ is noise associated with the respective antenna port, and h₁ is the channel associated with the respective antenna port.

In Example 118, the subject matter of any of examples 113 to 117, or any of the examples described herein wherein said performing at least a pair of channel estimates respectively associated with first and second time slots bearing the demodulation reference signal comprises performing a channel estimation for a second time slot associated with a respective antenna port.

In Example 119, the subject matter of example 118, or any of the examples described herein in which the channel estimate for the second time slot associated with a respective antenna port is ĥ_{1,2}=½(y₃s′₃+y₄s′₄)=h₁+η₁, where s′₃ and s′₄ are estimates corresponding to received modulation symbols associated with the second time slot, y₃ and y₄ are signals bearing the modulation symbols associated with the second time slot, η₁ is noise associated with the respective antenna port, and h₁ is the channel associated with the respective antenna port.

In Example 120, the subject matter of example 119, or any of the examples described herein comprising multiplying ĥ_{1,2}=½(y₃s′₃+y₄s′₄)=−h₁+η₁ by −1 to give ĥ_{1,2}=h₁+η′₃, where η′₃ is noise associated with the respective antenna port.

In Example 121, the subject matter of example 120, or any of the examples described herein comprising performing channel interpolation filtering based on the despread channel estimations in the first and second time slots.

In Example 122, the subject matter of example 121, or any of the examples described herein in which performing channel interpolation filtering based on the despread channel estimations in the first and second time slots comprises determining

$$H = {W}^{T} [ \begin{matrix}{\hat{h}}_{1 , 1} \\ {\hat{h}}_{1 , 2}\end{matrix} ] ,$$

where H is the final channel estimate and W is the channel interpolation filter.

In Example 123, the subject matter of example 122, or any of the examples described herein in which the channel interpolation filter is a Minimum Mean Square Error filter.

In Example 124, there is provided an apparatus for a user equipment for processing a demodulation reference signal spread using a respective orthogonal cover code; the apparatus comprising means to despread the demodulation reference signal using a further orthogonal cover code; the respective orthogonal cover code and the further orthogonal cover code having different code lengths.

In Example 125, the subject matter of example 124, or any of the examples described herein comprising means to receive the demodulation reference signal via a respective antenna port or wherein the demodulation reference signal is associated with a respective antenna port.

In Example 126, the subject matter of either of examples 124 to 125, or any of the examples described herein in which the respective orthogonal cover code has a length of two or four.

In Example 127, the subject matter of any of examples 124 to 126, or any of the examples described herein in which the further orthogonal cover code has a length of two or four.

In Example 128, the subject matter of any of examples 124 to 127, or any of the examples described herein wherein said means to despread the demodulation reference signal using a further orthogonal cover code comprises means to despread said demodulation reference signal using said further orthogonal cover code in the presence of an interference signal associated with an interfering antenna port.

In Example 129, the subject matter of example 128, or any of the examples described herein in which the interfering antenna port is an antenna port selected from a set of antenna ports.

In Example 130, the subject matter of example 129, or any of the examples described herein in which the set of antenna ports comprises antenna one or more than one of antenna ports 7, 8, 11 or 13.

In Example 131, the subject matter of any of examples 124 to 130, or any of the examples described herein comprising means to estimate channel characteristics using the despread demodulation reference signal.

In Example 132, the subject matter of example 131, or any of the examples described herein in which said means to estimate channel characteristics using the despread demodulation reference signal comprises means to perform at least a pair of channel estimates respectively associated with first and second time slots bearing the demodulation reference signal.

In Example 133, the subject matter of example 132, or any of the examples described herein further comprising means to multiply the channel estimate associated with the second time slot by a factor; optionally, the factor is −1.

In Example 134, the subject matter of either of examples 132 and 133, or any of the examples described herein comprising means to perform channel interpolation filtering based on said at least a pair of channel estimates.

In Example 135, the subject matter of any of examples 132 to 134, or any of the examples described herein wherein said means to perform at least a pair of channel estimates respectively associated with first and second time slots bearing the demodulation reference signal comprises means to perform a channel estimation for a first time slot associated with a respective antenna port.

In Example 136, the subject matter of example 135, or any of the examples described herein in which the channel estimate for the first time slot associated with a respective antenna port is ĥ_{1,2}=½(y₁s′₁+y₂s′₂)=h₁+η₁, where s′₁ and s′₂ are estimates corresponding to received modulation symbols associated with the first time slot, y₁ and y₂ are signals bearing the modulation symbols associated with the first time slot, η₁ is noise associated with the respective antenna port, and h₁ is the channel associated with the respective antenna port.

In Example 137, the subject matter of any of examples 132 to 136, or any of the examples described herein wherein said means to perform at least a pair of channel estimates respectively associated with first and second time slots bearing the demodulation reference signal comprises means to perform a channel estimation for a second time slot associated with a respective antenna port.

In Example 138, the subject matter of example 137, or any of the examples described herein in which the channel estimate for the second time slot associated with a respective antenna port is ĥ_{1,2}=½(y₃s′₃+y₄s′₄)=h₁+η₁, where s′₃ and s′₄ are estimates corresponding to received modulation symbols associated with the second time slot, y₃ and y₄ are signals bearing the modulation symbols associated with the second time slot, η₁ is noise associated with the respective antenna port, and h₁ is the channel associated with the respective antenna port.

In Example 139, the subject matter of example 138, or any of the examples described herein comprising means to multiply ĥ_{1,2}=½(y₃s′₃+y₄s′₄)=h₁+η₁ by −1 to give where η′₃ is noise associated with the respective antenna port.

In Example 140, the subject matter of example 139, or any of the examples described herein comprising means to perform channel interpolation filtering based on the despread channel estimations in the first and second time slots.

In Example 141, the subject matter of example 140, or any of the examples described herein in which said means to perform channel interpolation filtering based on the despread channel estimations in the first and second time slots comprises means to determine

$$H = {W}^{T} [ \begin{matrix}{\hat{h}}_{1 , 1} \\ {\hat{h}}_{1 , 2}\end{matrix} ] ,$$

where H is the final channel estimate and W is the channel interpolation filter.

In Example 142, the subject matter of example 141, in which the channel interpolation filter is a Minimum Mean Square Error filter.

In Example 143, there is provided machine readable storage storing machine executable instructions arranged, when executed by processing circuitry, to process a demodulation reference signal spread using a respective orthogonal cover code; said instructions comprising instructions to despread the demodulation reference signal using a further orthogonal cover code; the respective orthogonal cover code and the further orthogonal cover code having different code lengths.

In Example 144, the subject matter of example 143, or any of the examples described herein comprising instructions to receive the demodulation reference signal via a respective antenna port or wherein the demodulation reference signal is associated with a respective antenna port.

In Example 145, the subject matter of either of examples 143 to 144, or any of the examples described herein in which the respective orthogonal cover code has a length of two or four.

In Example 146, the machine readable storage of any of examples 143 to 145, or any of the examples described herein in which the further orthogonal cover code has a length of two or four.

In Example 147, the subject matter of any of examples 143 to 146, or any of the examples described herein wherein said instructions to despread the demodulation reference signal using a further orthogonal cover code comprises instructions to despread said demodulation reference signal using said further orthogonal cover code in the presence of an interference signal associated with an interfering antenna port.

In Example 148, the subject matter of example 147, or any of the examples described herein in which the interfering antenna port is an antenna port selected from a set of antenna ports.

In Example 149, the subject matter of example 148, or any of the examples described herein in which the set of antenna ports comprises antenna one or more than one of antenna ports 7, 8, 11 or 13.

In Example 150, the subject matter of any of examples 143 to 149, or any of the examples described herein comprising instructions to estimate channel characteristics using the despread demodulation reference signal.

In Example 151, the subject matter of example 150, or any of the examples described herein in which said instructions to estimate channel characteristics using the despread demodulation reference signal comprises instructions to perform at least a pair of channel estimates respectively associated with first and second time slots bearing the demodulation reference signal.

In Example 152, the subject matter of example 151, or any of the examples described herein further comprising instructions to multiply the channel estimate associated with the second time slot by a factor; optionally, the factor is −1.

In Example 153, the subject matter of either of examples 151 and 152, or any of the examples described herein comprising instructions to perform channel interpolation filtering based on said at least a pair of channel estimates.

In Example 154, the subject matter of any of examples 151 to 153, or any of the examples described herein wherein said instructions to perform at least a pair of channel estimates respectively associated with first and second time slots bearing the demodulation reference signal comprises instructions to perform a channel estimation for a first time slot associated with a respective antenna port.

In Example 155, the subject matter of example 154, or any of the examples described herein in which the channel estimate for the first time slot associated with a respective antenna port is ĥ_{1,2}=½(y₁s′₁+y₂s′₂)=h₁+η₁, where s′₁ and s′₂ are estimates corresponding to received modulation symbols associated with the first time slot, y₁ and y₂ are signals bearing the modulation symbols associated with the first time slot, η₁ is noise associated with the respective antenna port, and h₁ is the channel associated with the respective antenna port.

In Example 156, the subject matter of any of examples 151 to 155, or any of the examples described herein wherein said instructions to perform at least a pair of channel estimates respectively associated with first and second time slots bearing the demodulation reference signal comprises instructions to perform a channel estimation for a second time slot associated with a respective antenna port.

In Example 157, the subject matter of example 156, or any of the examples described herein in which the channel estimate for the second time slot associated with a respective antenna port is ĥ_{1,2}=½(y₃s′₃+y₄s′₄)=h₁+η₁, where s′₃ and s′₄ are estimates corresponding to received modulation symbols associated with the second time slot, y₃ and y₄ are signals bearing the modulation symbols associated with the second time slot, η₁ is noise associated with the respective antenna port, and h₁ is the channel associated with the respective antenna port.

In Example 158, the subject matter of example 157, or any of the examples described herein comprising instructions to multiply ĥ_{1,2}=½(y₃s′₃+y₄s′₄)=h₁+η₁ by −1 to give ĥ_{1,2}=h₁+η′₃, where η′₃ is noise associated with the respective antenna port.

In Example 159, the subject matter of example 158, or any of the examples described herein comprising instructions to perform channel interpolation filtering based on the despread channel estimations in the first and second time slots.

In Example 160, the machine readable storage of example 159, or any of the examples described herein in which said instructions to perform channel interpolation filtering based on the despread channel estimations in the first and second time slots comprises instructions to determine

$$H = {W}^{T} [ \begin{matrix}{\hat{h}}_{1 , 1} \\ {\hat{h}}_{1 , 2}\end{matrix} ] ,$$

where H is the final channel estimate and W is the channel interpolation filter.

In Example 161, the subject matter of example 160, or any of the examples described herein in which the channel interpolation filter is a Minimum Mean Square Error filter.

In Example 162, there is provided an apparatus for a user equipment comprising machine readable storage of any of examples 143 to 161, or any of the examples described herein.

In Example 163, there is provided a user equipment comprising machine readable storage of any of examples 143 to 161, or any of the examples described herein.

In Example 164, the subject matter of example 163, or any of the examples described herein further comprising at least one or more of a display, graphical user interface, audio output, keyboard, audio input, physical user interface, memory or processor.

In Example 165, there is provided an apparatus for a user equipment for processing modulation symbols, associated with a demodulation reference signal, spread using a respective orthogonal cover code; the apparatus comprising circuitry to: an input interface to receive the modulation symbols associated with the demodulation reference signal; circuitry to recover the modulation symbols, associated with the demodulation reference signal, using a further orthogonal cover code; the respective orthogonal cover code and the further orthogonal cover code having different code lengths, and an output interface to output the recovered modulation symbols.

In Example 166, the subject matter of example 165, or any of the examples described herein in which the modulation symbols are associated with a respective antenna port.

In Example 167, the subject matter of either of examples 165 to 166, or any of the examples described herein in which the respective orthogonal cover code has a length of a power of two, optionally two or four.

In Example 168, the subject matter of any of examples 165 to 167, or any of the examples described herein in which the further orthogonal cover code has a length of a power of two, optionally two or four.

In Example 169, the subject matter of any of examples 165 to 168, or any of the examples described herein wherein said circuitry to recover the modulation symbols using a further orthogonal cover code comprises circuitry to despread said modulation symbols using said further orthogonal cover code in the presence of a further signal associated with a further antenna port.

In Example 170, the subject matter of example 169, or any of the examples described herein in which the further antenna port is an antenna port selected from a set of antenna ports.

In Example 171, the subject matter of example 170, or any of the examples described herein in which the set of antenna ports comprises one or more than one of antenna ports 7, 8, 11 or 13.

In Example 172, the subject matter of any of examples 165 to 170, or any of the examples described herein comprising channel estimation circuitry to estimate channel characteristics using the recovered modulation symbols.

In Example 173, the subject matter of example 172, or any of the examples described herein in which said channel estimation circuitry to estimate channel characteristics using the recovered modulation symbols comprises circuitry to determine at least a pair of channel estimates respectively associated with first and second time slots bearing the modulation symbols.

In Example 174, the subject matter of example 173, or any of the examples described herein further comprising a multiplier to multiply the channel estimate associated with the second time slot by a factor; optionally, the factor is −1.

In Example 175, the subject matter of either of examples 173 and 174, or any of the examples described herein comprising a filter to perform channel interpolation filtering based on said at least a pair of channel estimates.

In Example 176, the subject matter of any of examples 173 to 175, or any of the examples described herein wherein said circuitry to determine at least a pair of channel estimates respectively associated with first and second time slots bearing the modulation symbols comprises circuitry to estimate a channel associated with a first time slot associated with a respective antenna port.

In Example 177, the subject matter of example 176, in which the channel estimate for the first time slot associated with a respective antenna port is ĥ_{1,2}=½(y₁s′₁+y₂s′₂)=h₁+η₁, where s′₁ and s′₂ are estimates corresponding to received modulation symbols associated with the first time slot, y₁ and y₂ are signals bearing the modulation symbols associated with the first time slot, η₁ is noise associated with the respective antenna port, and h₁ is the channel associated with the respective antenna port.

In Example 178, the subject matter of any of examples 173 to 177, or any of the examples described herein wherein said circuitry determine at least a pair of channel estimates respectively associated with first and second time slots bearing the modulation symbols comprises circuitry to estimate a channel associated with a second time slot associated with a respective antenna port.

In Example 179, the subject matter of example 178, or any of the examples described herein in which the channel estimate for the second time slot associated with a respective antenna port is ĥ_{1,2}=½(y₃s′₃+y₄s′₄)=h₁+η₁, where s′₃ and s′₄ are estimates corresponding to received modulation symbols associated with the second time slot, y₃ and y₄ are signals bearing the modulation symbols associated with the second time slot, η₁ is noise associated with the respective antenna port, and h₁ is the channel associated with the respective antenna port.

In Example 180, the subject matter of example 179, or any of the examples described herein comprising multiplier circuitry to multiply ĥ_{1,2}=½(y₃s′₃+y₄s′₄)=h₁+η₁ by −1 to give ĥ_{1,2}=h₁+η′₃, where η′₃ is noise associated with the respective antenna port.

In Example 181, the subject matter of example 180, or any of the examples described herein comprising a filter to perform channel interpolation filtering based on the channel estimations in the first and second time slots.

In Example 182, the subject matter of example 181, or any of the examples described herein in which said filter to perform channel interpolation filtering based on the despread channel estimations in the first and second time slots comprises filter circuitry to determine

$$H = {W}^{T} [ \begin{matrix}{\hat{h}}_{1 , 1} \\ {\hat{h}}_{1 , 2}\end{matrix} ] ,$$

where H is the final channel estimate and W is the channel interpolation filter.

In Example 183, the subject matter of example 182, in which the channel interpolation filter is a Minimum Mean Square Error filter.

In Example 184, there is provided a method of processing a demodulation reference signal; the method comprising receiving, via antenna port 11 over a prescribed channel, a demodulation reference signal spread using an orthogonal cover code of length four and having an associated scrambling identity (nSCID) of zero; and receiving, via a further antenna port of a set of antenna ports over the prescribed channel, a co-scheduled demodulation reference signal spread using an orthogonal cover code of length four and having an associated scrambling identity (nSCID) of zero; and despreading the demodulation reference signal associated with antenna port 11 to recover the demodulation reference signal.

In Example 185, the subject matter of example 184, or any of the examples described herein further comprising performing channel estimation of a channel using the despread demodulation reference signal.

In Example 186, the subject matter of either of examples 184 and 185, or any of the examples described herein in which the prescribed channel is a Physical Downlink Shared Channel.

In Example 187, there is provided a method of scheduling a demodulation reference signal via an antenna port in a multi-user multiple input multiple output system; the method comprising generating a demodulation reference signal that has been spread using a respective spreading orthogonal cover code of length four for output via antenna port 11; generating a further demodulation reference signal that has been spread using a further respective spreading orthogonal cover code of length four for output via a further antenna port of a set of antenna ports; and co-scheduling the spread demodulation reference signals for transmission via antenna port 11 and the further antenna port of the set of antenna ports respectively.

In Example 188, the subject matter of example 187, or any of the examples described herein in which the set of antenna ports comprises at least one or more than one of antenna ports 7, 8, and 13.

In Example 189, the subject matter of example 188, or any of the examples described herein comprising selecting said further respective antenna port from the set of antenna ports 7, 8, and 13.

In Example 190, the subject matter of example 189, or any of the examples described herein in which said selecting said further respective antenna port from the set of antenna ports comprises selecting said further respective antenna port randomly from the set of antenna ports.

In Example 191, the subject matter of either of examples 189 and 190, or any of the examples described herein in which said selecting said further respective antenna port from the set of antenna ports comprises dynamically selecting said further respective antenna port from the set of antenna ports.

In Example 192, the subject matter of any of examples 187 to 191, or any of the examples described herein in which antenna port 11 is a fixed antenna port.

In Example 193, there is provided machine readable storage storing machine executable instructions arranged, when executed by processor circuitry, to process a demodulation reference signal; the machine executable instructions comprising instructions to recover a demodulation reference signal spread using an orthogonal cover code of length four and having an associated scrambling identity (nSCID) of zero; said demodulation reference signal being associated with antenna port 11 and a prescribed channel; and instructions to receive a co-scheduled demodulation reference signal spread using an orthogonal cover code of length four and having an associated scrambling identity (nSCID) of zero; said co-scheduled demodulation reference signal being associated with a further antenna port of a set of antenna ports and the prescribed channel; and instructions to despread the demodulation reference signal associated with antenna port 11 to recover the demodulation reference signal.

In Example 194, the subject matter of example 193, or any of the examples described herein further comprising instructions to perform channel estimation of a channel using the despread demodulation reference signal.

In Example 195, the subject matter of either of examples 193 and 194, or any of the examples described herein in which the prescribed channel is a Physical Downlink Shared Channel.

In Example 196, there is provided machine readable storage storing instructions to schedule a demodulation reference signal via an antenna port in a multi-user multiple input multiple output system; the instructions comprising instructions to generate a demodulation reference signal that has been spread using a respective spreading orthogonal cover code of length four for output via antenna port 11; instructions to generate a further demodulation reference signal that has been spread using a respective spreading orthogonal cover code of length four for output via a further antenna port of a set of antenna ports; and instructions to co-schedule the spread demodulation reference signals for transmission via antenna port 11 and the further antenna port of the set of antenna ports respectively.

In Example 197, the subject matter of example 196, or any of the examples described herein in which the set of antenna ports comprises at least one or more than one of antenna ports 7, 8, and 13.

In Example 198, the subject matter of example 197, or any of the examples described herein comprising instructions to select said further respective antenna port from the set of antenna ports 7, 8, and 13.

In Example 199, the subject matter of example 198, or any of the examples described herein in which said instructions to select said further respective antenna port from the set of antenna ports comprises instructions to select said further respective antenna port randomly from the set of antenna ports.

In Example 200, the subject matter of either of examples 198 and 199, or any of the examples described herein in which said instructions to select said further respective antenna port from the set of antenna ports comprises instructions to dynamically select said further respective antenna port from the set of antenna ports.

In Example 201, the subject matter of any of examples 193 to 200, or any of the examples described herein in which antenna port 11 is a fixed antenna port.

In Example 202, there is provided an apparatus for a user equipment comprising machine readable storage of any of examples 193 to 201, or any of the examples described herein.

In Example 203, there is provided a user equipment comprising machine readable storage of any of examples 193 to 201, or any of the examples described herein.

In Example 204, the subject matter of example 203, or any of the examples described herein further comprising at least one or more of a display, graphical user interface, audio output, keyboard, audio input, physical user interface, memory or processor.

In Example 205, there is provided an apparatus to process a demodulation reference signal; the apparatus comprising means to recover a demodulation reference signal spread using an orthogonal cover code of length four and having an associated scrambling identity (nSCID) of zero; said demodulation reference signal being associated with antenna port 11 and a prescribed channel; and means to receive a co-scheduled demodulation reference signal spread using an orthogonal cover code of length four and having an associated scrambling identity (nSCID) of zero; said co-scheduled demodulation reference signal being associated with a further antenna port of a set of antenna ports and the prescribed channel; and means to despread the demodulation reference signal associated with antenna port 11 to recover the demodulation reference signal.

In Example 206, the subject matter of example 205, or any of the examples described herein further comprising means to perform channel estimation of a channel using the despread demodulation reference signal.

In Example 207, the subject matter of either of examples 205 and 206, or any of the examples described herein in which the prescribed channel is a Physical Downlink Shared Channel.

In Example 208, there is provided an apparatus to schedule a demodulation reference signal via an antenna port in a multi-user multiple input multiple output system; the means comprising means to generate a demodulation reference signal that has been spread using a respective spreading orthogonal cover code of length four for output via antenna port 11; means to generate a further demodulation reference signal that has been spread using a respective spreading orthogonal cover code of length four for output via a further antenna port of a set of antenna ports; and means to co-schedule the spread demodulation reference signals for transmission via antenna port 11 and the further antenna port of the set of antenna ports respectively.

In Example 209, the subject matter of example 208, or any of the examples described herein in which the set of antenna ports comprises at least one or more than one of antenna ports 7, 8, and 13.

In Example 210, the subject matter of example 209, or any of the examples described herein comprising means to select said further respective antenna port from the set of antenna ports 7, 8, and 13.

In Example 211, the subject matter of example 210, or any of the examples described herein in which said means to select said further respective antenna port from the set of antenna ports comprises means to select said further respective antenna port randomly from the set of antenna ports.

In Example 212, the subject matter of either of examples 210 and 211, or any of the examples described herein in which said means to select said further respective antenna port from the set of antenna ports comprises means to dynamically select said further respective antenna port from the set of antenna ports.

In Example 213, the subject matter of any of examples 208 to 212, or any of the examples described herein in which antenna port 11 is a fixed antenna port.

In Example 214, there is provided an apparatus for a user equipment to process a demodulation reference signal; the apparatus comprising circuitry to despread a demodulation reference signal, associated with antenna port 11, that was spread using an orthogonal cover code of length four and having an associated scrambling identity (nSCID) of zero in the presence of a co-scheduled demodulation reference signal associated with a further antenna port of a set of antenna ports received over the prescribed channel, the co-scheduled demodulation reference signal having been spread using an orthogonal cover code of length four and having an associated scrambling identity (nSCID) of zero; and output the despread demodulation reference signal associated with antenna port 11.

In Example 215, the subject matter of example 214, or any of the examples described herein further comprising channel estimation circuitry to estimate a channel using the despread demodulation reference signal.

In Example 216, the subject matter of either of examples 214 and 215, or any of the examples described herein in which the prescribed channel is a Physical Downlink Shared Channel.

In Example 217, there is provided an apparatus for a base station to schedule a demodulation reference signal via an antenna port in a multi-user multiple input multiple output system; the apparatus comprising circuitry to generate a demodulation reference signal that has been spread using a respective spreading orthogonal cover code of length four for output via antenna port 11; circuitry to generate a further demodulation reference signal that has been spread using a respective spreading orthogonal cover code of length four for output via a further antenna port of a set of antenna ports; and circuitry to co-schedule the spread demodulation and further demodulation reference signals for transmission via antenna port 11 and the further antenna port of the set of antenna ports respectively.

In Example 218, the subject matter of example 217, or any of the examples described herein in which the set of antenna ports comprises at least one or more than one of antenna ports 7, 8, and 13.

In Example 219, the subject matter of example 218, or any of the examples described herein comprising circuitry to select said further respective antenna port from the set of antenna ports 7, 8, and 13.

In Example 220, the subject matter of example 219, or any of the examples described herein in which said circuitry to select said further respective antenna port from the set of antenna ports comprises circuitry to select said further respective antenna port randomly from the set of antenna ports.

In Example 221, the subject matter of either of examples 219 and 220, or any of the examples described herein in which said circuitry to select said further respective antenna port from the set of antenna ports comprises circuitry to dynamically select said further respective antenna port from the set of antenna ports.

In Example 222, the subject matter of any of examples 217 to 221, or any of the examples described herein in which antenna port 11 is a fixed antenna port.

In Example 223, there is provided a signal comprising a plurality of co-scheduled reference signals that have been spread using respective orthogonal cover codes having respective code lengths and that have been associated with respective antenna ports.

In Example 224, the subject matter of example 223, or any of the examples described herein, in which the reference signals comprise demodulation reference signals.

In Example 225, the subject matter of either of examples 223 and 224, or any of the examples described herein, in which a first reference signal of the co-scheduled reference signals has been spread using an orthogonal cover code having a prescribed code length.

In Example 226, the subject matter of example 225 or any of the examples described herein, in which the prescribed code length is 2 or 4.

In Example 227, the subject matter of any of examples 223 to 225, or any of the examples described herein, in which a second reference signal of the co-scheduled reference signals has been spread using an orthogonal cover code having a different prescribed code length.

In Example 228, the subject matter of example 227, or any of the examples described herein, in which the different prescribed code length is 2 or 4.

In Example 229, the subject matter of any of examples 223 to 228, or any of the examples described herein, in which the respective antenna ports are associated with a set of antenna ports.

In Example 230, the subject matter of example 229, or any of the examples described herein, in which the set of antenna ports comprises antenna ports {7, 8, 11, 13}.

In Example 231, the subject matter of either of examples 229 and 230, or any of the examples described herein, in which a first antenna port of the respective antenna ports comprises antenna port 11.

In Example 232, the subject matter of any of examples 229 to 231, or any of the examples described herein, in which a second antenna port of the respective antenna ports comprises an antenna port selected from antenna ports {7, 8, 13}.

In Example 233, the subject matter of any of examples 223 to 232, or any of the examples described herein, in which the respective antenna ports are associated with subsets of the set of antenna ports.

In Example 234, the subject matter of example 233, or any of the examples described herein, in which a first subset of the subsets of the set of antenna ports comprises antenna ports {7, 8}.

In Example 235, the subject matter of either of examples 233 and 234, or any of the examples described herein, in which a second subset of the subsets of the set of antenna ports comprises antenna ports {11, 13}.

In Example 236, the subject matter of any of examples 223 to 235, or any of the examples described herein, in which a first antenna port of the respective antenna ports comprises antenna port 7 and a second antenna ports of the respective antenna ports comprises antenna port 11 or antenna port 13.

In Example 237, the subject matter of any of examples 223 to 236, or any of the examples described herein, in which a first antenna port of the respective antenna ports comprises antenna port 8 and a second antenna ports of the respective antenna ports comprises antenna port 11 or antenna port 13.

In Example 238, there is provided a data structure for communicating co-scheduling of a plurality of signal transmissions, via respective antenna ports, using respective length orthogonal cover codes for the plurality signal transmission; the data structure comprising at least one of information associated with a signal of the plurality of signals, said information comprising data associated with a respective antenna port and a respective orthogonal cover code length, or further information associated with a further signal of the plurality of signals, said further information comprising data associated with a further antenna port and a further orthogonal cover code length.

In example 239, the subject matter of example 238, or any of the examples described herein, in which the information associated with a signal of the plurality of signals, said information comprising data associated with a respective antenna port and a respective orthogonal cover code length comprises data associated with an antenna port of a set of antenna ports.

In example 240, the subject matter of either of examples 238 and 239, or any of the examples described herein, in which the further information associated with a further signal of the plurality of signals, said further information comprising data associated with a further respective antenna port and a further respective orthogonal cover code length comprises data associated with an antenna port of a set of antenna ports.

In example 241, the subject matter of either of examples 239 and 240, or any of the examples described herein, in which the data associated with an antenna port of a set of antenna ports comprises an antenna port 7, 8, 11 or 13.

In example 242, the subject matter of example 241, or any of the examples described herein, in which the data associated with an antenna port of a set of antenna ports comprises antenna port 11 or antenna port 13 In example 243, the subject matter of either of examples 241 and 242 or any of the examples described herein, in which the data associated with an antenna port of a set of antenna ports comprises antenna port 7 or antenna port 8.

In example, 244, the subject matter of any of examples 238 to 243, or any of the examples described herein, in which the respective orthogonal cover code length comprises an orthogonal cover code length of two or four.

In example 245, the subject matter of any of examples 238 to 244, or any of the examples described herein, in which the further orthogonal cover code length comprises an orthogonal cover code length of two or four.

In example 246, the subject matter of any of examples 238 to 245, or any of the examples described herein, in which the information associated with a signal of the plurality of signals, said information comprising data associated with a respective antenna port and a respective orthogonal cover code length, or the further information associated with a further signal of the plurality of signals, said further information comprising data associated with a further antenna port and a further orthogonal cover code length comprises data associated with antenna port 11 respective scrambling identities.

In example 247, the subject matter of any of examples 238 to 246, or any of the examples described herein, in which the information associated with a signal of the plurality of signals, said information comprising data associated with a respective antenna port and a respective orthogonal cover code length comprises data associated with antenna port 11 and a respective orthogonal cover code length of 4.

In example, 248, the subject matter of example 247, or any of the examples described herein, in which the information associated with a signal of the plurality of signals, said information comprising data associated with a respective antenna port and a respective orthogonal cover code length comprises data associated with antenna port 11, a respective orthogonal cover code length of 4 and a scrambling identity value of zero.

In example 249, the subject matter of any of examples 238 to 248, or any of the examples described herein, in which the further information associated with a further signal of the plurality of signals, said further information comprising data associated with a further antenna port and a further respective orthogonal cover code length comprises data associated with at least one of antenna port 7, 8, and 13 and a respective orthogonal cover code length of 4.

In example 250, the subject matter of example 249, or any of the examples described herein, in which the further information associated with a further signal of the plurality of signals, said further information comprising data associated with a further antenna port and a further respective orthogonal cover code length comprises data associated with at least one of antenna port 7, 8, and 13, a respective orthogonal cover code length of 4 and a scrambling identity value of zero.

In example, 251, the subject matter of any of examples 238 to 250, or any of the examples described herein, wherein said respective antenna port is antenna port 7 and said further antenna port is antenna port 11.

In example 252, the subject matter of any of examples 238 to 250, or any of the examples described herein, wherein said respective antenna port is antenna port 8 and said further antenna port is antenna port 13.

In Example 253, there is provided a subject matter of processing modulation symbols of a test signal associated with a multi-user multiple input multiple output system; the subject matter comprising processing modulation symbols, associated with a prescribed antenna port, that have been spread using an orthogonal cover code of respective code length and that have an associated scrambling identity (nSCID), in the presence of co-scheduled modulation symbols, associated with a further antenna port of a set of antenna ports that have been spread using a respective orthogonal cover code of a respective code length and that have an associated scrambling identity nSCID.

In example 254, the subject matter of example 253, or any of the examples described herein, further comprising performing a channel estimation using the processed modulation symbols associated with the prescribed antenna port.

In example 256, the subject matter of example 254, or any of the examples described herein, further comprising determining at least one performance metric associated with said channel estimation of the channel associated with the prescribed antenna port.

In example 257, the subject matter of any of examples 253 to 256, or any of the examples described herein, wherein at least one of the modulation symbols or co-scheduled modulation symbols is associated with a demodulation reference signal.

In example 258, the subject matter of any of examples 253 to 257, or any of the examples described herein, wherein processing the modulation symbols associated with said prescribed antenna port comprises despreading the modulation symbols associated with the prescribed antenna port using a despreading orthogonal cover code of said respective length.

In example, 259, the subject matter of any of examples 253 to 258, or any of the examples described herein, in which the prescribed antenna port is a fixed antenna port.

In example 260, the subject matter of any of examples 253 to 259, or any of the examples described herein, in which the prescribed antenna port is antenna port 11.

In example, 261, the subject matter of any of examples 253 to 260, or any of the examples described herein, in which the further antenna port of the set of antenna ports is selected from a set comprising antenna ports 7, 8, and 13.

In example 262, the subject matter of any of examples 253 to 261, or any of the examples described herein, in which said orthogonal cover code of said respective code length of the prescribed antenna port has a code length of 4.

In example 263, the subject matter of any of examples 253 to 262, or any of the examples described herein, in which said scrambling identity associated with the prescribed antenna port has a value of zero.

In example 264, the subject matter of any of examples 253 to 263, or any of the examples described herein, in which said orthogonal cover code of said respective code length of the further antenna port has a code length of 4.

In example 265, the subject matter of any of examples 253 to 264, or any of the examples described herein, in which said scrambling identity associated with the further antenna port has a value of zero.

In example 266, the subject matter of any of examples 253 to 265, or any of the examples described herein, comprising receiving the modulation symbols and co-scheduled modulation symbols.

In example 267, the subject matter of any of examples 253 to 266, or any of the examples described herein, in which at least one of the prescribed antenna port and the further antenna port is associated with a prescribed channel.

In example 268, the subject matter of example 267, or any of the examples described herein, in which the prescribed channel is a Physical Downlink Shared Channel.

In Example 269, there is provided a method of scheduling a demodulation test associated with a prescribed antenna port in a multi-user multiple input multiple output system; the subject matter comprising scheduling modulation symbols having a respective spreading orthogonal cover code of a respective length for output via prescribed antenna port; co-scheduling further modulation symbols having an associated spreading orthogonal cover code of a respective length for output via a further antenna port of a set of antenna ports; and outputting the scheduled and co-scheduled modulation symbols for transmission via the prescribed antenna port and said further antenna port of the set of antenna ports.

In example 270, the subject matter of example 269, or any of the examples described herein, in which said prescribed antenna port comprises an antenna port selected from the set of antenna ports and said further antenna port comprises an antenna ports selected from the set of antenna ports less the prescribed antenna port.

In example 271, the subject matter of either of examples 269 to 270, or any of the examples described herein, wherein the prescribed antenna port is a fixed antenna port.

In example 272, the subject matter of any of examples 269 to 271, or any of the examples described herein, wherein the prescribed antenna port is antenna port 11.

In example 273, the subject matter of any of examples 269 to 272, or any of the examples described herein, in which the set of antenna ports comprises the prescribed antenna port and at least said further antenna port.

In example 274, the subject matter of example 273, or any of the examples described herein, in which the set of antenna ports comprises the prescribed antenna port and a plurality of antenna ports including the further antenna port.

In example 275, the subject matter of any of examples 269 to 274, or any of the examples described herein, in which the set of antenna ports comprises antenna ports {7, 8, 11, 13}.

In example 276, the subject matter of any of examples 269 to 275, or any of the examples described herein, in which at least one of the prescribed antenna port and the further antenna port is associated with a prescribed channel.

In example 278, the subject matter of example 276, or any of the examples described herein, in which the prescribed channel is a Physical Downlink Shared Channel.

In example 279, the subject matter of any of examples 269 to 278, or any other example described herein, in which at least one of said modulation symbols and further modulation symbols are symbols associated with a demodulation reference signal.

In example 280, the subject matter of any of examples 269 to 279, or any of the examples described herein, in which said scheduling modulation symbols having a respective spreading orthogonal cover code of a respective length for output via prescribed antenna port comprises an associated scrambling identity.

In example 281, the subject matter of example 280, or any of the examples described herein, in which the associated scrambling identity has a value of zero or one.

In example 282, the subject matter of any of examples 269 to 281, or any of the examples described herein, in which said co-scheduling further modulation symbols having an associated spreading orthogonal cover code of a respective length for output via a further antenna port of a set of antenna ports comprises an associated scrambling identity.

In example 283, the subject matter of example 282, or any of the examples described herein, in which the associated scrambling identity has a value of zero or one.

In example, 284, the subject matter of any of examples 269 to 283, or any of the examples described herein, wherein said respective spreading orthogonal cover code of a respective length for output via prescribed antenna port has a code length of 4.

In example, 285, the subject matter of any of examples 269 to 284, or any of the examples described herein, wherein said associated spreading orthogonal cover code of a respective length for output via a further antenna port has a code length of 4.

In Example 286, there is provided machine readable storage storing machine executable instructions arranged, when executed by one or more than one processor, to implement a method according to the subject matter of any of examples 253 to 285, or any of the examples described herein.

In Example 287, there is provided a subject matter for a user equipment to process modulation symbols of a test signal associated with a multi-user multiple input multiple output system; the subject matter comprising circuitry: to recover modulation symbols, associated with a prescribed antenna port, that have been spread using an orthogonal cover code of respective code length and that have an associated scrambling identity (nSCID), in the presence of co-scheduled modulation symbols associated with a further antenna port of a set of antenna ports that have been spread using a respective orthogonal cover code of a respective code length and that have an associated scrambling identity nSCID.

In example 289, the subject matter of example 288, or any of the examples described herein, further comprising channel estimation circuitry to perform a channel estimation using the processed modulation symbols associated with the prescribed antenna port.

In example 290, the subject matter of example 289, or any of the examples described herein, further comprising circuitry to determine at least one performance metric associated with said channel estimation of the channel associated with the prescribed antenna port.

In example 291, the subject matter of any of examples 287 to 290, or any of the examples described herein, wherein at least one of the modulation symbols or co-scheduled modulation symbols is associated with a demodulation reference signal.

In example 292, the subject matter of any of examples 287 to 291, or any of the examples described herein, wherein said circuitry to process the modulation symbols associated with said prescribed antenna port comprises circuitry to despread the modulation symbols associated with the prescribed antenna port using a despreading orthogonal cover code of said respective length.

In example 293, the subject matter of any of examples 287 to 292, or any of the examples described herein, in which the prescribed antenna port is a fixed antenna port.

In example 294, the subject matter of any of examples 287 to 293, or any of the examples described herein, in which the prescribed antenna port is antenna port 11.

In example 295, the subject matter of any of examples 287 to 294, or any of the examples described herein, in which the further antenna port of the set of antenna ports is selected from a set comprising antenna ports 7, 8, and 13.

In example 296, the subject matter of any of examples 287 to 295, or any of the examples described herein, in which said orthogonal cover code of said respective code length of the prescribed antenna port has a code length of 4.

In example 297, the subject matter of any of examples 287 to 296, or any of the examples described herein, in which said scrambling identity associated with the prescribed antenna port has a value of zero.

In example 298, the subject matter of any of examples 287 to 297, or any of the examples described herein, in which said orthogonal cover code of said respective code length of the further antenna port has a code length of 4.

In example 299, the subject matter of any of examples 287 to 297, or any of the examples described herein, in which said scrambling identity associated with the further antenna port has a value of zero.

In example 300, the subject matter of any of examples 287 to 299, or any of the examples described herein, comprising circuitry to receive the modulation symbols and co-scheduled modulation symbols.

In example 301, the subject matter of any of examples 287 to 300, or any of the examples described herein, in which at least one of the prescribed antenna port and the further antenna port is associated with a prescribed channel.

In example, 302, the subject matter of example 301, or any of the examples described herein, in which the prescribed channel is a Physical Downlink Shared Channel.

In Example 303, there is provided an apparatus for a base station to schedule a demodulation test associated with a prescribed antenna port in a multi-user multiple input multiple output system; the subject matter comprising circuitry to: schedule modulation symbols having a respective spreading orthogonal cover code of a respective length for output via prescribed antenna port; co-schedule further modulation symbols having an associated spreading orthogonal cover code of a respective length for output via a further antenna port of a set of antenna ports; and output the scheduled and co-scheduled modulation symbols for transmission via the prescribed antenna port and said further antenna port of the set of antenna ports.

In example 304, the subject matter of example 303, or any of the examples described herein, in which said prescribed antenna port comprises an antenna port selected from the set of antenna ports and said further antenna port comprises an antenna ports selected from the set of antenna ports less the prescribed antenna port.

In example 305, the subject matter of either of examples 303 to 304, or any of the examples described herein, wherein the prescribed antenna port is a fixed antenna port.

In example 306, the subject matter of any of examples 303 to 305, or any of the examples described herein, wherein the prescribed antenna port is antenna port 11.

In example 307, the subject matter of any of examples 303 to 306, or any of the examples described herein, in which the set of antenna ports comprises the prescribed antenna port and at least said further antenna port.

In example 308, the subject matter of example 307, or any of the examples described herein, in which the set of antenna ports comprises the prescribed antenna port and a plurality of antenna ports including the further antenna port.

In example 309, the subject matter of any of examples 303 to 308, or any of the examples described herein, in which the set of antenna ports comprises antenna ports {7, 8, 11, 13}.

In example 310, the subject matter of any of examples 303 to 309, or any of the examples described herein, in which at least one of the prescribed antenna port and the further antenna port is associated with a prescribed channel.

In example 311, the subject matter of example 310, or any of the examples described herein, in which the prescribed channel is a Physical Downlink Shared Channel.

In example 312, the subject matter of any of examples 303 to 311, or any of the examples described herein, in which at least one of said modulation symbols and further modulation symbols are symbols associated with a demodulation reference signal.

In example 313, the subject matter of any of examples 303 to 312, or any of the examples described herein, in which said scheduled modulation symbols having a respective spreading orthogonal cover code of a respective length for output via prescribed antenna port have an associated scrambling identity.

In example 314, the subject matter of example 313, or any of the examples described herein, in which the associated scrambling identity has a value of zero or one.

In example 315, the subject matter of any of examples 303 to 314, or any of the examples described herein, in which said co-scheduled further modulation symbols having an associated spreading orthogonal cover code of a respective length for output via a further antenna port of a set of antenna ports comprise an associated scrambling identity.

In example 316, the subject matter of example 315, or any of the examples described herein, in which the associated scrambling identity has a value of zero or one.

In example 317, the subject matter of any of examples 303 to 316, or any of the examples described herein, wherein said respective spreading orthogonal cover code of a respective length for output via prescribed antenna port has a code length of 4.

In example 318, the subject matter of any of examples 303 to 317, or any of the examples described herein, wherein said associated spreading orthogonal cover code of a respective length for output via a further antenna port has a code length of 4.

In Example 319, there is provided an apparatus for a user equipment to process modulation symbols of a test signal associated with a multi-user multiple input multiple output system; the subject matter comprising means: to process modulation symbols, associated with a prescribed antenna port, that have been spread using an orthogonal cover code of respective code length and that have an associated scrambling identity (nSCID), in the presence of co-scheduled modulation symbols associated with a further antenna port of a set of antenna ports that have been spread using a respective orthogonal cover code of a respective code length and that have an associated scrambling identity nSCID.

In example 320, the subject matter of example 319, or any of the examples described herein, further comprising means to perform a channel estimation using the processed modulation symbols associated with the prescribed antenna port.

In example 321, the subject matter of example 320, or any of the examples described herein, further comprising means to determine at least one performance metric associated with said channel estimation of the channel associated with the prescribed antenna port.

In example 322, the subject matter of any of examples 319 to 321 or any of the examples described herein, wherein at least one of the modulation symbols or co-scheduled modulation symbols is associated with a demodulation reference signal.

In example 323, the subject matter of any of examples 319 to 322, or any of the examples described herein, wherein said means to process the modulation symbols associated with said prescribed antenna port comprises means to despread the modulation symbols associated with the prescribed antenna port using a despreading orthogonal cover code of said respective length.

In example 324, the subject matter of any of examples 319 to 323, or any of the examples described herein, in which the prescribed antenna port is a fixed antenna port.

In example 325, the subject matter of any of examples 319 to 324, or any of the examples described herein, in which the prescribed antenna port is antenna port 11.

In example 326, the subject matter of any of examples 319 to 325, or any of the examples described herein, in which the further antenna port of the set of antenna ports is selected from a set comprising antenna ports 7, 8, and 13.

In example 327, the subject matter of any of examples 319 to 326, or any of the examples described herein, in which said orthogonal cover code of said respective code length of the prescribed antenna port has a code length of 4.

In example 328, the subject matter of any of examples 319 to 327, or any of the examples described herein, in which said scrambling identity associated with the prescribed antenna port has a value of zero.

In example 329, the subject matter of any of examples 319 to 328, or any of the examples described herein, in which said orthogonal cover code of said respective code length of the further antenna port has a code length of 4.

In example 330, the subject matter of any of examples 319 to 329, or any of the examples described herein, in which said scrambling identity associated with the further antenna port has a value of zero.

In example 331, the subject matter of any of examples 319 to 326, or any of the examples described herein, comprising means to receive the modulation symbols and co-scheduled modulation symbols.

In example 332, the subject matter of any of examples 319 to 331, or any of the examples described herein, in which at least one of the prescribed antenna port and the further antenna port is associated with a prescribed channel.

In example 333, the subject matter of example 332, or any of the examples described herein, in which the prescribed channel is a Physical Downlink Shared Channel.

In Example 334, there is provided an apparatus for a base station to schedule a demodulation test associated with a prescribed antenna port in a multi-user multiple input multiple output system; the subject matter comprising means to: schedule modulation symbols having a respective spreading orthogonal cover code of a respective length for output via prescribed antenna port; co-schedule further modulation symbols having an associated spreading orthogonal cover code of a respective length for output via a further antenna port of a set of antenna ports; and output the scheduled and co-scheduled modulation symbols for transmission via the prescribed antenna port and said further antenna port of the set of antenna ports.

In example 335, the subject matter of example 334, or any of the examples described herein, in which said prescribed antenna port comprises an antenna port selected from the set of antenna ports and said further antenna port comprises an antenna ports selected from the set of antenna ports less the prescribed antenna port.

In example 336, the subject matter of either of examples 334 to 335, or any of the examples described herein, wherein the prescribed antenna port is a fixed antenna port.

In example 337, the subject matter of any of examples 334 to 336, or any of the examples described herein, wherein the prescribed antenna port is antenna port 11.

In example 338, the subject matter of any of examples 334 to 337, or any of the examples described herein, in which the set of antenna ports comprises the prescribed antenna port and at least said further antenna port.

In example 339, the subject matter of example 338, or any of the examples described herein, in which the set of antenna ports comprises the prescribed antenna port and a plurality of antenna ports including the further antenna port.

In example 340, the subject matter of any of examples 334 to 339, or any of the examples described herein, in which the set of antenna ports comprises antenna ports {7, 8, 11, 13}.

In example 341, the subject matter of any of examples 334 to 340 or any of the examples described herein, in which at least one of the prescribed antenna port and the further antenna port is associated with a prescribed channel.

In example 342, the subject matter of example 341, or any of the examples described herein, in which the prescribed channel is a Physical Downlink Shared Channel.

In example 343, the subject matter of any of examples 334 to 342, or any of the examples described herein, in which at least one of said modulation symbols and further modulation symbols are symbols associated with a demodulation reference signal.

In example 344, the subject matter of any of examples 334 to 343, or any of the examples described herein, in which said scheduled modulation symbols having a respective spreading orthogonal cover code of a respective length for output via prescribed antenna port have an associated scrambling identity.

In example 345, the subject matter of example 344, or any of the examples described herein, in which the associated scrambling identity has a value of zero or one.

In example 346, the subject matter of any of examples 334 to 345, or any of the examples described herein, in which said co-scheduled further modulation symbols having an associated spreading orthogonal cover code of a respective length for output via a further antenna port of a set of antenna ports comprise an associated scrambling identity.

In example 347, the subject matter of example 346, or any of the examples described herein, in which the associated scrambling identity has a value of zero or one.

In example 348, the subject matter of any of examples 334 to 347, or any of the examples described herein, wherein said respective spreading orthogonal cover code of a respective length for output via prescribed antenna port has a code length of 4.

In example 349, the subject matter of any of examples 334 to 348, or any of the examples described herein, wherein said associated spreading orthogonal cover code of a respective length for output via a further antenna port has a code length of 4.

In Example 350, there is provided a subject matter of testing a target user equipment in a multi-user multiple input multiple output communication; the subject matter comprising generating a demodulation reference signal that has been spread using a respective spreading code for a respective antenna port of a set of antenna ports; generating a further demodulation reference signal that has been spread using a further respective spreading code for a further respective antenna port of the set of antenna ports; and outputting the spread demodulation reference signals for simultaneous transmission via said respective and further antenna ports respectively.

In example 351, the subject matter of example 350, or any of the examples described herein, in which outputting the spread demodulation reference signals for transmission via said respective antenna port comprises outputting the demodulation signals for transmission via at least one of antenna ports 7, 8, 11 or 13.

In example 352, the subject matter of either of examples 350 and 351, or any of the examples described herein, in which said respective antenna port of a set of antenna ports comprises antenna port 11.

In example 353, the subject matter of any of examples 350 to 352, or any of the examples described herein, in which said further respective antenna port of a set of antenna ports comprises antenna port 7, 8 or 13.

In example, 354, the subject matter of any of examples 350 to 353, or any of the examples described herein, in which said respective antenna port comprises a target antenna port selected from the set of antenna ports {7, 8, 11, 13} and said further respective antenna port comprises an antenna ports selected from the set of antenna ports less the target antenna port.

In example 355, the subject matter of any of examples 350 to 354, or any of the examples described herein, in which at least one of said respective spreading code and said further respective spreading code comprises an orthogonal cover code.

In example 356, the subject matter of any of examples 350 to 355, or any of the examples described herein, in which said respective spreading code and said further respective spreading code have different code lengths.

In example 357, the subject matter of example 356, or any of the examples described herein, in which said respective spreading code has a code length of two and said further respective spreading code has a code length of four.

In example 358, the subject matter of any of examples 350 to 357, or any of the examples described herein, in which said respective spreading code is an orthogonal cover code of length two and said further respective spreading code is an orthogonal cover code of length four.

In Example 359, there is provided machine executable instructions arranged, when executed by circuitry, to implement a subject matter of any of examples 350 to 358.

In Example 360, there is provided a machine readable storage storing machine executable instructions of example 359.

In Example 361, there is provided an apparatus comprising means to or circuitry to implement a subject matter of any of examples 350 to 358.

In Example 362 there is provided an apparatus comprising machine readable storage of example 360.

In Example 363, there is provided an apparatus for a user equipment to process a demodulation reference signal; the apparatus comprising: circuitry to despread a demodulation reference signal, associated with antenna port 11, that was spread using an orthogonal cover code of length four and having an associated scrambling identity (nSCID) of zero in the presence of co-scheduled demodulation reference signal associated with a further antenna port of a set of antenna ports received over the prescribed channel, the co-scheduled demodulation reference signal having been spread using an orthogonal cover code of length four and having an associated scrambling identity (nSCID) of zero; and an interface to output the despread demodulation reference signal associated with antenna port 11.

In Example 364, the subject matter of claim 363, or any of the examples described herein further comprising channel estimation circuitry to estimate a channel using the despread demodulation reference signal.

In Example 365, the subject matter of either of claims 363 and 364, or any of the examples described herein in which the prescribed channel is a Physical Downlink Shared Channel.

In Example 366, there is provided an apparatus for a base station to schedule a demodulation reference signal via an antenna port in a multi-user multiple input multiple output system; the apparatus comprising: circuitry to generate a demodulation reference signal that has been spread using a respective spreading orthogonal cover code of length 4 for output via antenna port 11; circuitry to generate a further demodulation reference signal that has been spread using a respective spreading orthogonal cover code of length 4 for output via a further antenna port of a set of antenna ports; and circuitry to co-schedule the spread demodulation reference signals for transmission via antenna port 11 and the further antenna port of the set of antenna ports respectively.

In Example 367, the subject matter of claim 366, or any of the examples described herein in which the set of antenna ports comprises at least one or more than one of antenna ports 7, 8, and 13.

In Example 368, the subject matter of claim 367, or any of the examples described herein comprising circuitry to select said further respective antenna port from the set of antenna ports 7, 8, and 13.

In Example 369, the subject matter of claim 368, or any of the examples described herein in which said circuitry to select said further respective antenna port from the set of antenna ports comprises circuitry to select said further respective antenna port randomly from the set of antenna ports.

In Example 370, the subject matter of either of claims 368 and 369, or any of the examples described herein in which said circuitry to select said further respective antenna port from the set of antenna ports comprises circuitry to dynamically select said further respective antenna port from the set of antenna ports.

In Example 371, the subject matter of any of claims 366 to 370, or any of the examples described herein in which antenna port 11 is a fixed antenna port.

1-34. (canceled)

35. Machine readable storage storing machine executable instructions arranged, when executed by one or more processors, to process a demodulation reference signal; the instructions comprising instructions to:
process a demodulation reference signal spread using a respective orthogonal cover code of respective length associated with antenna port 7 of a physical downlink shared channel, process a co-scheduled demodulation reference signal spread using an associated orthogonal cover code of a prescribed associated with antenna port 11 of the physical downlink shared channel; and
despread at least one of
the demodulation reference signal spread using said respective orthogonal cover code of said respective length to recover the demodulation reference signal, or
the co-scheduled demodulation reference signal spread using said associated orthogonal cover code of said prescribed length to recover the demodulation reference signal.

36. The machine readable storage of claim 35, further comprising instructions to estimate channel characteristics of a channel associated with antenna port 7 using the despread demodulation reference signal.

37. The machine readable storage of claim 36, further comprising instructions to decode data using said channel characteristics.

38. The machine readable storage of claim 35, further comprising instructions to estimate channel characteristics of a channel associated with antenna port 11 using the despread co-scheduled demodulation reference signal.

39. The machine readable storage of claim 38, further comprising instructions to decode data using said channel characteristics associated with antenna port 11 using the despread co-scheduled demodulation reference signal.

40. The machine readable storage of claim 35, in which the respective orthogonal cover code of said respective length associated with antenna port 7 has a length of two or four.

41. The machine readable storage of claim 35, in which the associated orthogonal cover code of said prescribed length associated with antenna port 11 has a length of two or four.

42. Machine readable storage storing machine executable instructions arranged, when executed by one or more processors, to process a demodulation reference signal; the instructions comprising instructions to:
process a demodulation reference signal spread using a respective orthogonal cover code of a respective length associated with antenna port 8 of a physical downlink shared channel,
process a co-scheduled demodulation reference signal spread using an associated orthogonal cover code of a prescribed length associated with antenna port 13 of a physical downlink shared channel; and
despread at least one of
the demodulation reference signal spread using said respective orthogonal cover code of said respective length to recover the demodulation reference signal, or
the co-scheduled demodulation reference signal spread using said associated orthogonal cover code of said prescribed length to recover the demodulation reference signal.

43. The machine readable storage of claim 42, further comprising estimating channel characteristics of a channel associated with antenna port 8 using the despread demodulation reference signal.

44. The machine readable storage of claim 43, further comprising decoding data using said channel characteristics.

45. The machine readable storage of claim 42, further comprising estimating channel characteristics of a channel associated with antenna port 13 using the despread co-scheduled demodulation reference signal.

46. The machine readable storage of claim 45, further comprising decoding data using said channel characteristics associated with antenna port 13 using the despread co-scheduled demodulation reference signal.

47. The machine readable storage of claim 42, in which the respective orthogonal cover code of said respective length associated with antenna port 8 has a length of two or four.

48. The machine readable storage of claim 42, in which the associated orthogonal cover code of said prescribed length associated with antenna port 13 has a length of two or four.

49. An apparatus for a base station to co-schedule demodulation reference signals; the apparatus comprising
generator circuitry to generate a demodulation reference signal,
spreader circuitry to spread an instance of the demodulation reference signal using a prescribed orthogonal cover code of a prescribed length for transmission via antenna port 7,
spreader circuitry to spread an instance of the demodulation reference signal using a further orthogonal cover code of a further prescribed length for transmission via antenna port 11, and
a scheduler to co-schedule transmission of the spread instances of the demodulation reference signals.

50. The apparatus of claim 49, in which the prescribed orthogonal cover code has a prescribed length of two or four.

51. The apparatus of claim 49, in which the further prescribed orthogonal cover code has a further prescribed length of two or four.

52. The apparatus of claim 49, in which the generator circuitry to generate the demodulation reference signal is responsive to an associated scrambling identity (nSCID).

53. The apparatus of claim 49, in which said scheduler to co-schedule comprises circuitry to associate the spread instances of the demodulation reference signals with corresponding resources.

54. An apparatus for a base station to co-schedule demodulation reference signals; the apparatus comprising
generator circuitry to generate a demodulation reference signal,
spreader circuitry to spread an instance of the demodulation reference signal using a prescribed orthogonal cover code of a prescribed length for transmission via antenna port 8,
spreader circuitry to spread an instance of the demodulation reference signal using a further orthogonal cover code of a further prescribed length for transmission via antenna port 13, and
a scheduler to co-schedule transmission of the spread instances of the demodulation reference signals.

55. The apparatus of claim 54, in which the prescribed orthogonal cover code has a prescribed length of two or four.

56. The apparatus of claim 54, in which the further prescribed orthogonal cover code has a further prescribed length of two or four.

57. The apparatus of claim 54, in which the generator circuitry to generate the demodulation reference signal is responsive to an associated scrambling identity (nSCID).

58. The apparatus of claim 54, in which said scheduler to co-schedule comprises circuitry to associate the spread instances of the demodulation reference signals with corresponding resources.
